(19) United States
(12) Patent Application Publication
(10) Pub. No.: US 2005/0247573 A1
(43) Pub. Date: Nov. 10, 2005

(54) Biosensors

(76) Inventors: Hideaki Nakamura, Ibaraki (JP); Shouji Shinohara, Ibaraki (JP); Masao Gotoh, Ibaraki (JP); Isao Karube, Ibaraki (JP)

Correspondence Address: Michael L. Goldman;Nixon Peabody LLP, Clinton Square, P.O. Box 31051, Rochester, NY, 14603-1051, US

(21) Appl. No.: 11/087,015

(22) Filed: Mar. 22, 2005

(30) Foreign Application Priority Data
Mar. 23, 2004 (JP) 2004-084116
Apr. 23, 2004 (JP) 2004-127937
Jan. 21, 2005 (JP) 2005-014376
Jan. 21, 2005 (JP) 2005-014377

(51) Int. Cl. G01N 27/26

(52) U.S. Cl. 205/777.5; 204/403.01; 204/403.02

(57) ABSTRACT

The biosensors of the present invention comprise an electrically insulating substrate, an electrically insulating cover connected to the substrate via a spacer layer, a reaction-detecting section formed on the substrate at a region sandwiched between the substrate and cover, and comprising at least one set of electrodes, and an external terminal to be connected to the reaction-detecting section, and a sealed sample-feeding path defined between the substrate and cover by the spacer layer, where the sample-feeding path has a portion intersecting the electrodes, as well as a cutting plane line provided at an outermost surface of the substrate or cover, which is a boundary between a sensor portion comprising electrodes and a sealed cap portion which does not comprise electrodes, and the cutting plane line is present at a position where, when the sealed cap portion is cut along the cutting plane line, the cut surface does not cross the electrodes and does cross the sample-feeding path, so that a sample-inlet port and an air-discharge port leading from the sample-feeding path are exposed through the cut surface. In addition, the biosensors for simultaneously measuring multiple items of the present invention comprise: a substrate; a cover connected to the substrate via a spacer layer; and a number of biosensor units comprising substrates each containing at least one biosensor unit which comprises a reaction-detecting section including one electrode system and one reagent layer on the substrate, and a sample-feeding path including the reagent layer, wherein each of the biosensor units comprise one reagent layer on one sample-feeding path, a cutting plane line for dividing each of the biosensor unit-comprising substrates is provided at a top surface of the substrate or cover, the cutting plane line and sample-feeding path are placed such that, when the substrate or cover is cut along the cutting plane line, a sample-inlet port for supplying a sample solution is open to a cut surface of each biosensor unit-comprising substrate as a cut port of the sample-feeding path.

### FIELD OF THE INVENTION

The present invention relates to biosensors.

More specifically, the present invention relates to biosensors comprising a structure that can keep the inside of a reaction-detecting section airtight until use; packagings thereof; methods for using the same; and devices thereof.

The present invention also relates to biosensors for simultaneously measuring multiple items, methods for using the same, and devices thereof, as well as methods for determining test compounds using the biosensors for simultaneously measuring multiple items.

### BACKGROUND OF THE INVENTION

To date, modes for packaging disposable sensors by using a container include systems where a number of biosensors are retained in a bottle container, and systems where each individual biosensor is retained in its own container and the opening of the container is thermally compressed using a film (Unexamined Published Japanese Patent Application No. (JP-A) 2000-314711). Dry conditions are maintained in such systems by placing a desiccant or such inside the containers.

However, during use, the former systems are opened and closed an increasing number of times, and thus the moisture-absorbing ability of the desiccant is reduced by the humidity of opening. Such packaging modes are unsuitable for use in humid weather conditions, such as those in Japan. Further, to properly preserve the biosensors, ultraviolet rays and oxygen must be blocked, and these modes of packaging do not do this.

In the latter systems, each biosensor is retained in its own container, thus using a lot of packaging materials. Accordingly, from the viewpoint of effective use of limited resources, and of waste management, such modes of packaging cannot be said to be environmentally friendly.

In addition, packaging methods are used, where biosensors with desiccants are sandwiched between two layers of film, coated with an ultraviolet absorber or a material that does not transmit ultraviolet, and these are adhered by thermal compression from outside the films (JP-A 2003-72861).

However, since this method applies heat at the time of packaging, heat during processing and the influence of thermal oxidation originating from this heat may alter the body of the biosensors, degrade chemical materials developed in reagent layers, and alter biomaterials. Further, it is necessary to consider the influence of heat-derived vapor pressure to maintain a given humidity. Because this packaging mode does not include deoxidants, air oxidation has an effect during the preservation period, since packaging takes place in air. Furthermore, such packages cannot be easily opened since their adhered portions, formed by thermal compression, are firmly stuck with the two films. People with disabilities, the elderly, children, or such may find such packaging difficult to open.

Conventional disposable biosensors have a tertiary structure for maintaining quantitativeness, and known mechanisms for automatically supplying sample solution to a sensor, using capillary action or the like (JP-A Hei 1-291153). A sensor with such a structure is assembled by laminating a spacer and cover on an electrically insulating substrate. An electrode pattern is formed on the substrate, and air holes are opened on the cover, to discharge the air necessary for capillary action. The substrate, spacer, and cover form a sample-inlet port with air holes on one side and a sample-feeding path for providing a given amount of sample solution to the detecting section by capillary action.

So far, systems in which at least two adjacent biosensors share one sample-feeding path have been used for biosensors able to simultaneously measure multiple items (FIG. 8 in JP-A Hei 1-291153).

### SUMMARY OF THE INVENTION

In conventional systems, bottle container systems are first problematic in that they cannot maintain a dry state inside, due to repeated opening and closing. In addition, since systems that package biosensors in containers use bulky containers compared to the size of the biosensor, they are problematic in that the packaging step is complex and requires lots of materials. Furthermore, although systems which package single biosensors by thermal compression of the biosensor between two films can shield ultraviolet rays and maintain a dry state through use of a desiccant, they cannot eliminate the influence of heat and oxidation, and opening the package can be problematic.

Thus, a first objective of the present invention is to achieve mild manufacturing processes suited to the use of biomaterials, such as processes that do not involve heating, even when a reaction process is required after deploying a reagent layer to an inner reaction-detecting section, or when simple packaging is needed; and to provide biosensors that can reliably shield the inner reaction-detecting section from the outside world until use.

Conventional biosensors for simultaneously measuring multiple items are problematic in that sample solutions supplied to the sample-feeding path are affected by at least one biosensor reagent.

Methods have been adopted in which sample solutions are introduced through holes that communicate with the sample-feeding path to the side of the biosensor on which the substrate or cover lies. In such cases, however, sample solution adheres to the edges of the holes used as sample-inlet ports when that sample solution was supplied to the biosensor feeding path, resulting in the use of sample solution in an amount greater than the inner volume of the sample-feeding path.

Thus, a second objective of the present invention is to provide biosensors that allow simultaneous measurement of multiple items using a reduced amount of sample solution, in which the sample solution supplied to a sample-feeding path to eliminate the influence of at least one other biosensor reagent; and to provide methods for measuring test compounds using these biosensors that simultaneously measure multiple items.

A first invention described herein was made in view of the first objective. By adopting a biosensor structure wherein a sample-inlet port and air-discharge port are exposed as a cross section of the sample-feeding path, achieved by cutting part of the biosensor structure when ready for use, the present inventors discovered biosensors which include a sealed reaction-detecting section comprising at least one set of electrodes and a sealed sample-feeding path, wherein the biosensors enable the reaction-detecting section to be completely sealed prior to use, have excellent sealing ability, and can preserve the inner environment in a preferred state through the use of a desiccant or the like as needed. The present inventors thus completed the present invention.

As this type of biosensor can seal the reaction-detecting section and such by connecting the substrate and cover via a spacer, heating is not involved in the biosensor manufacturing and packaging steps after forming a reaction layer in the reaction-detecting section.

A second invention described herein has been made in view of the second objective. The present inventors discovered that by using biosensors with specific structures to simultaneously measure multiple items, the biosensors could perform simultaneous multi-item measurement even with very little sample solution, and even when a little sample solution is supplied to the sample-feeding path, the influence of at least one biosensor reagent is eliminated. The present inventors thus completed the present invention.

Specifically, the present invention comprises the following:

[1] A biosensor comprising:
an electrically insulating substrate;
an electrically insulating cover connected to the substrate via a spacer layer;
a reaction-detecting section comprising at least one set of electrodes, and an external terminal to be connected to the reaction-detecting section, both of which are formed on the substrate at a region between the substrate and cover; and
a sealed sample-feeding path defined by the spacer layer between the substrate and cover,
wherein the sample-feeding path comprises a portion that intersects the electrodes,
a cutting plane line is provided at an outermost surface of the substrate or cover, and is bordered by a sensor portion comprising the electrodes and a sealed cap portion which does not comprise the electrodes,
the cutting plane line exists at a position where, when the sealed cap portion is cut along the cutting plane line, the cut surface does not cross the electrodes, and the cut surface crosses the sample-feeding path so that a sample-inlet port and air-discharge port from the sample-feeding path are exposed through the cut surface.

[2] The biosensor of [1], wherein the cutting plane line is formed by notches or cuts, and the notches or cuts are laid out to face the same positions on the substrate and cover.

[3] The biosensor of [1] or [2], wherein the substrate and cover each comprise a multilayer structure of at least two or more layers, and the cutting plane line is formed to leave at least an innermost layer of the multilayer structure.

[4] The biosensor of any of [1] to [3], wherein a reagent layer is provided at a region where the sample-feeding path crosses the electrode.

[5] The biosensor of any of [1] to [4], wherein a part of the region sandwiched between the substrate and cover comprises a desiccant and/or deoxidant.

[6] The biosensor of [5], wherein the desiccant and/or deoxidant is comprised in a sealed cap portion.

[7] The biosensor of any of [1] to [6], wherein a part of the region sandwiched between the substrate and cover comprises a humidity indicator and/or oxygen-detecting agent.

[8] The biosensor of [7], wherein a part or all of the substrate and/or cover is of a material transparent to visible rays, and thus the humidity indicator and/or oxygen-detecting agent is visible.

[9] The biosensor of any of [1] to [7], wherein the substrate and/or cover are made of a material that does not transmit ultraviolet.

[10] The biosensor of any of [1] to [9], wherein a top surface of the substrate and/or cover is coated with an ultraviolet absorber or a material that does not transmit ultraviolet.

[11] The biosensor of any of [1] to [10], wherein the substrate or cover comprise a compound with a photocatalytic effect, or where a top surface of the substrate and/or cover is coated with a layer comprising a compound with a photocatalytic effect.

[12] The biosensor of any of [1] to [11], wherein the spacer layer comprises a fluorescent or luminescent agent close to an exposed sample-inlet port and air-discharge port.

[13] The biosensor of any of [1] to [12], wherein the electrodes form an array.

[14] The biosensor of [13], wherein at least one sample-inlet port is exposed when the sealed cap portion is cut along the cutting plane line, and the reaction-detecting section comprising at least one set of electrodes is located ahead of the sample-feeding path connected to the sample-inlet port.

[15] The biosensor of [14], wherein the at least one sample-inlet port is connected to at least two sample-feeding paths branched from the sample-inlet port, and the reaction-detecting section comprising at least one set of electrodes is located ahead of the sample-feeding path.

[16] The biosensor of [8], wherein the substrate and/or cover comprising a material transparent to visible rays is coated with a protective film.

[17] The biosensor of any of [1] to [16], wherein the external terminal is coated with a protective film.

[18] The biosensor of any of [1] to [16], wherein the external terminal is covered with the cover, and the cover has a fold-line foldable in such a way as to expose the external terminal.

[19] A biosensor package retaining a plurality of a biosensor of any of [1] to [18].

[20] A biosensor aggregation sheet comprising a plurality of any of the biosensors of [1] to [18], regularly laid out at predetermined intervals, wherein a cut-away perforation is provided at a substrate of an adjoining biosensor.

[21] A method for using a biosensor of any of [1] to [18], wherein the method comprises the step of cutting off a sealed cap to form a sample-inlet port and an air-discharge port.

[22] A biosensor device comprising:
a biosensor of any of [1] to [18];
a measuring section for measuring an electrical value at a reaction-detecting section of the biosensor;
a display section for displaying a value measured in the measuring section; and
a memory section for saving the measured value.

[23] The biosensor device of [22], wherein the measuring method in the measuring section is any one of potential step chronoamperometry, coulometry, and cyclic voltammetry.

[24] The biosensor device of [22] or [23], wherein the biosensor comprises a wireless means for transmitting measurement data to the measuring section, and the wireless means is a non-contact IC card or Bluetooth.

[25] A biosensor for simultaneously measuring multiple items, comprising:
a substrate;
a cover connected to the substrate via a spacer layer; and
a number of biosensor unit-comprising substrates, containing at least one biosensor unit which comprises a reaction-detecting section that includes one electrode and one reagent layer on the substrate, and a sample-feeding path that includes the reagent layer,
wherein each of the biosensor units comprises one reagent layer on one sample-feeding path,
a cutting plane line for dividing each of the biosensor unit-comprising substrates is provided at a top surface of the substrate or cover,
the cutting plane line and sample-feeding path are placed such that, when the substrate or cover is cut along the cutting plane line, a sample-inlet port that supplies a sample solution to the sample-feeding path opens at a cut surface of each biosensor unit-comprising substrate, as a cut port of the sample-feeding path.

[26] The biosensor of [25], wherein the sample-feeding path is provided such that the sample-inlet port opens at the cut surface, and an air-discharge port is provided at the surface of the substrate or cover, or at a side surface of the biosensor unit-comprising substrate which differs from the cut surface.

[27] The biosensor of [25], wherein the sample-feeding path is sealed;
a cutting plane line (the first cutting plane line), which divides each of the biosensor unit-comprising substrates, and a second cutting plane line, which is different from the first cutting plane line and is used to expose the air-discharge port by cutting parts of the substrate and cover, are provided on a top surface of the substrate or cover; and
the first and second cutting plane lines and the sample-feeding path are arranged such that the sample-inlet port opens as a cut opening on the first cut surface when the substrate or cover is cut along the first cut surface, and such that the air-discharge port opens as a cut opening on the second cut surface when the substrate or cover is cut along the second cut surface.

[28] The biosensor of [27], equipped with an auxiliary device on a surface of the substrate or cover, such that the substrate or cover are bent along the second cutting plane line in response to bending of the substrate or cover along the first cutting plane line.

[29] The biosensor of [25], wherein the sample-feeding path is provided such that both the sample-inlet port and air-discharge port open to a cut surface of each of the biosensor unit-comprising substrates, and the sample-feeding path is set up in a sealed state, prior to cutting.

[30] The biosensor of any of [25] to [29], wherein the sample-feeding path is laid out such that a sample-inlet port forms for every biosensor unit.

[31] The biosensor of any of [25] to [30], wherein at least one of the substrate or cover comprises a multilayer structure comprising at least two layers, and the cutting plane line is formed at any one of the layers of the multilayer structure, excluding the innermost layer.

[32] The biosensor of any of [25] to [31], wherein the electrodes form an array.

[33] A method for using the biosensor of any one of [25] to [32], wherein said method comprises the steps of:
(1) bending the substrate or cover along a cutting plane line which divides the biosensor unit-comprising substrates, and cutting the substrate or cover to open the cut opening (sample-inlet port) of the sample-feeding path on the cut surface of each biosensor unit-comprising substrate;
(2) fixing the shape of the bent biosensor unit-comprising substrate to keep the sample-inlet port open;
(3) contacting the open sample-inlet port with a solution comprising a measuring target; and
(4) supplying the solution comprising the measuring target to the sample-feeding path.

[34] The method of [33], wherein the bending in step (1) is carried out such that the cut surface is exposed and one substrate is cut while the other substrate is left connected, and wherein step (3) is carried out with the biosensor bent.

[35] The method of [33] or [34], wherein step (3) comprises contacting the sample-inlet ports of two or more biosensor unit-comprising substrates with the solution at one time.

[36] The method of [33], wherein the biosensor unit-comprising substrate comprises two or more biosensor units, and step (2) comprises contacting one sample-inlet port of the biosensor unit-comprising substrates with a solution at the same time.

[37] A method for measuring a measuring target using the biosensor of any one of [25] to [32], wherein the method comprises the steps of:
(1) bending the substrate or cover along a cutting plane line which divides the biosensor unit-comprising substrates, and cutting the substrate or cover to open a cut opening (sample-inlet port) of the sample-feeding path on the cut surface of each biosensor unit-comprising substrate;
(2) fixing the shape of the bent biosensor unit-comprising substrate to keep the sample-inlet port open;
(3) contacting the open sample-inlet port with a solution comprising a measuring target;
(4) supplying the solution comprising the measuring target to the sample-feeding path; and
(5) measuring the measuring targets with each of the biosensors.

[38] A biosensor device comprising:
a biosensor of any one of [25] to [32];
a connector section which captures electric signals at biosensor electrodes;
a measuring section which measures an electrical value via the connector section;
a display section which displays the value measured in the measuring section; and
a memory section which saves the measured value.

[39] The biosensor device of [38], wherein the connector section comprises a structure for:
altering the shape of the biosensor unit-comprising substrate for opening the sample-inlet port;
fixing the biosensor unit-comprising substrate with the shape; and then
capturing electrical signals at the biosensor electrodes.

[40] The biosensor device of [38], wherein the measuring method in the measuring section is potential step chronoamperometry, coulometry, or cyclic voltammetry.

[41] A connector for use in biosensors, for fixing the biosensor of any one of [25] to [32] to capture electrical signals, wherein the connector comprises:
a sensor shape-fixing section that fixes the bent shape of the biosensor unit-comprising substrate to open the sample-inlet port; and
an electrical connection section or wiring for capturing electrical signals on the biosensor, and electrical signals at the biosensor electrodes.

### BRIEF DESCRIPTION OF THE DRAWINGS

FIG. 1 shows an example of a biosensor of the present invention. FIG. 1a shows an example of an outer substrate; FIG. 1b shows an example of a substrate adhering surface, comprising a wiring pattern; FIG. 1c shows an example of an outer surface of a cover; FIG. 1d shows an example of a cover adhering surface, comprising a spacer; FIG. 1e shows an example of a plan view of a biosensor in which a substrate and cover substrate are adhered; FIG. 1f shows an example of a enlarged cross-sectional view along A-A′ of FIG. 1e; FIG. 1g shows an example of a enlarged cross-sectional view along B-B′ of FIG. 1e; and FIG. 1h shows an example of using the biosensors.

FIG. 2 shows another example of a biosensor of the present invention. FIG. 2a shows an example of a substrate adhering surface, comprising a wiring pattern; FIG. 2b shows an example of a cover adhering surface, comprising a spacer; FIG. 2c shows an example of a plan view of a biosensor in which a substrate and cover substrate are adhered; FIG. 2d shows an example of a enlarged cross-sectional view along A-A′ of FIG. 2c; FIG. 2e shows an example of a enlarged cross-sectional view along B-B′ of FIG. 2c; and FIG. 2f shows an example of using the biosensors.

FIG. 3 shows another example of a biosensor of the present invention. FIG. 3a shows an example of a substrate adhering surface, comprising a wiring pattern; FIG. 3b shows an example of a cover adhering surface, comprising a spacer; FIG. 3c shows an example of a plan view of a biosensor in which a substrate and cover substrate are adhered; FIG. 3d shows an example of a enlarged cross-sectional view along A-A′ of FIG. 3c; FIG. 3e shows an example of a enlarged cross-sectional view along B-B′ of FIG. 3c; and FIG. 3f shows an example of using the biosensors.

FIG. 4 shows another example of a biosensor of the present invention. FIG. 4a shows an example of a substrate adhering surface, comprising a wiring pattern; FIG. 4b shows an example of a cover adhering surface, comprising a spacer; FIG. 4c shows an example of a plan view of a biosensor in which a substrate and cover substrate are adhered; FIG. 4d shows an example of a enlarged cross-sectional view along A-A′ of FIG. 3c; FIG. 4e shows an example of a enlarged cross-sectional view along B-B′ of FIG. 4c; and FIG. 4f shows an example of using the biosensors.

FIG. 5 shows another example of a biosensor of the present invention. FIG. 5a shows an example of an outer substrate; FIG. 5b shows an example of a substrate adhering surface, comprising a wiring pattern; FIG. 5c shows an example of an outer surface of a cover; FIG. 5d shows an example of a cover adhering surface, comprising a spacer; FIG. 5e shows an example of a plan view of a biosensor in which a substrate and cover substrate are adhered; FIG. 5f shows an example of a enlarged cross-sectional view along A-A′ of FIG. 5e; FIG. 5g shows an example of a enlarged cross-sectional view along B-B′ of FIG. 5e; and FIG. 5h shows an example of using the biosensors.

FIG. 6 shows another example of a biosensor of the present invention. FIG. 6a shows an example of an outer substrate; FIG. 6b shows an example of a substrate adhering surface, comprising a wiring pattern; FIG. 6c shows an example of an outer surface of a cover; FIG. 6d shows an example of a cover adhering surface, comprising a spacer; FIG. 6e shows an example of a plan view of a biosensor in which a substrate and cover substrate are adhered; FIG. 6f shows an example of a enlarged cross-sectional view along A-A′ of FIG. 6e; FIG. 6g shows an example of a enlarged cross-sectional view along B-B′ of FIG. 6e; and FIG. 6h shows an example of using the biosensors.

FIG. 7 shows another example of a biosensor of the present invention. FIG. 7a shows an example of an outer substrate; FIG. 7b shows an example of a substrate adhering surface, comprising a wiring pattern; FIG. 7c shows an example of an outer surface of a cover; FIG. 7d shows an example of a cover adhering surface, comprising a spacer; FIG. 7e shows an example of a plan view of a biosensor in which a substrate and cover substrate are adhered; FIG. 7f shows an example of a enlarged cross-sectional view along A-A′ of FIG. 7e; FIG. 7g shows an example of a enlarged cross-sectional view along B-B′ of FIG. 7e; and FIG. 7h shows an example of using the biosensors.

FIG. 8 shows examples of structural diagrams of embodiments of the present invention, except for the biosensor cover. To improve the visibility of the structural diagrams of the biosensors illustrated, all structural diagrams in FIG. 8 show electrodes placed in the upper portion of a spacer layer, but the spacer layer actually covers the tops of the electrodes. The structural diagrams shown in FIGS. 9i and 10g are the same as those in FIG. 8. FIGS. 8a to 8f correspond to the cases in FIGS. 1 to 6, respectively, while FIGS. 8g to 8i correspond to structures which contain a desiccant in a sealed cap portion, shown in FIGS. 1 to 6, respectively.

FIG. 9 shows another example of a biosensor of the present invention. FIG. 9a shows an example of an outer substrate; FIG. 9b shows an example of a substrate adhering surface, comprising a wiring pattern; FIG. 9c shows an example of an outer surface of a cover; FIG. 9d shows an example of a cover adhering surface, comprising a spacer; FIG. 9e shows an example of a plan view of a biosensor in which a substrate and cover substrate are adhered; FIG. 9f shows an example of a enlarged cross-sectional view along A-A′ of FIG. 9e; FIG. 9g shows an example of a enlarged cross-sectional view along B-B′ of FIG. 9e; and FIG. 9h shows an example of using the biosensors. FIG. 9i shows examples of structural diagrams of embodiments of the present invention, except for the biosensor cover.

FIG. 10 shows another example of an array-type biosensor of the present invention. FIG. 10a shows an example of an outer substrate; FIG. 10b shows an example of a substrate adhering surface, comprising a wiring pattern; FIG. 10c shows an example of an outer surface of a cover; FIG. 10d shows an example of a cover adhering surface, comprising a spacer; FIG. 10e shows an example of a plan view of a biosensor in which a substrate and cover substrate are adhered; and FIG. 10f shows an example of using the biosensors. FIG. 10g shows examples of structural diagrams of embodiments of the present invention, except for the biosensor cover.

FIG. 11 shows an example of packaging the biosensors of the present invention using a protective film. FIG. 11a shows an example of packaging using a protective film that consists of a detachable adhesive layer and a holding portion, where the detachable adhesive layer is not formed. FIG. 11b shows an example of a use of FIG. 11a; FIG. 11c shows an example of packaging using the protective film of FIG. 11a partly fixed by a strong adhesive or such; and FIG. 11d shows an example of a use of FIG. 11c.

FIG. 12 shows an example of biosensors of the present invention where the biosensor does not have packaging. FIGS. 12a and 12c show an example of a biosensor with a terminal protective cover; FIG. 12b shows an example of a use when there is one line of perforations between the cover and the terminal protective cover; and FIGS. 12d and 12e show examples of uses when there are additional lines of perforations in the terminal protective cover. FIG. 12d shows an example where the terminal protective cover is folded, while FIG. 12e shows an example where it is folded back.

FIG. 13 shows an example of a biosensor aggregation sheet of the present invention, where the linked biosensors do not have packaging.

FIG. 14 shows an example of a simultaneous multi-item measuring biosensor of the present invention. FIG. 14a shows an example of an outer substrate; FIG. 14b shows an example of a substrate adhering surface, comprising a wiring pattern; FIG. 14c shows an example of an outer surface of a cover; FIG. 14d shows an example of a cover adhering surface, comprising a spacer; FIG. 14e shows an example of a plan view of a simultaneous multi-item measuring biosensor in which a substrate and cover substrate are adhered; FIG. 14f shows an example of a enlarged cross-sectional view along A-A′ of FIG. 14e; FIG. 14g shows an example of a enlarged cross-sectional view along B-B′ of FIG. 14e; and FIG. 14h shows a side view of an example of a use of a biosensor. FIG. 14i shows a front view of an example of a use of a simultaneous multi-item measuring biosensor.

FIG. 15 shows another example of a simultaneous multi-item measuring biosensor of the present invention. FIG. 15a shows an example of an outer substrate; FIG. 15b shows an example of a substrate adhering surface, comprising a wiring pattern; FIG. 15c shows an example of an outer surface of a cover; FIG. 15d shows an example of a cover adhering surface, comprising a spacer; FIG. 15e shows an example of a plan view of a biosensor in which a substrate and cover substrate are adhered; FIG. 14f shows an example of a enlarged cross-sectional view along A-A′ of FIG. 15e; FIG. 15g shows an example of a enlarged cross-sectional view along B-B′ of FIG. 15e; and FIG. 15h shows a side view of an example of a use of a simultaneous multi-item measuring biosensor. FIG. 15i shows a front view of an example of a use of a simultaneous multi-item measuring biosensor.

FIG. 16 shows another example of a simultaneous multi-item measuring biosensor of the present invention. FIG. 16a shows an example of an outer substrate; FIG. 16b shows an example of a substrate adhering surface, comprising a wiring pattern; FIG. 16c shows an example of an outer surface of a cover; FIG. 16d shows an example of a cover adhering surface, comprising a spacer; FIG. 16e shows an example of a plan view of a simultaneous multi-item measuring biosensor in which a substrate and cover substrate are adhered; FIG. 16f shows an example of a enlarged cross-sectional view along A-A′ of FIG. 16e; FIG. 16g shows an example of a enlarged cross-sectional view along B-B′ of FIG. 16e; and FIG. 16h shows a side view of an example of a use of a simultaneous multi-item measuring biosensor. FIG. 16i shows a front view of an example of a use of a simultaneous multi-item measuring biosensor.

FIG. 17 shows another example of a simultaneous multi-item measuring biosensor of the present invention. FIG. 17a shows an example of an outer substrate; FIG. 17b shows an example of a substrate adhering surface, comprising a wiring pattern; FIG. 17c shows an example of an outer surface of a cover; FIG. 17d shows an example of a cover adhering surface, comprising a spacer; FIG. 17e shows an example of a plan view of a simultaneous multi-item measuring biosensor in which a substrate and cover substrate are adhered; FIG. 17f shows an example of a enlarged cross-sectional view along A-A′ of FIG. 17e; FIG. 17g shows an example of a enlarged cross-sectional view along B-B′ of FIG. 17e; and FIG. 17h shows a side view of an example of a use of a simultaneous multi-item measuring biosensor. FIG. 17i shows a front view of an example of a use of a simultaneous multi-item measuring biosensor.

FIG. 18 shows another example of a simultaneous multi-item measuring biosensor of the present invention. FIG. 18a shows an example of an outer substrate; FIG. 18b shows an example of a substrate adhering surface, comprising a wiring pattern; FIG. 18c shows an example of an outer surface of a cover; FIG. 18d shows an example of a cover adhering surface, comprising a spacer; FIG. 18e shows an example of a plan view of a simultaneous multi-item measuring biosensor in which a substrate and cover substrate are adhered; FIG. 18f shows an example of a enlarged cross-sectional view along A-A′ of FIG. 18e; FIG. 18g shows an example of a enlarged cross-sectional view along B-B′ of FIG. 18e; and FIG. 18h shows a side view of an example of a use of a simultaneous multi-item measuring biosensor. FIG. 18i shows a front view of an example of a use of a simultaneous multi-item measuring biosensor.

FIG. 19 shows examples of using the biosensors for simultaneously measuring multiple items of the present invention, with a measuring unit (connector). 19i) shows examples of the biosensors for simultaneous measurement of multiple items before connection to the measuring unit. 19ii) shows examples the biosensors for simultaneous measurement of multiple items connected to the measuring unit. FIG. 19a shows examples of a top view. FIG. 19b shows examples of a cross-sectional view along A-A′. FIG. 19c shows examples of a side view.

FIG. 20 shows, from another angle, examples of using the biosensors for simultaneously measuring multiple items of the present invention with the measuring unit. FIG. 20a shows an example of a front view of a biosensor for simultaneous measurement of multiple items before being connected to a measuring unit. FIG. 20b shows an example of a front view of a biosensor for simultaneous measurement of multiple items connected to a measuring unit.

FIG. 21 shows, from another angle, examples of using of the biosensors for simultaneously measuring multiple items of the present invention with a measuring unit. FIG. 21a shows an example of a side view of a biosensor for simultaneous measurement of multiple items connected to the measuring unit, where the measuring unit is inclined so as to supply a sample solution. FIG. 21b shows an example of a front view of the biosensor for simultaneous measurement of multiple items and measuring unit of FIG. 21a.

FIG. 22 shows an example of an arrayed biosensor for simultaneous measurement of multiple items of the present invention. FIG. 22a shows an example of a perspective top view of an arrayed biosensor for simultaneous measurement of multiple items. FIG. 22b shows an example of using the arrayed biosensor for simultaneous measurement of multiple items. FIG. 22c shows an example of an enlarged cross-sectional view along A-A′ in FIG. 22a; and FIG. 22d shows an example of an enlarged cross-sectional view along B-B′ in FIG. 22a.

FIG. 23 shows an example of a linked and arrayed biosensor for simultaneous measurement of multiple items of the present invention. FIG. 23a shows an example of a perspective top view of a linked and arrayed biosensor for simultaneous measurement of multiple items. FIG. 23b shows an example of using the linked and arrayed biosensor for simultaneous measurement of multiple items. FIG. 23c shows an example of an enlarged cross-sectional view along A-A′ in FIG. 23a; and FIG. 23d shows an example of an enlarged cross-sectional view along B-B′ in FIG. 23a.

FIG. 24 shows another example of an arrayed biosensor for simultaneous measurement of multiple items of the present invention. FIG. 24a shows an example of a perspective top view of an arrayed biosensor for simultaneous measurement of multiple items. FIG. 24b shows an example of using the arrayed biosensor for simultaneous measurement of multiple items. FIG. 24c shows an example of an enlarged cross-sectional view along A-A′ in FIG. 24a; and FIG. 24d shows an example of an enlarged cross-sectional view along B-B′ in FIG. 24a.

FIG. 25 shows another example of a linked and arrayed biosensor for simultaneous measurement of multiple items of the present invention. FIG. 25a shows an example of a perspective top view of a linked and arrayed biosensor for simultaneous measurement of multiple items. FIG. 25b shows an example of using the linked and arrayed biosensor for simultaneous measurement of multiple items. FIG. 25c shows an example of an enlarged cross-sectional view along A-A′ in FIG. 25a; and FIG. 25d shows an example of an enlarged cross-sectional view along B-B′ in FIG. 25a FIG. 26 shows another example of a simultaneous multi-item measuring biosensor of the present invention. FIG. 26a shows an example of an outer substrate; FIG. 26b shows an example of a substrate adhering surface, comprising a wiring pattern; FIG. 26c shows an example of an outer surface of a cover; FIG. 26d shows an example of a cover adhering surface, comprising a spacer; FIG. 26e shows an example of a plan view of a simultaneous multi-item measuring biosensor in which a substrate and cover substrate are adhered; FIG. 26f shows an example of a enlarged cross-sectional view along A-A′ of FIG. 26e; FIG. 26g shows an example of a enlarged cross-sectional view along B-B′ of FIG. 26e; and FIG. 26h shows a side view of an example of a use of a simultaneous multi-item measuring biosensor.

FIG. 27 shows another example of a simultaneous multi-item measuring biosensor of the present invention. FIG. 27a shows an example of an outer substrate; FIG. 27b shows an example of a substrate adhering surface, comprising a wiring pattern; FIG. 27c shows an example of an outer surface of a cover; FIG. 27d shows an example of a cover adhering surface, comprising a spacer; FIG. 27e shows an example of a plan view of a simultaneous multi-item measuring biosensor in which a substrate and cover substrate are adhered; FIG. 27f shows an example of a enlarged cross-sectional view along A-A′ of FIG. 27e; FIG. 27g shows an example of a enlarged cross-sectional view along B-B′ of FIG. 27e; and FIG. 27h shows a side view of an example of a use of a simultaneous multi-item measuring biosensor.

FIG. 28 shows another example of a simultaneous multi-item measuring biosensor of the present invention. FIG. 28a shows an example of an outer substrate; FIG. 28b shows an example of a substrate adhering surface, comprising a wiring pattern; FIG. 28c shows an example of an outer surface of a cover; FIG. 28d shows an example of a cover adhering surface, comprising a spacer; FIG. 28e shows an example of a plan view of a simultaneous multi-item measuring biosensor in which a substrate and cover substrate are adhered; FIG. 28f shows an example of a enlarged cross-sectional view along A-A′ of FIG. 28e; FIG. 28g shows an example of a enlarged cross-sectional view along B-B′ of FIG. 28e; and FIG. 28h shows a side view of an example of a use of a simultaneous multi-item measuring biosensor.

FIG. 29 shows another example of a simultaneous multi-item measuring biosensor of the present invention. FIG. 29a shows an example of an outer substrate; FIG. 29b shows an example of a substrate adhering surface, comprising a wiring pattern; FIG. 29c shows an example of an outer surface of a cover; FIG. 29d shows an example of a cover adhering surface, comprising a spacer; FIG. 29e shows an example of a plan view of a simultaneous multi-item measuring biosensor in which a substrate and cover substrate are adhered; FIG. 29f shows an example of a enlarged cross-sectional view along A-A′ of FIG. 29e; FIG. 29g shows an example of a enlarged cross-sectional view along B-B′ of FIG. 29e; and FIG. 29h shows a side view of an example of a use of a simultaneous multi-item measuring biosensor.

FIG. 30 shows another example of a simultaneous multi-item measuring biosensor of the present invention. FIG. 30a shows an example of an outer substrate; FIG. 30b shows an example of a substrate adhering surface, comprising a wiring pattern; FIG. 30c shows an example of an outer surface of a cover; FIG. 30d shows an example of a cover adhering surface, comprising a spacer; FIG. 30e shows an example of a plan view of a simultaneous multi-item measuring biosensor in which a substrate and cover substrate are adhered; FIG. 30f shows an example of a enlarged cross-sectional view along A-A′ of FIG. 30e; FIG. 30g shows an example of a enlarged cross-sectional view along B-B′ of FIG. 30e; and FIG. 30h shows a side view of an example of a use of a simultaneous multi-item measuring biosensor.

FIG. 31 shows examples of using a biosensor for simultaneous measurement of multiple items of the present invention. FIG. 31a shows an example of a foldable biosensor for simultaneous measurement of multiple items before use; FIG. 31b shows an example of using a folded biosensor for simultaneous measurement of multiple items when the cover for the terminal portion is removed at the perforations; FIG. 31c shows an example of a use of a folded biosensor for simultaneous measurement of multiple items when the cover for the terminal portion is folded along the perforations; and FIG. 31d shows an example of a use of a folded biosensor for simultaneous measurement of multiple items when the cover for the terminal portion is folded back along the perforations.

FIG. 32 shows an example of a linked biosensor for simultaneous measurement of multiple items of the present invention. FIG. 32a shows an example of a biosensor for simultaneous measurement of multiple items removed from the link sheet along the perforations; and FIG. 32b shows an example of a link sheet consisting of biosensors for simultaneously measuring multiple items.

FIG. 33 shows another example of a linked biosensor for simultaneous measurement of multiple items of the present invention. FIG. 33a shows an example of a biosensor for simultaneous measurement of multiple items removed from the link sheet along the perforations; and FIG. 33b shows an example of a link sheet consisting of biosensors for simultaneously measuring multiple items.

FIG. 34 shows an example of a linked biosensor for simultaneous measurement of multiple items of the present invention using a soft sheet. FIG. 34a shows an example of a biosensor for simultaneous measurement of multiple items along the perforations provided on a soft sheet; and FIG. 34b shows an example of biosensors for simultaneously measuring multiple items linked with a soft sheet.

FIG. 35 shows an example of a sealed-type simultaneous multi-item measuring biosensor of the present invention. FIG. 35a shows an example of an outer substrate; FIG. 35b shows an example of a substrate adhering surface, comprising a wiring pattern; FIG. 35c shows an example of an outer surface of a cover; FIG. 35d shows an example of a cover adhering surface, comprising a spacer; FIG. 35e shows an example of a plan view of a simultaneous multi-item measuring biosensor in which a substrate and cover substrate are adhered; FIG. 35f shows an example of a enlarged cross-sectional view along A-A′ of FIG. 35e; FIG. 35g shows an example of a enlarged cross-sectional view along B-B′ of FIG. 35e; and FIG. 35h shows a side view of an example of a use of a biosensor. FIG. 35i shows a front view of an example of a use of a simultaneous multi-item measuring biosensor.

FIG. 36 shows an example of an operation of the sealed-type single-item measuring biosensor of the present invention. FIG. 36a shows an example of a biosensor before measurement; FIG. 36b shows an example of a biosensor connected to a connector to which a sample solution is supplied; FIG. 36c shows an example of a biosensor after supply with the sample solution; and FIG. 36d shows an example of a biosensor after measurement.

FIG. 37 is a graph showing the results of measuring glucose concentration in whole blood using the sealed-type single-item measuring biosensors of the present invention.

FIG. 38 is a graph showing the results of analyzing the preservation stability of the sealed-type single-item measuring biosensors of the present invention.

FIG. 39 shows an example of an operation of a simultaneous multi-item measuring biosensor of the present invention. FIG. 39a shows an example of a biosensor before measurement; FIG. 39b shows an example of a biosensor connected to a connector to which a sample solution is supplied; FIG. 39c shows an example of a biosensor after supply with the sample solution; and FIG. 39d shows an example of a biosensor after measurement.

FIG. 40 shows an example of the operation of a connector connecting to a biosensor for simultaneous measurement of multiple items of the present invention. FIG. 40a shows an example of a disconnected connector, before connection to the biosensor; and FIG. 40b shows an example of a connector connected to the biosensor.

FIG. 41 is a graph showing the results of measuring glucose concentration in whole blood using a biosensor for simultaneously measuring two items of the present invention, divided into left and right biosensor responses.

FIG. 42 is a graph showing the results of measuring the preservation stability of a biosensor for simultaneously measuring two items of the present invention, divided into left and right biosensor responses.

FIG. 43 is a graph showing the results of analyzing the responses of biosensors for simultaneously measuring two items of the present invention, using a mixture of glucose and lactic acid.

FIG. 44 shows another example of the operation of a sealed-type biosensor for simultaneous measurement of multiple items of the present invention. FIG. 44a shows an example of a biosensor before use in measurement; FIG. 44b shows an example of a biosensor supplied with a sample solution; FIG. 44c shows an example of a top perspective view of the biosensor supplied with sample solution; and FIG. 44d shows an example of a side view of the biosensor supplied with sample solution.

FIG. 45 is a graph showing the results of measuring glucose concentration in whole blood using a sealed-type biosensor for simultaneously measuring two items of the present invention, divided into left and right biosensor responses.

FIG. 46 is a graph showing the results of measuring the preservation stability of a sealed-type biosensor for simultaneously measuring two items of the present invention, divided into left and right biosensor responses.

FIG. 47 shows another example of an operation of a simultaneous multi-item measuring biosensor of the present invention. FIG. 47a shows an example of a biosensor before measurement; FIG. 47b shows an example of a biosensor connected to a connector to which a sample solution is supplied; FIG. 47c shows an example of a biosensor after supply with the sample solution; and FIG. 47d shows an example of a biosensor after measurement.

FIG. 48 is a graph showing the results of measuring glucose concentration in whole blood using a sealed-type biosensor for simultaneously measuring two items of the present invention, divided into left and right biosensor responses.

FIG. 49 is a graph showing the results of measuring the preservation stability of a sealed-type biosensor for simultaneously measuring two items of the present invention, divided into left and right biosensor responses.

FIG. 50 is a graph showing the results of analyzing the responses of sealed-type biosensors for simultaneously measuring two items of the present invention, using a mixture of glucose and lactic acid.

1 Substrate
2 Cover
3 Spacer
4 Pattern including electrodes
5 Vacant portion of the spacer (sample-feeding path)
6 Reagent layer (reaction layer)
7 Notch
8 Terminal
9 Sensor portion
10 Sealed cap portion
11 Sample-inlet port
12 Air-discharge port
13 Sample solution
14 Broken lines indicating a removed portion
15 Desiccant
16 Electrode
17 Wiring
18 Protective film
19 Peel seal portion (adhesive layer)
20 Holding portion (non-adhesive layer)
21 Protective-film fixing portion
22 Terminal protective cover
23 Perforations
24 Completely packaged biosensor
25 Bent portion
26 Portion to become a sample-inlet port
27 Connector
101 Substrate
102 Cover
103 Spacer
104 Pattern including electrodes
105 Vacant portion of the spacer (sample-feeding path)
106 Reagent layer (reaction layer)
107 Notch
108 Terminal
109 Sample-inlet port
110 Air-discharge port
111 Sample solution
112 Broken lines indicating a folding portion
113 Resist
114 Desiccant
115 Biosensor for simultaneous measurement of multiple items
116 Measuring unit (connector)
117 Inlet section
118 Horizontal movement section
119 Guide
120 Top folding portion
121 Bottom folding portion
122 Wiring
123 Electrode
124 Air-discharge port
125 Perforations
126 Soft sheet for linkage
127 Biosensor unit
128 Biosensor unit-comprising substrate
129 Auxiliary device
130 Auxiliary device fixing portion
131 Upper outward-folding portion (opening of air-discharge port)
132 Simultaneous two-item measuring connector
133 Base
134 Cap
135 Folder
136 Presser
137 Wiring

### DETAILED DESCRIPTION OF THE INVENTION

First Invention: Biosensors

The biosensors of the present invention comprise:
an electrically insulating substrate;
an electrically insulating cover connected to the substrate via a spacer layer;
a reaction-detecting section comprising at least one set of electrodes, and an external terminal to be connected to the reaction-detecting section, both of which are formed on the substrate at a region between the substrate and cover; and
a sealed sample-feeding path defined by the spacer layer between the substrate and cover, wherein
the sample-feeding path comprises a portion intersecting the electrodes,
a cutting plane line is provided at outermost surfaces of the substrate or cover, and bounds between a sensor portion comprising the electrodes and a sealed cap portion which does not comprise the electrodes,
the cutting plane line is present at a position where when the sealed cap portion is cut along the cutting plane line, a cut surface does not cross the electrodes, and the cut surface crosses the sample-feeding path so that a sample-inlet port led from the sample-feeding path and an air-discharge port are exposed through the cut surface.

That is, in the biosensors of the present invention, cutting the sealed cap portion along the cutting plane line before use exposes two cross sections of the sample-feeding path in the sensor portion, since the cut surface crosses the sample-feeding path. Accordingly, one of the two exposed cross sections serves as a sample-inlet port, while the other cross section serves as an air-discharge port. The cutting method is not particularly limited, and can be snapping, breaking, or tearing along the cutting plane line.

The sensor portion is the body of the biosensor, comprising a substrate; a cover connected to the substrate via a spacer layer; a reaction-detecting section formed on the substrate at a region sandwiched between the substrate and cover and comprising at least one set of electrodes; an external terminal to be connected to the reaction-detecting section; a sample-feeding path defined between the substrate and cover by the spacer layer; a sample-inlet port; and an air-discharge port. The sealed cap portion is a portion that does not include electrodes and can be disposed of by cutting.

The directions of the openings of the sample-inlet port and air-discharge port of the biosensors are not particularly limited, as long as they are on the same cross section when the biosensor is used. The sample-inlet port and air-discharge port may be formed anywhere inside the cross section which appears at the time of use, at a position where the sample solution can be supplied to the sample-feeding path.

The phrase “on the same cross section” herein means that the entirety of both the sample-inlet port and air-discharge port appear on the same cross section due to biosensor deformation at time of use. The shape of the edges that constitute the cross section of the sensor portion depends on the shape of the corresponding sealed cap portion, and may be linear or curved. With regard to the shape of the cut surface, if the side near the sample-inlet port is curved, the risk of human injury can be reduced in particular uses such as measuring blood glucose, where blood is extracted from the body.

Furthermore, the shape of the sealed cap portion is not particularly limited, and is preferably rectangular, trapezoidal, triangular, or the like.

The sample-feeding path forms a pattern with the spacer layer. Examples of the spacer layer can include an adhesive layer, as well as a spacer layer with an adhesive layer in which adhesive is applied to both sides of the spacer. Therefore, the spacer layer adheres the substrate and cover together, and defines the sample-feeding path.

The electrodes are at least one set of electrodes comprising a positive and negative electrode facing each other. Such electrodes may consist of two electrodes, a positive one and a negative one, or may comprise two or more electrodes.

In the present invention, the area around the sample-inlet port and the top surface of the sample-feeding path can be coated with a surfactant or lipid. This surfactant or lipid coating enables smooth supply of the sample solution.

Before cutting the sealed cap portion, the biosensors of the present invention keep the inside of the sample-feeding path airtight, including the reaction-detecting section. Thus, the internal state of the biosensors can be maintained for long periods after manufacture, and the internal environment of the biosensors, specifically the gas composition (deoxygenated state), atmospheric pressure, humidity (humid conditions) and so on, can be controlled to a certain preferred environment.

Accordingly, even a sample solution that cannot be smoothly supplied via the dry sample-feeding path of the biosensor can be smoothly supplied into the biosensor by uniformly applying a surfactant or the like to the inner wall or the like of the sample-feeding path, maintaining a given humidity. When the sample solution is blood or such, heparin, prolixin-S, or a metal salt of ethylenediaminetetraacetic acid or citric acid may be coated as an anticoagulant agent alone, or together with a surfactant.

Furthermore, it is preferable that the sample-feeding path between at least the sample-inlet port and reaction-detecting section is a straight line or gentle curve. A sample-feeding path of this shape enables smooth supply of the sample solution. It is therefore preferable that corners, particularly areas with acute angles, are absent from the above-described region of the sample-feeding path.

Substrates

The above-described substrates are not particularly limited as long as they provide electrical insulation. For example, any plastic, biodegradable material, or paper can be preferably used.

Plastics include hard polyvinyl chloride, polystyrene, polypropylene, polyethylene terephthalate, polyethylene naphthalate, polyester, polyether nitrile, polycarbonate, polyamide imide, phenolic resin, epoxy resin, acrylic resin, and ABS resin. Preferable plastics for use in sheet form are polycarbonate, hard polyvinyl chloride, polyethylene terephthalate, acrylic resin, ABS resin, or the like.

A preferable biodegradable material is polylactic acid.

The substrates may be made of a material that does not transmit ultraviolet light.

The substrate depth is not particularly limited, and for example is preferably in the range of about 10 to 1,000 μm, and more preferably in the range of about 100 to 500 μm.

Covers

The above-described covers may be made of materials similar to those of the substrates described above. Cover depth is not particularly limited, and is preferably, for example, in the range of about 10 to 1000 μm, and more preferably in the range of about 100 to 500 μm.

Spacer Layers

The spacer layers adhere substrates to covers, and define sample-feeding paths.

The spacers may be made of materials similar to the substrates described above, and in such cases, adhesive is applied to the top surface of the spacers to obtain an adhesive layer for connecting the substrate and cover. Alternatively, the spacer itself may be an adhesive layer formed by an adhesive. The adhesive is not particularly limited, as long as it does not react with or is not soluble in the substrate and cover. For example, an acrylic resin can be used as the adhesive.

The spacer itself may be formed by an adhesive and resist. In such cases, as for the adhesive, the resist is not particularly limited, as long as it does not react with or is not soluble in the substrate and cover. Examples of the resist include ultraviolet-curing vinyl-acrylic resin, urethane acrylate resin, and polyester acrylate resin. The resist is mainly used to clarify the electrode pattern, for example, to define the electrode area, and to insulate the sample-feeding path where the reagent layer is not present. Accordingly, the resist layer may or may not form the same pattern as the adhesive layer. Where it does not, the resist layer is preferably formed on the electrode substrate for insulation.

As the above-described acrylic resin, heat-curing and photo-curing types, more specifically, ultraviolet-curing and visible-light-curing types of acrylic resins may be used. The top surface of the spacer may be coated with an ultraviolet-absorber or a material that does not transmit ultraviolet.

Spacer depth is not particularly limited, and is preferably in the range of 5 to 500 μm, and more preferably in the range of about 10 to about 100 μm.

The spacer layer can be formed by screen-printing methods. Reagents such as enzymes, mediators, or surfactants may be comprised in the spacer layer.

Electrode Systems

The above-described electrode systems comprise sets of electrodes consisting of positive and negative electrodes facing each other, as well as lead lines. Such electrode systems may consist of two electrodes, a positive electrode and negative electrode, or may comprise two or more electrodes.

The electrodes can be made of any of carbon, silver, silver/silver chloride, platinum, gold, nickel, copper, palladium, titanium, iridium, lead, tin oxide, and platinum black. As carbon, specifically, carbon nanotubes, carbon microcoils, carbon nanophones, fullerens, dendrimers, and derivatives thereof can be used.

The electrode depth is not limited, as long as it does not interfere with spacer contact. For screen-printing, electrode depth is normally in the range of about 1 to 100 μm, more preferably in the range of about 3 to 20 μm. For vapor deposition, sputtering, film adhesion, and plating, depth is normally in the range of about 200 to 2,000 Angstroms, more preferably in the range of about 500 to 1,000 Angstroms. When electrode depth is within such ranges, the electrode edges formed on the substrate are not serrated, resulting in electrodes with high accuracy. Furthermore, separation and disconnection of the electrodes can also be prevented.

Such electrodes can be formed on the substrate or cover by any methods of screen-printing, vapor deposition, sputtering, film adhesion, or plating.

The cutting plane lines are preferably formed by notches or cuts, and the notches or cuts are laid out at identical substrate or cover positions so they face each other.

Notches or cuts formed on the cutting plane line make cutting easier. Furthermore, if the cutting plane lines are laid out to face the same positions, cutting is easy.

Herein, the term “cuts” refers to cuts on the substrate or cover constituting the biosensor, made from outside to a depth that does not reach the interior. Therefore, the cuts do not penetrate the substrate or cover before cutting.

In the present specification, the phrase “A and/or B” means at least one of A or B.

The substrate or cover may comprise a multilayer structure of at least two or more layers, and the cutting plane line is formed to leave at least an innermost layer of the multilayer structure.

When the substrate or cover comprises a multilayer structure of at least two or more layers, the cutting plane line, as well as notches, perforations, or the like, can be formed to leave at least the innermost layer of the multilayer structure. Furthermore, it is preferable that the notches or perforations are laid out at identical substrate or cover positions so as to face one another. By using a multilayer structure, the cutting plane lines are formed to leave at least an innermost layer, and the resulting biosensors thus are free from damage such as flawed inner layer portions. Therefore, these biosensors are advantageous in that they can endure forces such as sudden bending during the manufacturing process or when in storage state.

Reagent Layers

Reagent layers are preferably provided at a region where the sample-feeding path crosses the electrodes.

In the biosensors of the present invention, reagents react with samples through capillary action used to feed the samples from a sample-inlet port through a sample-feeding path. Samples are then contacted with a reagent layer on electrodes forming a reaction-detecting section. The reaction is monitored as electrical changes on the electrodes. One or a number of such reagent layers can be present where the sample-feeding path passes on the electrodes.

The reagent layers are preferably on the top surface of one or both of the positive and negative electrodes.

Because the biosensors of the present invention are extremely well sealed prior to use, they can maintain a given humidity in the reagent layer. Thus, even when oxygen is present inside the biosensor, degradation or denaturation due to air oxidation can be suppressed in reagents protected by humidity.

According to the present invention, the top surface of a reagent layer can be coated with a compound such as a surfactant or lipid, to enable smooth supply of the sample solution. A surfactant or lipid coating on the top surface of the reagent layer can further suppress degradation due to air oxidation. When the sample solution is blood or such, heparin, prolixin-S, or a metal salt of ethylenediaminetetraacetic acid or citric acid may be used as anticoagulant agents for coating.

The reagent layers can contain, as necessary, any enzyme, antibody, ribosome, nucleic acid, primer, peptide nucleic acid, nucleic acid probe, microorganism, organelle, receptor, cellular tissue, molecular recognizing factor such as crown ether, mediator, intercalating agent, coenzyme, antibody labeling agent, substrate, inorganic salt, surfactant, lipid, sugar such as trehalose, humectant such as glycerin, and stabilizer such as cysteine, or a combination thereof, depending on the test subject.

When the sample solution is blood, the reagent layer may comprise anticoagulant agents. Heparin, prolixin-S, metal salts of ethylenediaminetetraacetic acid or citric acid may be used as anticoagulant agents.

The enzymes include oxidases and dehydrogenases, such as glucose oxidase, fructosylamine oxidase, lactate oxidase, urate oxidase, cholesterol oxidase, alcohol oxidase, glutamate oxidase, pyruvate oxidase, pyruvate kinase, acetate kinase, peroxidase, glucose dehydrogenase, lactate dehydrogenase, and alcohol dehydrogenase; cholesterol esterase, inorganic pyrophosphatase, acidic phosphatase, alkaline phosphatase, nucleotide triphosphatase, nucleotide diphosphatase, nucleotide monophosphatase, inositol phosphatase, protein phosphatase, adenosine triphosphatase, guanosine triphosphatase, adenosine-5′-diphosphatase, casein phosphatase, tyrosine phosphatase, serine phosphatase, threonine phosphatase, maltose phosphorylase, sucrose phosphorylase, purine nucleotide phosphorylase, adenyl cyclase, guanylate cyclase, glucose isomerase, mutarotase, catalase, protease, nicotinamide adenine dinucleotide (NADH) oxydase, diaphorase, and osmium peroxidase complex; nucleic acid ligases such as DNA polymerase, RNA polymerase, DNA ligase, and DNase; and restriction enzymes. These enzymes can be used alone or in combination.

Instead of enzymes alone, the reagent layers may also contain enzymes in combination with mediators. The mediators are selected from pigments such as potassium ferricyanide, ferrocene, benzoquinone, osmium peroxidase complex, 1-methoxy-5-methylphenazinium methyl sulfonate (1-M-PMS), 2,6-dichloroindophenol (DCIP), 9-dimethylaminobenzo-α-phenazoxonium chloride, methylene blue, indigo trisulfonic acid, phenosafranin, thionin, new methylene blue, 2,6-dichlorophenol, indophenol, azure B, N,N,N′,N′-tetramethyl-p-phenylenediamine dihydrochloride, resorufin, safranin, sodium anthraquinone β-sulfonate, and indigo carmine; biological oxidation-reduction materials such as riboflavin, L-ascorbic acid, flavin adenine dinucleotide, flavin mononucleotide, nicotine adenine dinucleotide, lumichrome, ubiquinone, hydroquinone, 2,6-dichlorobenzoquinone, 2-methylbenzoquinone, 2,5-dihydroxybenzoquinone, 2-hydroxy-1,4-naphthoquinone, glutathione, peroxydase, cytochrome C, and ferredoxin, or derivatives thereof; and Fe-EDTA, Mn-EDTA, Zn-EDTA, methosulfate, 2,3,5,6-tetramethyl-p-phenylenediamine, and the like.

The reagent layers may comprise inorganic salts such as sodium chloride or potassium chloride, in combination with quinhydrone.

Preferable concentrations of the above-described mediators are approximately 40 nM or more.

Of the above-described compounds, potassium ferricyanide, ferrocene, benzoquinone, osmium peroxidase complex, DCIP, 1-M-PMS, and 9-dimethylaminobenzo-α-phenazoxonium chloride are preferable.

A combination of primers, DNA polymerases, and deoxyribonucleotide triphosphates can be contained in reagent layers. Furthermore, the reagent layers can comprise a combination of inorganic salts, such as sodium chloride or potassium chloride, and quinhydrone, as well as primers, DNA polymerases, and deoxyribonucleotide triphosphates.

When the biosensors are used as DNA chips, fixed nucleic acid probes can be used as reagent layers. In such cases, the electrodes are preferably placed in an array.

The reagent layers are formed near each electrode set, or on a partial or entire electrode surface, to constitute, together with the electrodes, the reaction-detecting section. Such reagent layers can be formed by a dispenser method, where a dispenser or the like is used to add drops which are then dried; by a screen-printing method in which viscosity is adjusted; and so on. Specifically, dispenser methods are preferable. The reagent layers can be fixed to the top surface of the electrode or substrate using an adsorption method involving a drying step or a covalent binding method.

A convex partition section can be provided between reagent layers. The reagent layers can be placed not only at one region but also at two or more regions, where two or more different kinds of reagent layers may be provided.

The reagent layers may be mixed with an adhesive used as a spacer material, or the like.

Such reagent layers can be placed not only at one location, but also at two or more locations. In such cases, two or more different kinds of reagent layers may be provided. When reagent layers are provided at two or more places, a convex partition section can be provided between them. The convex partition section can be formed by screen-printing and can be made of carbon, resist, or water-absorbing materials.

Part of the region sandwiched between the substrate and cover can comprise a desiccant and/or deoxidant. The desiccant and/or deoxidant are preferably comprised in a sealed cap portion.

Thus, since the biosensors of the present invention are sealed with a reaction-detecting section included inside, such desiccants and/or deoxidants provided in the biosensors can maintain an internal dry or oxygen-free state over a long period of time.

By using such desiccants and/or deoxidants, the internal atmosphere of the biosensor can be dry or deoxygenated, even when the biosensors are manufactured and sealed in an atmosphere containing humidity or oxygen during the biosensor assembling step to include the reaction-detecting section.

The above-described desiccants and/or deoxidants are preferably present inside the sealed cap portion, which becomes unnecessary after cutting. This avoids direct contact with the sample solution. The sealed cap portion and sensor portion are connected inside via the spacer or sample-feeding path. Thus, even when the desiccant and/or deoxidant are present in the sealed cap portion, the inner space of the spacer, present between the substrate and cover in the structure of the biosensors in the preserved state before use, can be dried or deoxygenated. In particular, the desiccant and/or deoxidant can keep the inner space of the biosensors in a dry and/or deoxygenated state via a sample-feeding path, where the desiccant and/or deoxidant are arranged in the sealed cap portion to cross the sample-feeding path.

Furthermore, since the biosensor sealed cap portion with desiccant and/or deoxidant inside is cut and removed when the biosensor is used, the sample solution does not contact the desiccant and/or deoxidant when in use.

Examples of the desiccant include porous structures such as silica gel, active alumina, potassium chloride, molecular sieves, and hygroscopic polymer.

Examples of the deoxidant include powder consisting of metal halide and metal such as iron, and organic compounds such as hydrosulfite, active magnesium (see, e.g., JP-A No. 2001-37457), ascorbic acid (see, e.g., JP-A No. Hei 05-7772), catechol compounds (see, for example, JP-A No. Hei 09-75724), and polyvalent alcohols (see, for example, JP-A No. 2003-144113). These deoxidants may be supported by well-known carriers (see, for example, JP-A No. 2001-37457). Commercially available deoxidants include, for example, AGELESS® (produced by Mitsubishi Gas Chemical Company, Inc.) and VITALON® (produced by Toagosei Chemical Co., Ltd.).

In addition, the biosensors of the present invention can comprise a humidity indicator and/or oxygen-detecting agent in a part of the region sandwiched between the substrate and cover. In order to confirm a dry and/or deoxygenated state in the biosensor prior to use, a humidity indicator in combination with a desiccant; and/or oxygen-detecting agent in combination with a deoxidant, can be used.

The humidity indicator is not particularly limited as long as it can be used in the packaging of the present invention.

Commercially available oxygen-detecting agents include, for example, AGELESS EYE® (produced by Mitsubishi Gas Chemical Company, Ltd.) and VITALON®-oxygen-detecting agent (produced by Toagosei Chemical Co., Ltd.).

A part or all of the substrate or cover is preferably a material transparent to visible light, so the humidity indicator and/or oxygen-detecting agent is visible.

A part or all of the substrate or cover is also preferably of a material that can shield ultraviolet rays. In such cases, all of the substrate or cover may be an ultraviolet-shielding material, or the top surface of the substrate or cover may be covered with an ultraviolet-shielding film. Examples of this film include films that comprise an organic compound such as benzotriazole, or a fluorescent agent that converts ultraviolet rays to visible light.

When using a substrate or cover not transparent to visible light, the above-described humidity indicator and/or oxygen-detecting agent can be arranged at the spacer portion of the cut surface that newly appears when the sealed cap portion is cut. In such cases, the humidity indicator and/or oxygen-detecting agent may be contained in the spacer layer or constituted as a part of the spacer layer. This arrangement can allow the state inside a biosensor, indicated by the humidity indicator and/or oxygen-detecting agent, to be confirmed at the cut surface or inside near the cut surface after cutting and immediately before use.

The substrate or cover is preferably made of a material that does not transmit ultraviolet. Alternatively, the top surfaces of the substrate or cover may be coated with an ultraviolet-absorber or a material that does not transmit ultraviolet.

Transmission of ultraviolet rays can be suppressed or blocked when the substrate or cover are made of a material that does not transmit ultraviolet, or are coated with an ultraviolet-absorber or a material that does not transmit ultraviolet, as described above.

The ultraviolet-absorbers are not particularly limited and include, for example, metals such as aluminum, metal halides such as silver chloride, fluorescent agents, and organic compounds such as benzotriazole.

Materials that do not transmit ultraviolet are not particularly limited and include, for example, vapor-deposited film, consisting of metals such as aluminum or of metal halides such as silver chloride, and organic compound films of benzotriazole or the like.

The substrate or cover may comprise a compound with photocatalytic effect, or a top surface of the substrate or cover may be coated with a layer comprising a compound with photocatalytic effect.

Herein, the term “photocatalyst” means a compound excited by light absorption into an active state, exerting a strong oxidation-reduction effect on organic compounds in contact with the top surface of the photocatalyst. A “photocatalytic effect” is such an oxidation-reduction effect.

The above-described light includes ultraviolet rays and/or visible light. An input of ultraviolet rays and/or visible light causes a photocatalytic effect at the top surface of the biosensor. This effect results in self-purification, such as sterilization, decomposition of viruses with capsids and envelopes comprising proteins, and degradation of stains adhering to the top surface. This allows preservation under constantly sanitary conditions. Accordingly, this type of biosensor is particularly effective when used in fields such as the medical field, where biosensors are directly contacted with biological samples, and in fields where food or the like is handled.

Compounds with photocatalytic effect include metal oxides. Metal oxides that can be used specifically include, without limitation, at least one selected from the group consisting of titanium oxide, titanium dioxide, zinc oxide, titanium oxide strontium, tungsten trioxide, ferric oxide, bismuth trioxide, and tin oxide.

Spacer layers may comprise a fluorescent or luminescent agent close to an exposed sample-inlet port, or close to a sample-inlet port and an air-discharge port. It is particularly preferable that the fluorescent or luminescent agent is comprised near the sample-inlet port.

The fluorescent or luminescent agent can form a mark to improve visibility, and thus can prevent mishandling in supplying samples. When the fluorescent or luminescent agent is used at the cut surface portion, it may be comprised in the spacer material or constituted as part of the spacer. When the fluorescent or luminescent agent is used as a mark near the sample-inlet port of the substrate or cover, the mark can be formed by printing or such. The luminescent agent may be one well known in the art, with a light emission reaction that starts upon contact with oxygen in the air.

The electrodes may form an array. Preferable biosensors forming the array are those in which at least one sample-inlet port is exposed when the sealed cap portion is cut along the cutting plane line, and in which the reaction-detecting section comprising at least one set of electrodes is located ahead of the sample-feeding path connected to the sample-inlet port. At least one sample-inlet port may be connected to at least two sample-feeding paths branched from the sample-inlet port, and the reaction-detecting section comprising at least one set of electrodes may be located ahead of the sample-feeding path.

Herein, the term “array” means an arrangement in an arrayed condition.

When at least two sample-feeding paths are branched from one sample-inlet port, a surfactant may be coated inside the sample-feeding path so that the sample solution can reach all of the arrayed reagent layers. Alternatively, when the sample solution is blood or such, heparin, prolixin-S, or a metal salt of ethylenediaminetetraacetic acid or citric acid may be coated as an anticoagulant agent.

The substrate or cover comprising a material transparent to visible rays may be coated with a protective film.

In such cases, the visibility of the oxygen-detecting agent or the humidity indicator located at the spacer layer of the sealed cap can be ensured. The protective films can serve to prevent the influence of visible light and ultraviolet rays on the reagent layer of the biosensors.

The external terminal may be coated with a protective film. The protective film is used to cover the electrode terminals, connecting portions of the measuring unit, or the like, which are exposed on the same surface of the biosensor, as necessary until use. Protective films may have a single or multi layer structure.

Such a protective film may comprise portions with a detachable adhesive layer and a non-adhesive portion. The non-adhesive portion can be used as a grip portion for separating the protective film. The portion with the detachable adhesive layer is generally called the “peel seal” or “weak seal portion”, and can be easily separated with a certain degree of pulling force.

Preferable protective films characteristically block at least one of humidity, ultraviolet rays, or oxygen.

The materials for the protective films are preferably, for example, plastic films such as polyvinylidene chloride, polyethylene, polyester, nylon, ethylene-vinyl alcohol copolymer, and fluorine resin. Such plastics are flexible and excellent at shielding humidity.

Protective films comprising ultraviolet-absorber or a material that does not transmit ultraviolet are preferably used for blocking ultraviolet rays. Protective films comprising a desiccant, deoxidant, or the like are preferably used for blocking oxygen.

An external terminal may be covered with a cover, and the cover may have a fold-line that can be folded to expose the external terminal. In such cases, packaging of the main body and simple packaging with the protective film are unnecessary, since the terminals are stored in the cover before use, i.e., in the main body of the biosensors of the present invention.

Examples of the fold-line include perforations, notches, cuts, and recesses. The fold-back or folding process can be made easier by providing two parallel lines of perforations or the like on the fold-back or folding portion. To facilitate fold-pack or folding, the adhesive layer used to form the spacer is preferably absent from the fold-back or folding portion.

The substrate's detachable adhesive can be provided in at least one location on the inner surface of the fold-back or folding portion of the cover. With a force naturally applied to the fold-back or folding portion of the cover, the detachable adhesive can adhere the cover at a level that does not expose the terminal portion of the biosensor in the preserved state. This can stably maintain the shape of the biosensor in its preserved state.

In such cases, the terminals contact with the detachable adhesive and are separate from the substrate, so the function of the terminals as conducting materials should not be influenced. Accordingly, the detachable adhesive is preferably arranged so as not to contact the terminals.

Furthermore, the two parallel lines of perforations or the like provided at the fold-back or folding portion of the cover enable two cover pieces to be overlapped and folded to face each other. In such cases, the detachable adhesive is preferably placed on the inner side of one of the two cover pieces that cover the end portions of the terminals. This enables the shape of the biosensor in the preserved state to be stably maintained. In addition, the detachable adhesive can also be used to adhesively fix the two cover pieces when they are folded to face each other.

The biosensor packages of the present invention retain a number of the above-mentioned biosensors. More specifically, a number of simply packaged biosensors of the present invention can be packaged together using a bottle container system, a box container system, or the like.

Furthermore, when a number of biosensors of the present invention are aligned in a container using a box container system or the like, and are removed from the container in order, it is possible to print the serial number of each biosensor or the number of the remaining biosensors in the container on the main body or the protective film.

Multiple biosensors can be regularly laid out at predetermined intervals, and cut-away perforations may be provided at the substrates of adjoining biosensors.

This structure can enable efficient manufacture of multiple biosensors at one time. In addition, each of the adjoining biosensors can be connected to a measuring section to provide a measuring device that can simultaneously measure multiple samples. Furthermore, as a number of biosensors are regularly laid out at predetermined intervals in the above-described structure, individual biosensors can be connected to the measuring unit by sequentially shifting the biosensors using rotation or the like. Measuring devices in this form can serially and automatically measure multiple samples. By forming perforations in the adjoining substrates, the retaining space can be smaller, and folding between adjoining biosensors, separation of individual electrodes, and such can be achieved.

Methods for using the biosensors of the present invention comprise the step of cutting a sealed cap to form a sample-inlet port and air-discharge port. As the sample-inlet port and air-discharge port are included in the sample-feeding path inside the biosensors in the manufacturing step, the interior of the biosensor is kept airtight when shipped. Since the part of the biosensor which does not contain the electrodes is separate during use, the sample-inlet port and air-discharge port are formed and exposed for the first time as the cut surface of the sample-feeding path, and the biosensor is ready for use.

The biosensor devices of the present invention comprise:
biosensors;
measuring sections for measuring electrical values at reaction-detecting sections of the biosensors;
display sections for displaying values measured in measuring sections; and
memory sections for saving measured values.
   The measuring methods in the measuring section can be any one of potential step chronoamperometry, coulometry, and cyclic voltammetry. “Potential step chronoamperometry” is a method where a given potential is externally supplied to an electrode; and changes in the current due to electrolysis are measured. “Coulometry” is a method where the amount of electricity that flowed until complete electrolysis of a target substance is measured; and the amount of the substance or the quantity of reaction electrons is calculated based on Faraday's laws. “Cyclic voltammetry” is a method for determining the current-voltage curve when scanning electrode potential over a certain range from positive to negative at a given speed, and is also called “potential scanning”.

Further, the biosensors comprise a wireless means for transmitting measurement data to the measuring section, preferably a non-contact IC card or Bluetooth.

Second Invention: Biosensors for Simultaneously Measuring Multiple Items

The biosensors for simultaneously measuring multiple items of the present invention comprise:
a substrate;
a cover connected to the substrate via a spacer layer; and
a number of biosensor unit-comprising substrates each containing at least one biosensor unit which comprises a reaction-detecting section including one electrode system and one reagent layer on the substrate, and a sample-feeding path including the reagent layer,
wherein each of the biosensor units comprise one reagent layer on one sample-feeding path,
a cutting plane line for dividing each of the biosensor unit-comprising substrates is provided at a top surface of the substrate or cover,
the cutting plane line and sample-feeding path are placed such that, when the substrate or cover is cut along the cutting plane line, a sample-inlet port for supplying a sample solution is open to a cut surface of each biosensor unit-comprising substrate as a cut port of the sample-feeding path.

Specifically, the biosensors for simultaneously measuring multiple items of the present invention comprise at least two biosensor unit-comprising substrates, in which a cutting plane line is provided to divide each biosensor unit-comprising substrate. Each biosensor unit-comprising substrate comprises at least one biosensor unit. A biosensor unit comprises one reaction-detecting section and one sample-feeding path. A reaction-detecting section comprises one electrode system and one reagent layer, where the electrode system is connected to an external connection terminal by lead lines. A reagent layer is preferably laid out where the sample-feeding path and the electrode system cross.

In the biosensors for simultaneously measuring multiple items of the present invention, one or more biosensor units are present on a single biosensor unit-comprising substrate, where each biosensor unit comprises one reagent layer on one sample-feeding path. Accordingly, as the sample solution supplied to the sample-feeding path reaches only one reagent layer, and is isolated from the other reagent layers, it is not affected by components diffused from other reagent layers.

The biosensors for simultaneously measuring multiple items of the present invention comprise a number of biosensor unit-comprising substrates, where cutting plane lines are provided to divide individual biosensor unit-comprising substrates. Accordingly, substrates or covers can be cut along cutting plane lines to divide each biosensor unit-comprising substrate.

When a substrate or cover is cut along a cutting plane line, the opening of the sample-feeding path is opened on the cut surface of each biosensor unit-comprising substrate formed by the cutting. This cut opening is used as the sample-inlet port. If the biosensors are structured such that the sample-feeding path crosses the cutting plane line twice, two cut openings appear, providing both a sample-inlet port and an air-discharge port.

Since the cut opening is only opened by cutting at the time of use, it can be reliably maintained. This is particularly useful when the cut opening is small. If the sample-inlet port and air-discharge port are both opened by cutting, the sample-feeding path can be sealed until use, and the activity of the reagent layer can be maintained. This can eliminate the need for packaging the biosensors, and thus significantly reduce manufacturing costs. When using the biosensors for simultaneously measuring multiple items of the present invention, the opened sample-inlet port can contact the sample solution to supply solution to the sample-feeding path from the sample-inlet port by capillary action. This procedure can considerably reduce the amount of sample solution used. Accordingly, even small amounts of test compound in the sample solution can be detected with high sensitivity.

A cutting plane line is provided on at least one of the substrate or cover. The cutting plane line is preferably formed from notches or cuts. When the cutting plane line is provided on both the substrate and cover, the notches or cuts are preferably laid out at identical substrate or cover positions so as to face each other.

Notches or cuts on the cutting plane line makes cutting easier. In addition, if the cutting plane lines are laid out in the same position, so as to face each other, substrates or covers which bend outside can be easily cut, and substrates or covers which bend inside can also be easily cut or bent.

Herein, the term “cut” means a cut formed in the substrate or cover constituting the biosensor, made from outside, but not deep enough to reach the interior. Therefore, the cuts do not thoroughly penetrate the substrate and cover before cutting. The cutting method is not particularly limited, and comprises a step of snapping, breaking, or tearing along the cutting plane line.

The sample-feeding path in the present invention is patterned by the spacer layer and provided on the substrate. The depth (height) of the sample-feeding path depends on the depth of the spacer layer, and is preferably in the range of about 5 to 500 μm, and more preferably in the range of about 10 to 100 μm. Capillary action occurs easily in sample-feeding paths with a depth in such a range.

The sample-feeding path preferably connects at least the sample-inlet port and reaction-detecting section, by a straight line or gentle curve. These shapes enable smooth movement of the sample solution. Therefore, the sample-feeding path preferably has no corners between these regions, and particularly no areas with acute angles.

In the present invention, the area around the sample-inlet port and the top surface of the sample-feeding path can be coated with a surfactant or lipid. Coating with a surfactant or lipid can ensure smooth movement of the sample solution.

Herein below, the present specification describes substrates, covers, spacers, electrode systems, reagent layers, etc.

Substrates, Covers, Spacer Layers, Electrode Systems

Substrates, covers, spacers, and electrode systems similar to those described in the aforementioned first invention can be employed in the biosensors for simultaneously measuring multiple items of this invention.

Reagent Layers

While one or a number of reagent layers can be present on the electrodes where the sample-feeding path passes in the aforementioned first invention, in the biosensors for simultaneously measuring multiple items of the second invention, one reagent layer can be present on the electrode system where the sample-feeding path passes. Except for this difference, reagent layers the same as those discussed for the aforementioned first invention can be used.

In the biosensors for simultaneously measuring multiple items, as mentioned above, one reagent layer is placed at one location on the sample-feeding path in each biosensor unit. According to this invention, after cutting the biosensor for simultaneous measurement of multiple items, each biosensor unit-comprising substrate will comprise at least one biosensor unit. When a number of different reagent layers are used, a biosensor unit-comprising substrate can comprise a number of biosensor units.

Since one reagent layer is provided on one sample-feeding path in the biosensors for simultaneously measuring multiple items, sample solutions are not mixed, even when one biosensor unit-comprising substrate comprises two or more biosensor units. When one biosensor unit-comprising substrate comprises two or more biosensor units, however, a convex partition section can be provided between the reagent layers of each biosensor unit to more surely prevent mixing of sample solutions. The convex partition section can be formed by screen-printing, and can be made of carbon, resist, or water-absorbing material.

In the present invention, the sample-feeding path is preferably provided such that the sample-inlet port opens at the cut surface, and an air-discharge port is provided at the surface of the substrate or cover, or at a side surface of the biosensor unit-comprising substrate which differs from the cut surface. In such cases, while the angle at which the cut surface and sample-feeding path cross each other is not limited, it is preferably 0 degrees or more to less than 180 degrees, more preferably 0 degrees or more to 120 degrees or less, and still more preferably 0 degrees or more to less than 100 degrees.

Herein, the sample-feeding path in the biosensors for simultaneously measuring multiple items of the second invention are also preferably sealed to provide the merits of the sealing system described in the aforementioned first invention.

In another preferred embodiment of the present invention, for example, the sample-feeding path is sealed in the biosensors for simultaneously measuring multiple items;
a cutting plane line (first cutting plane line), which divides each of the biosensor unit-comprising substrates, and a second cutting plane line, which is different from the first cutting plane line and is used to expose the air-discharge port by cutting parts of the substrate and cover, are provided on a top surface of the substrate or cover; and
the first and second cutting plane lines and the sample-feeding path are arranged such that the sample-inlet port is open as a cut opening on the first cut surface when the substrate or cover is cut along the first cut surface, and such that the air-discharge port is open as a cut opening on the second cut surface when the substrate or cover is cut along the second cut surface. In such cases, the sample-feeding path may be provided such that the sample-inlet port and air-discharge port are separately opened on the cut surface of each of the biosensor unit-comprising substrates, and a sealed sample-feeding path may be laid out before cutting.
   Auxiliary Devices

Herein, auxiliary devices may be provided on a top surface of the substrate or cover, such that the substrate or cover are bent along a second cutting plane line in response to bending of the substrate or cover along a first cutting plane line.

Materials for the auxiliary device are not particularly limited, and may stretch or not. Preferably, auxiliary devices are of sufficient strength to cut the cut portion of the substrate or cover to open the air-discharge port along the cutting plane line. Furthermore, auxiliary devices are preferably fixed to a part or all of the portion serving as the opening of the air-discharge port.

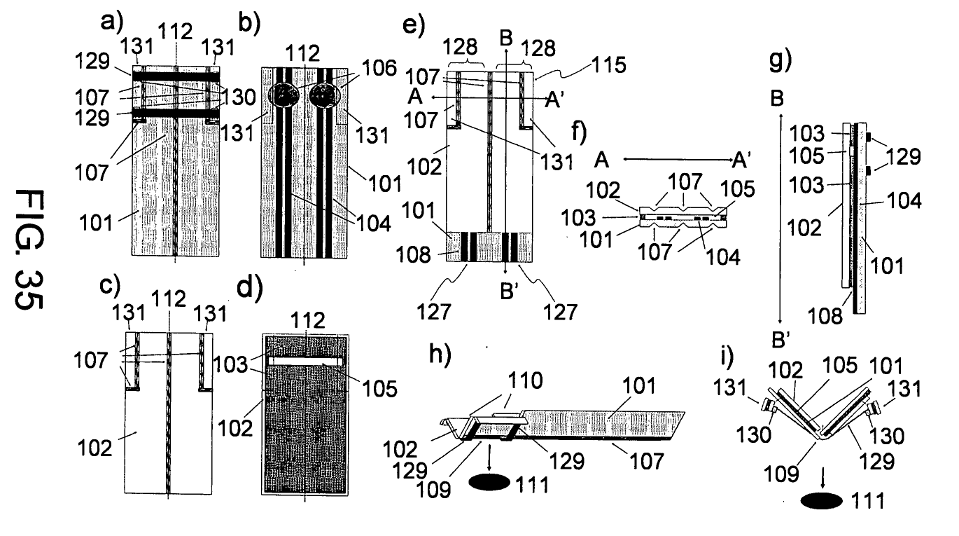

Such an auxiliary device may be, for example, strap-shaped stretchable plastic. As shown in FIG. 35 for example, both ends of one strap are connected to the upper outward-folding portions 131 at both ends of the biosensor unit-comprising substrate. When the cover (or substrate) is bent and cut along the first cutting plane line, the upper outward-folding portions 131 are pulled by the strap in response to bending, and are bent and cut along the second cutting plane line. This process can automatically open the air-discharge port.

Connectors

Specific connectors are needed to capture electrochemical signals from the biosensors for simultaneously measuring multiple items of the present invention.

Preferable connectors of the present invention fix the biosensors for simultaneously measuring two items so they capture electrical signals. Preferable connectors comprise:
a sensor shape-fixing section (folder) for fixing the bent shape of the biosensor unit-comprising substrate, bent for opening the sample-inlet port; and
an electrical connection section and wiring, for capturing electrical signals on the biosensor, and electrical signals at the electrodes of the biosensors.

The above-described connector has a structure that alters the structure of a sensor formed flat, to supply a sample solution to the sample-inlet port of the newly opened sensor, and to maintain the biosensor's shape until measurement is complete. Therefore, the shape of the connectors is not particularly limited, as long as it satisfies the above-mentioned conditions and reliably captures electrical signals from the sensor. Furthermore, the connectors may be incorporated in a measuring unit, or used in connection with an electrochemical measuring unit.

For example, preferable connectors comprise a folding portion and a folder that maintains the folded sensor shape. In such cases, the folding portion and folder may be identical or independent. Furthermore, the folding portion is preferably structured such that the biosensor structure can be changed from a flat shape to a non-flat shape, and more preferably, to a V shape. In such cases, the folding portion is preferably designed such that the angle at which the cut surface and sample-feeding path cross is, without limitation, 0 degrees or more to less than 180 degrees, more preferably 0 degrees or more to 120 degrees or less, much more preferably 0 degrees or more to less than 100 degrees. The above-described conditions can be applied even when the folding portion functions as the folder. The folding portion may be, without limitation, a type which changes the shape of the biosensors by sliding and connecting the sensor to the connector, or a type which changes the shape by sandwiching the sensor with the upper and lower angled folding portions.

In another preferable embodiment of the present invention, the sample-feeding path may be provided such that both the sample-inlet port and air-discharge port are open at the cut surface of each of the biosensor unit-comprising substrates, and the sealed sample-feeding path may be laid out before cutting. That is, since the biosensors for simultaneously measuring multiple items of the present invention keep the sample-feeding path airtight before cutting, including the reaction-detecting section, their internal state can be maintained over a long period of time, and the internal environment of the biosensors, specifically, the vapor composition (deoxygenated state), atmospheric pressure, and humidity (humid conditions), can be controlled to a certain preferred environment.

Some sample solutions cannot be smoothly supplied by a dry sample-feeding path of the biosensors for simultaneously measuring multiple items but even these sample solutions can be smoothly supplied to the biosensors by uniformly applying a surfactant or the like to the inner wall or the like of the sample-feeding path, maintaining a given humidity. When the sample solution is blood or such, heparin, prolixin-S, or a metal salt of ethylenediaminetetraacetic acid or citric acid may be coated as an anticoagulant agent, alone or together with a surfactant.

The sample-feeding path of the present invention is preferably laid out such that one sample-inlet port is formed per biosensor unit. Such a sample-feeding path layout better eliminates the influence of components diffused from the other reagent layers.

In the present invention, at least one of the substrate or cover may comprise a multilayer structure comprising at least two layers, and the cutting plane line may be formed at any layer of the multilayer structure, excluding the innermost layer.

When the substrate or cover has a multilayer structure of at least two layers, the cutting plane lines are formed to leave at least the innermost layer of the multilayer structure. Furthermore, the cutting plane lines are preferably laid out at identical positions of the substrate or cover so as to face each other. By forming the cutting plane line to leave at least the innermost layer, the biosensors with a multilayer structure for simultaneously measuring multiple items can be formed without sustaining any damage, such as flaws in the inner layer portion. The above-described biosensors are advantageous in that they can endure forces such as sudden bending applied in the manufacturing process or in storage state.

In the present invention, a part of the region sandwiched between the substrate and cover can comprise a desiccant and/or deoxidant. As the biosensors for simultaneously measuring multiple items of the present invention are sealed with the reaction-detecting section included therein, such a desiccant and/or deoxidant, when provided in the biosensor, can maintain an internal dry state or oxygen-free state over a long period of time. Even when the biosensors are manufactured and sealed such that the reaction-detecting section of the biosensors is included in an environment containing humidity or oxygen at the time of assembling the biosensor, the interior of the biosensor can be set in a dry or deoxygenated state. The desiccant and/or deoxidant preferably avoids direct contact with the sample solution. It is also preferable that the desiccant and/or deoxidant are arranged so as not to cross the sample-feeding path. The same desiccants and deoxidants as described for the aforementioned first invention can be used.

The biosensors for simultaneous measurement of multiple items of the present invention can comprise a humidity indicator and/or oxygen-detecting agent in a part of the region sandwiched between the substrate and cover. To confirm a dry and/or deoxygenated state in the biosensor for simultaneous measurement of multiple items, a desiccant in combination with a humidity indicator, and/or a deoxidant in combination with an oxygen-detecting agent, can be used. Humidity indicators are not particularly limited as long as they can be used in the packaging of the present invention. The same oxygen-detecting agents as those described for the aforementioned first invention can be used.

In such cases, it is preferable that a part or all of the substrate and/or cover are of a material transparent to visible rays, rendering the humidity indicator and/or oxygen-detecting agent visible. It is also preferable that a part or all of the substrate and/or cover are of a material that can shield ultraviolet rays. In such cases, the entire substrate and/or cover may be an ultraviolet shielding material, or the top surface of the substrate and/or cover may be coated with a film of an ultraviolet-shielding material. Examples of the film include films comprising an organic compound such as benzotriazole or the like, and films comprising a fluorescent agent which converts ultraviolet rays to visible light.

When using a substrate or cover that is not transparent to visible light, the humidity indicator and/or oxygen-detecting agent can be arranged to be present at the spacer portion of the cut surface that newly appears when the sealed cap portion is cut. In such cases, the humidity indicator or oxygen-detecting agent may be contained in the spacer layer, or constituted as part of the spacer layer. This arrangement enables confirmation of the state of the interior, as indicated by the humidity indicator and/or oxygen-detecting agent, at the cut surface or inside near the cut surface after cutting and immediately before use.

The substrate or cover is preferably made of a material that does not transmit ultraviolet light. The top surface of the substrate or cover may be coated with an ultraviolet absorber or a material that does not transmit ultraviolet. When the substrate or cover are made of an ultraviolet non-transmitting material, or are coated with an ultraviolet-absorber or a material that does not transmit ultraviolet, transmission of ultraviolet rays can be inhibited or blocked. The ultraviolet-absorbers and materials that do not transmit ultraviolet that can be used are the same as those described for the aforementioned first invention.

The substrate or cover may contain a compound with a photocatalytic effect, or the top surface of the substrate or cover may be coated with a layer containing a compound with a photocatalytic effect. Compounds with a photocatalytic effect that may be used are the same as those described for the aforementioned first invention.

A spacer layer close to an exposed sample-inlet port, or close to a sample-inlet port and an air-discharge port, may comprise a fluorescent or luminescent agent. It is particularly preferable that the fluorescent or luminescent agent is close to the sample-inlet port.

The fluorescent or luminescent agent can form a mark to improve visibility, and thus can prevent mishandling when supplying the sample. When a fluorescent or luminescent agent is used at the cut surface portion, it may be comprised in the spacer member or constituted as part of the spacer. When the fluorescent or luminescent agent is used to form a mark near the sample-inlet port of the substrate or cover, the mark can be formed by printing or such. Luminescent agents may be those well known in the art, where a light emission reaction starts upon contact with oxygen in the air.

The electrodes in the biosensors for simultaneously measuring multiple items of the present invention may form an array. When a biosensor forming an array is cut along the cutting plane line, at least one sample-inlet port is opened, and a reaction-detecting section comprising one electrode system and one reagent layer is located ahead of one sample-feeding path connected to the sample-inlet port. The one sample-inlet port may be connected to one sample-feeding path, or connected to at least two sample-feeding paths branched from the sample-inlet port. The reaction-detecting section comprising one electrode system may be located ahead of the sample-feeding path. In particular, one sample-inlet port is preferably connected to one sample-feeding path. This more surely prevents mixing of sample solutions in the reagent layers. When at least two sample-feeding paths are branched from one sample-inlet port, a surfactant may be coated inside the sample-feeding path so that the sample solution can reach all of the arrayed reagent layers. When the sample solution is blood, heparin, prolixin-S, or a metal salt of ethylenediaminetetraacetic acid or citric acid may be coated as an anticoagulant agent.

The biosensors for simultaneously measuring multiple items of the present invention comprise at least two biosensor unit-comprising substrates. When the biosensors comprise at least three or more biosensor unit-comprising substrates, each of the biosensor unit-comprising substrates is preferably regularly laid out on the serial substrates at predetermined intervals while separated by cutting plane lines. This structure enables efficient manufacture of biosensors for simultaneously measuring multiple items at a time. Each of the biosensor units in the adjacent biosensor unit-comprising substrates can be connected to a measuring section to simultaneously measure multiple samples.

The biosensors for simultaneously measuring multiple items of the present invention can be manufactured, for example, by pre-patterning the electrode systems on the substrate and the spacers on the top surface of the substrate or cover, then laying out the reagent layer, and adhering the substrate and cover using an adhesive. Specifically, for example, the cutting plane line is pre-formed on the outside surface of the substrates, and then the electrode pattern is formed inside the substrates by screen-printing or the like. Meanwhile, similarly, the cutting plane line is pre-formed on the outside surface of the cover as necessary, and then the pattern of the adhesive layer is formed as the spacer inside the cover.

A reagent layer can be formed on the sample-feeding path of the substrates by using a dispenser method to drop an enzyme-comprising reagent solution. The space where a regulating agent or indicator is placed can be simultaneously formed on the substrate or cover as part of the spacer pattern formed inside the cover. The biosensors for simultaneously measuring multiple items can be constructed by adhering the covers and the substrates, formed as described above.

<Method for Using a Biosensor for Simultaneous Measurement of Multiple Items/Method for Measuring Test Compounds>

The present invention provides methods for using the biosensors for simultaneously measuring multiple items, wherein said methods comprise the steps of:
(1) bending the substrate or cover along a cutting plane line which divides biosensor unit-comprising substrates, and cutting the substrate or cover to open the cut opening (sample-inlet port) of the sample-feeding path on the cut surface of each biosensor unit-comprising substrate;
(2) fixing a shape of the bent biosensor unit-comprising substrate to keep the sample-inlet port open;
(3) contacting the open sample-inlet port with a solution comprising a measuring target; and
(4) supplying the solution comprising the measuring target to the sample-feeding path.

The present invention also provides methods for measuring a measuring target using the biosensors of the present invention, wherein said methods comprise the steps of:
(1) bending the substrate or cover along a cutting plane line which divides biosensor unit-comprising substrates, and cutting the substrate or cover to open the cut opening (sample-inlet port) of the sample-feeding path on the cut surface of each biosensor unit-comprising substrate;
(2) fixing a shape of the bent biosensor unit-comprising substrate to keep the sample-inlet port open;
(3) contacting the open sample-inlet port with a solution comprising a measuring target;
(4) supplying the solution comprising the measuring target to the sample-feeding path; and
(5) measuring the measuring targets with the respective biosensors.

At the above-described step (1), both the substrate and cover can be cut to expose the cut surface, and then step (3) can be performed. Alternatively, one of the substrate or cover can be cut and bent, and the other can be left connected to expose the cut surface, and then step (3) can be performed while the biosensor for simultaneous measurement of multiple items is bent. The latter mode is particularly preferable.

After the above-described cutting step, the cut surface of each biosensor unit-comprising substrate of the biosensors for simultaneously measuring multiple items of the present invention, or the cut surfaces of a number of biosensor unit-comprising substrates at one time, can be contacted with the solution, as in step (3). When the cut surfaces of multiple biosensor unit-comprising substrates are simultaneously contacted with a solution, the biosensor unit-comprising substrates preferably comprise one biosensor unit, or two or more biosensor units. In such cases, to expose the cut surface it is preferable to cut and bend one of the substrate or cover, with the other left connected. When the cut surface of each biosensor unit-comprising substrate is contacted with a solution, the biosensor unit-comprising substrate preferably comprises a number of biosensor units. It is preferable that the substrates or covers are cut to expose the cut surfaces, and that each biosensor unit-comprising substrate is then used. In this way, simultaneous measurement of biosensor units comprising a number of reagent layers can be provided.

The measuring targets are not limited, as long as they can be measured by the biosensors. For example, measuring targets can be the amounts of compounds such as enzymes and DNAs, the quantity of ions, the quantity of oxygen, the pH of the solution, and properties such as conductivity.

<Biosensor Devices>

The biosensor devices of the present invention comprise:
biosensors for simultaneous measurement of multiple items;
connector sections which capture electric signals at electrodes of the biosensors;
measuring sections which measure electrical values via connector sections;
display sections which display values measured in the measuring sections; and
memory sections which save measured values.

It is preferable that the connector section alters the shape of the biosensor unit-comprising substrate for opening the sample-inlet port; fixes the biosensor unit-comprising substrate with the shape; and then captures electrical signals at the electrodes of the biosensor.

Preferable measuring methods in the measuring section are potential step chronoamperometry, coulometry, or cyclic voltammetry.

<Applications>

The first and second biosensors for simultaneously measuring multiple items of the present invention can be used to measure the following measuring targets, by changing reagent layer types.

In enzyme sensors, for example, the type of enzyme used as a molecular identifier is changed according to the sample's measurement target. For example, glucose oxydase or glucose dehydrogenase is used when the measuring target is blood glucose (glucose) or urine sugar; a mixture of fructosyl amine oxidase and protease is used when the measuring target is glycosylated hemoglobin; lactate oxydase is used when the measuring target is lactic acid; a mixture of cholesterol esterase and cholesterol oxydase is used when the measuring target is the total cholesterol or the like; urate oxydase is used when the measuring target is uric acid; alcohol oxydase is used when the measuring target is ethanol; glutamate oxydase is used when the measuring target is glutamate; pyruvate oxidase is used when the measuring target is pyruvic acid or phosphoric acid; a combination of maltose phosphorylase, alkaline or acid phosphatase, and/or mutarotase, and glucose oxydase is used when the measuring target is maltose or phosphoric acid; and a combination of sucrose phosphorylase, alkaline or acid phosphatase, mutarotase, and glucose oxydase is used when the measuring target is sucrose or phosphoric acid.

In the above-described enzyme sensors, electron carriers (mediators) are used together with enzymes. As the mediators, potassium ferricyanide, ferrocene, ferrocene derivatives, nicotinamide derivatives, flavin derivatives, benzoquinone, quinone derivatives, and the like can be used.

In pH sensors, a reagent layer of a quinhydrone and inorganic salt such as sodium chloride or potassium chloride is provided on the substrate comprising a silver/silver chloride electrode and another electrode. In such cases, a change in potential between electrodes is measured.

In single nucleotide polymorphism (SNP) sensors (A. Ahmadian et al., Biotechniques, 32, 748, 2002), a mixture of primers, DNA polymerases, and deoxyribonucleotide triphosphates is further used as a reagent on the pH sensors to measure a change in pH when the subject DNAs complement to the primers in the sample.

In immunosensors, the antigen-antibody reactions are used. For example, when serum albumin is measured, anti-albumin is uses as a molecular identifier. The immunosensors measure the potential between the electrodes, which changes depending on the formation of an antigen-antibody complex.

In microorganism sensors, microorganisms and soil microbes of the genus Acetobacter, Actinomaaura, Agrobacterium, Alcaligenes, Aphanomyces, Armillaria, Aspergillus, Bacillus, Burkholderia, Candida, Cephalosporium, Ceratocystis, Cladosporium, Clavibacter, Corticium, Corynebacterium, Cylindrocarpon, Cylindrocladium, Enterobacter, Erwinia, Flavobacterium, Fusarium, Gaeumannomyces, Ganoderma, Gibberella, Gliocladium, Gluconobacter, Glycomyces, Helicobasidium, Actobacillus, Leptosphaeria, Micobacterium, Micrococcus, Monosporascus, Mucor, Nocardia, Olpidium, Pasteuria, Penicillium, Phoma, Plasmodiophora, Phytophthora, Polymyxa, Proteus, Pseudomonas, Pyrenochaeta, Pythium, Ralstonia, Rhizobium, Rhizoctonia, Rhizopus, Rhodococcus, Rosellinia, Saccharomonospora, Sclerotina, Scietotium, Serratia, Sphingomonas, Spongospora, Streptococcus, Streptomyces, Streptoverticilium, Synchytrium, Talaromyces, Thanatephorus, Thielaviopsis, Torula, Trichoderma, Typhula, Verticillium, Zymomonas, and Xanthomonas are used as the molecular identifier, such as Pseudomonas fluorescence (measuring target is glucose or BOD (biochemical oxygen demand), soil), Trichosporon cutaneum, Pseudomonas putida (measuring target is BOD), and Trichosporon brassicae (measuring target is ethanol).

As these microorganisms aerobically respire (i.e., are aerobic bacteria), or produce metabolites in an oxygen-free environment, the amount of aerobic respiration or metabolites are to be monitored electrically.

Organella sensors use cell organella as the molecular identifiers. By using mitochondrial electron transport particles, for example, NADH can be measured. This is based on the following principle: NADH is oxidized by mitochondrial electron transport particles, at which time oxygen is consumed; and thus NADH and NADPH can be measured using oxygen as an index.

In receptor sensors, for example, receptors such as cell membranes are used as molecular identifiers. Hormones, neuro transmitters, or the like become target samples. The measuring principle is that a change in reception is converted to an electrical potential and measured via electrodes.

A tissue sensor uses the tissues of plants or animals as molecular identifiers. As plant or animal tissues, for example, frog skin, sliced animal liver, or cucumber or banana peel can be used. For example, the measuring principle with sodium sensors using frog skin tissues is as follows: the frog skin tissue selectively passes sodium ions, changing the potential of the skin tissues; and thus measuring the change in potential will provide the amount of sodium ions.

Another application of the first and second biosensors as described above is a DNA chip. In DNA chips, multiple kinds of single-stranded nucleic acid probes, which are complementary to multiple types of target genes to be detected, are fixed onto an array of electrodes, and one nucleic acid probe is fixed to one electrode. To confirm the presence or absence of multiple target genes, sample genes denatured to single-stranded are hybridized with the nucleic acid probes, and then double strand identifiers, which are electrochemically active and specifically bind to double-stranded nucleotides, are added. After washing, the substrate is folded in buffering solution. A voltage is sequentially applied to each electrode using the arrayed electrodes as the working electrode, and an upper large electrode as the opposite electrode. Double-stranded intercalating agent is oxidized when a double strand is formed, causing an oxidation current to flow. Current caused by the intercalating agent does not flow in electrodes when a double strand does not form. The type of nucleic acid probes can be identified by the position of the electrode which generates the current. Thus, the presence or absence of target genes and their properties can be determined. Intercalators (intercalating agents) such as acridine orange, and metaro intercalators (intercalating agents) such as tris-phenanthroline cobalt complex, can be used as double strand identifiers.

<Manufacturing Methods>

The first and second biosensors of the present invention can be manufactured, for example, by pre-patterning an electrode system on the substrate, and the spacer on the top surface of the substrate or cover; then laying out the reagent layer; and finally adhering the substrate or cover using an adhesive. More specifically, the first biosensors, for example, can be manufactured as follows: A cutting plane line is formed on the outside surface of a substrate, and then an electrode pattern is formed inside by screen printing or the like. Meanwhile, similarly, a cutting plane line is formed on the outside surface of a cover, and a pattern of an adhesive layer is formed inside as a spacer. A portion on the cover where the adhesive layer is not present is used as the space in a sample-feeding path and a sealed cap portion where a regulating agent or indicator is placed.

By using a dispenser method to drop an enzyme-comprising reagent solution, a reagent layer can be formed on the sample-feeding path of a substrate on at least one portion of the sample-inlet port and air-discharge port, which are formed by separating the sealed cap. The space where the regulating agent or indicator is placed can be formed on the cover at the same time, as a part of the adhesive layer pattern formed inside the cover. Biosensors with a boundary with the sealed cap can be constructed by adhering the cover and substrate formed in this manner.

After development of the reagent layer, the biosensor assembling steps do not use packing systems accompanied by heat, such as thermal compression or the like, and can be performed by merely adhering the substrate and cover via the spacer. A sample-feeding path to be the sample-inlet port and air-discharge port are included inside the biosensors manufactured as described, and thus the interior of the biosensors can be kept highly airtight. The second biosensors can be manufactured by using the same methods.

The biosensors of the present invention can be easily manufactured without using thermal compression or the like, and can increase yield, allowing the influence of oxidation of reagent layers to be eliminated, and providing excellent preservation stability over a long period of time. In addition, the essential portions of the biosensors, such as the sample-inlet port, the sample-feeding path, and the reaction-detecting section, are completely sealed after the manufacturing step, ensuring the environment inside the biosensor is extremely airtight. Therefore, a preferred internal environment can be generated by regulating manufacturing steps, and can be maintained over a long period of time. The internal environment can be better maintained over a long period of time by incorporating a regulating agent such as desiccant, to adjust the internal environment as needed. Furthermore, when in use, the incorporated internal-environment regulating agent is separated from the body of the biosensors with a structure of the present invention, and thus contact with sample solutions can be completely eliminated.

Considering the structures, materials, and manufacturing methods of the biosensors of the present invention, the biosensors of the present invention can significantly reduce environmental burdens at the time of manufacture and after use, compared to conventional disposable biosensors.

The biosensors for simultaneously measuring multiple items of the present invention have specific structures and thus by using them, multiple items can be simultaneously measured, even with a small amount of sample solution, and by supplying sample solution to the sample-feeding path the influence of at least one other biosensor reagent can be eliminated.

Japanese Patent Application Nos. 2004-084116 and 2004-127937 are incorporated in the present application.

Any patents, published patent applications, and publications cited herein are incorporated by reference.

### BEST MODE FOR CARRYING OUT THE INVENTION

Herein below, the present invention will be specifically described using Examples, but it is not to be construed as being limited thereto.

### EXAMPLE 1

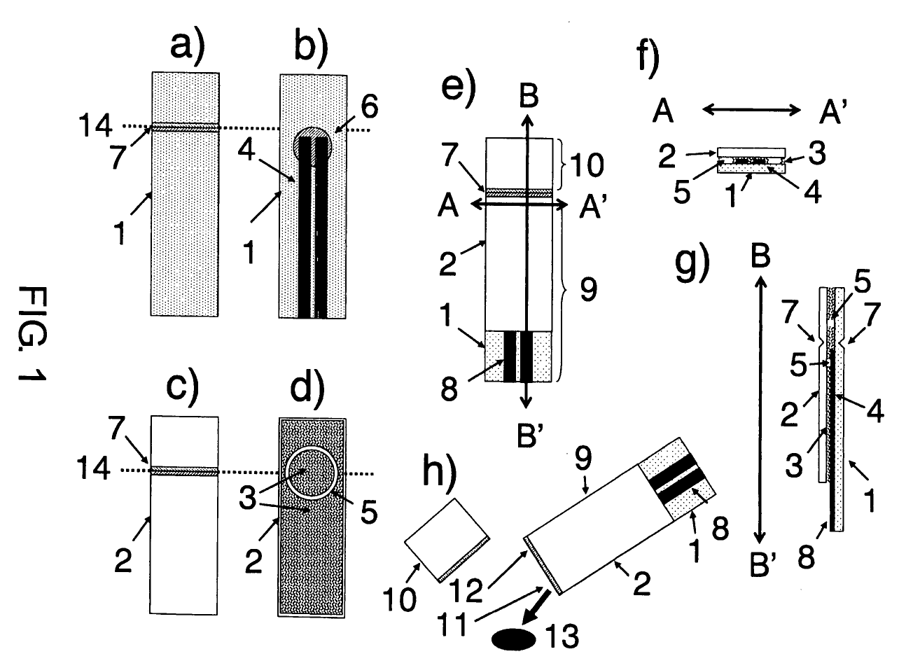

FIG. 1 shows a representative example of the biosensors of the present invention. FIG. 1 is an example of a biosensor of the present invention in which a cross section of sensor portion 10 appears on cutting the sealed cap portion that does not include an electrode, where the cross section of the sample-feeding path simultaneously forms a sample-inlet port and air-discharge port and is exposed to the outside for the first time.

FIG. 1a shows the outside of rectangular substrate 1 of a typical biosensor. On top of substrate 1 is a horizontally made V-shaped notch 7, which becomes a cutting plane line. Notch 7 is provided so that sealed cap portion 10 of the biosensor can be cut along broken line 14, by bending or the like, when using the biosensor.

FIG. 1b shows the inside of substrate 1. Both pattern 4, which includes a pair of electrodes, and reagent layer 6 are formed along the substrate 1 centerline, on the inside upper surface of the substrate. Pattern 4, which includes the electrodes, has two electrode members arranged in parallel from the bottom end until near broken line 14 at the top.

FIG. 1c shows the outside of cover 2. A horizontally formed notch 7, similar to the notch on substrate 1, exists along broken line 14 at the top of cover 2. FIG. 1d shows the inside of cover 2. On the upper surface of the inside of cover 2, an adhesive layer is formed as a spacer layer. A circular portion 5, comprising no spacer layer, is provided on cover 2 to form a reagent-feeding path by adhering with the substrate.

FIG. 1e is a structural diagram where the inner surfaces of substrate 1 and cover 2 are overlapped, aligning both top ends. By adhering substrate 1 and cover 2, the portion on cover 2 comprising no spacer becomes a space comprised inside the biosensor, resulting in sample-feeding path 5. By adjusting cover 2 to be shorter than substrate 1, overlapping the two with their top ends aligned causes the bottom of pattern 4, which includes the electrodes, to be exposed, resulting in terminal 8, as shown in FIG. 1e. The sensor portion 9 and sealed cap portion 10 are separated by the boundary of notch 7.

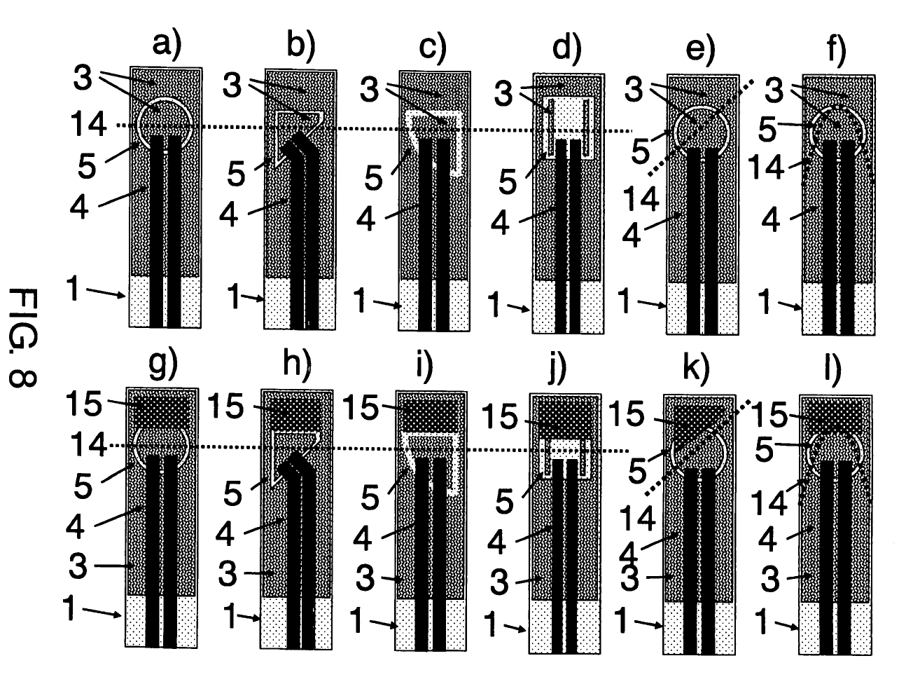

FIG. 8a shows the inner structure of the development of the biosensor in FIG. 1e, except for cover 2. Broken line 14 is provided on the circular sample-feeding path 5 to equally divide the sample-feeding path, indicating the place where the biosensor will be cut off. That is, broken line 14 as shown in this figure overlaps with notch 7 of substrate 1 and cover 2 (see, FIG. 1e). Therefore, cutting off sealed cap portion 10 of the biosensor along notch 7 (broken line 14) will expose openings at two positions in the space provided as the sample-feeding path 5, as shown in FIG. 1h. That is, two openings are exposed on the cross section of sensor portion 9: sample-inlet port 11 and air-discharge port 12. When sample solution 13 is supplied from sample-inlet port 11, the sample solution 13 is fed in the sample-feeding path by capillary action, and reaches a reaction-detecting section, comprising pattern 4, which includes two electrodes, and reagent layer 6. At the same time, a volume of air the same as the volume of sample solution fed to the sample-feeding path is exhausted from the air-discharge port 12.

FIG. 1f shows an A-A′ cross-sectional view of slightly below notch 7 in the sensor portion 9 of the biosensor shown in FIG. 1e. The two lines of pattern 4, which includes electrodes, are laid out on substrate 1. An adhesive layer exists as spacer 3 between the substrate and cover, around the electrodes. Sample-feeding path 5 is provided on both sides of the spacer layer of the electrodes. FIG. 1g shows a B-B′ cross-sectional view on the pattern of the electrodes of the biosensor as shown in FIG. 1e. V-shaped notches 7 are arranged on the outer surfaces of substrate 1 and cover 2, in such a way as to face and overlap each another. Pattern 4, which includes electrodes, extends until just before the V-shaped notch 7 on substrate 1. Spacer 3 and the two sample-feeding paths 5 are located between substrate 1 and cover 2. The lower sample-feeding path 5 is located on the electrodes, whereas the upper sample-feeding path 5 is on V-shaped notch 7, that is, on the part that is cut off when using the biosensor.

The structure of the biosensor of FIG. 1 indicates that the space that composes sample-feeding path 5 as well as the reaction-detecting section, which comprises pattern 4 including the two electrodes, is completely included inside the biosensor, thereby keeping the inside airtight. In addition, when the biosensor of the present invention is used, since the top view of sample-feeding path 5 forms a semicircular shape (FIG. 8a), the sample solution can be smoothly fed to the reagent layer located on the two electrodes, that is, to the reaction-detecting section.

Furthermore, the biosensors with this structure include the following characteristics: a very small quantity of sample solution can be used; the biosensors have a simple structure and can thus be easily manufactured; and the state of the biosensors at the time of manufacturing can be maintained until use, since the reaction-detecting section is included inside the biosensors, keeping them extremely airtight.

In addition to the above-mentioned characteristics common to the biosensors of the present invention, those for each form of the biosensors described in the present invention will be described hereinafter.

### EXAMPLE 2

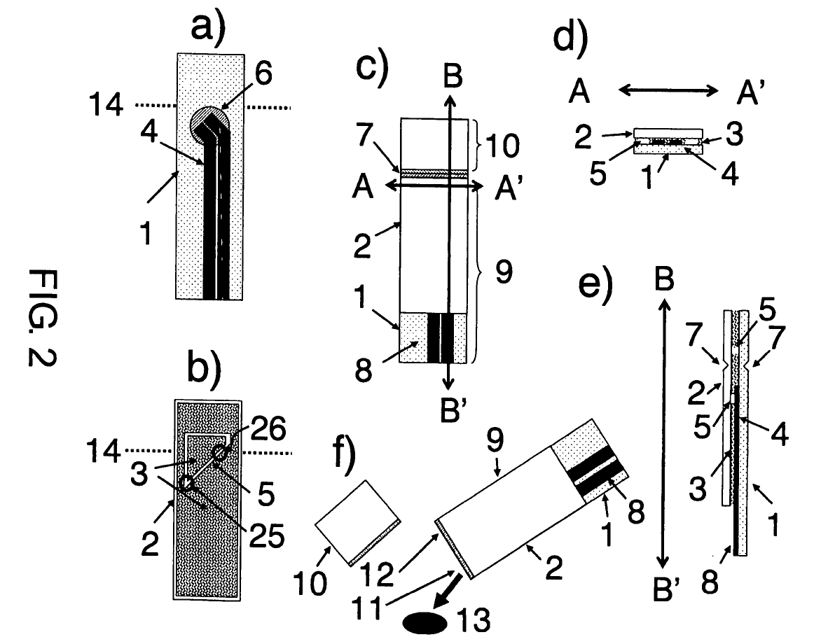

FIG. 2 shows a biosensor with an outer structure almost identical to that of FIG. 1, and a different inner structure.

In FIG. 2a, the wiring section, which includes the terminal of pattern 4 comprising electrodes, is located slightly right of the substrate center. The electrode part for detecting the reaction is located diagonally up on the left side. The reagent layer 6 is formed immediately below broken line 14, on the center line of the substrate, i.e., at the same position as shown in FIG. 1a.

FIG. 2b shows the inner surface of cover 2. On the inside upper surface of cover 2, the spacer layer, as well as a portion 5 inside the spacer layer, which comprises no spacer, are provided in a trapezoid shape, with the acute angle down. FIG. 2c is an example of a structural diagram where the inner surfaces of substrate 1 and cover 2 are overlapped with the top ends aligned, showing a substrate 1 terminal exposed at the bottom. FIG. 8b shows the inner structure of the diagram shown in FIG. 2c, except for cover 2. In FIG. 8b, the sample-feeding path 5 extends diagonally up from the acute angle of the trapezoid, via a part orthogonal to the electrode, and overlapping with broken line 14 further up. That is, the part where broken line 14 and the diagonally extending sample-feeding path 5 cross (which becomes sample-inlet port 26) becomes sample-inlet port 11 for sample solution 13, in the exemplary use as shown in FIG. 2f. Therefore, from the sample-inlet port 11 to the air-discharge port 12, the sample-feeding path 5 bends at an acute angle less than 90 degrees (the interior angle connecting the sample-inlet port 11, bent portion 25, and air-discharge port 12). The reagent-feeding path from the sample-inlet port up to bent portion 25 is linear (where the sample-feeding path is triangle or trapezoidal in a sealed state).

The cross-sectional views of this structure shown in FIGS. 2d and 2e are identical to those shown in FIGS. 1f and 1g.

In such biosensors, after sample solution 13 passes through the electrode part intersecting with the sample-feeding path, the feeding of the sample solution can nearly be stopped near the acute angle, since the surface area required for capillary action is partly interrupted in the part bent at the acute angle. Accordingly, these biosensors can measure a smaller amount of sample solution. Alternatively, if the feeding of the sample solution is not stopped, a highly repellent material can be provided as a stopper, by printing or the like at a preferable part where feeding should be stopped, or it can be applied to the wall surface of the sample-feeding path beyond the acute angle.

### EXAMPLE 3

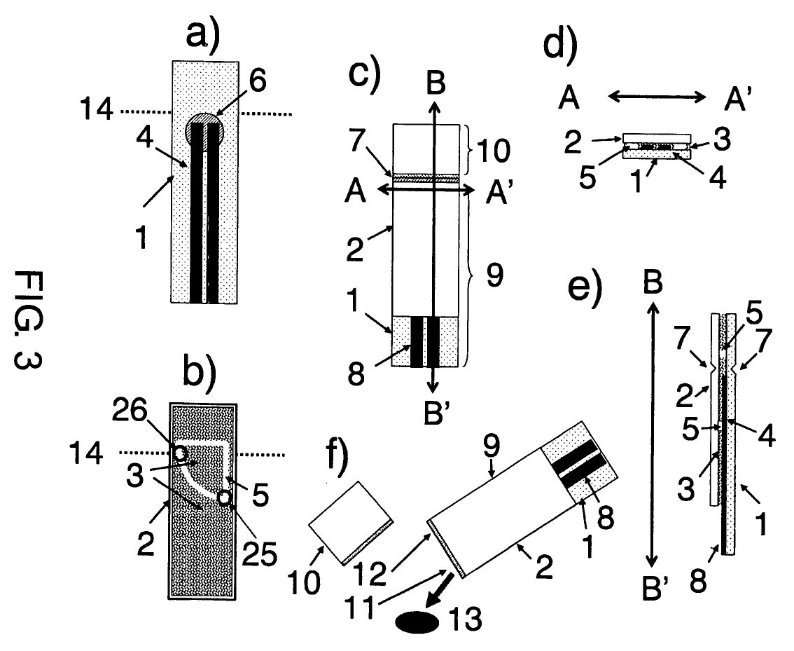

FIG. 3 shows an example of the biosensor structure in FIG. 2, where the reagent-feeding path is curved from part 26, which becomes the sample-inlet port of the sample-feeding path, to the bent portion 25 (when sealed the sample-feeding path is fan-shaped).

Since the reagent-feeding path is curved, a sample solution can be smoothly supplied to a position past the electrode part that intersects with the sample-feeding path, and stopped at the bent portion of the sample-feeding path further on. Accordingly, the required amount of sample solution can be reduced.

In this structure, as for FIG. 2, the fan shape that becomes sample-feeding path 5 shown in FIG. 3b has one angle of the fan at the bottom, and is formed in two directions: vertically, and extending upwards in an arc (see also FIG. 8c). This structure is also formed so the part eventually intersects the reaction-detecting section with the electrode near the arc center. Therefore, as shown in FIGS. 3f and 8c, feeding of the sample solution is almost stopped near the acute angle, where sample solution 13 bends at about 90 degrees after passing through the electrode part 4 intersecting with sample-feeding path 5, since the surface area required for capillary action is partly interrupted in this bent portion 25.

### EXAMPLE 4

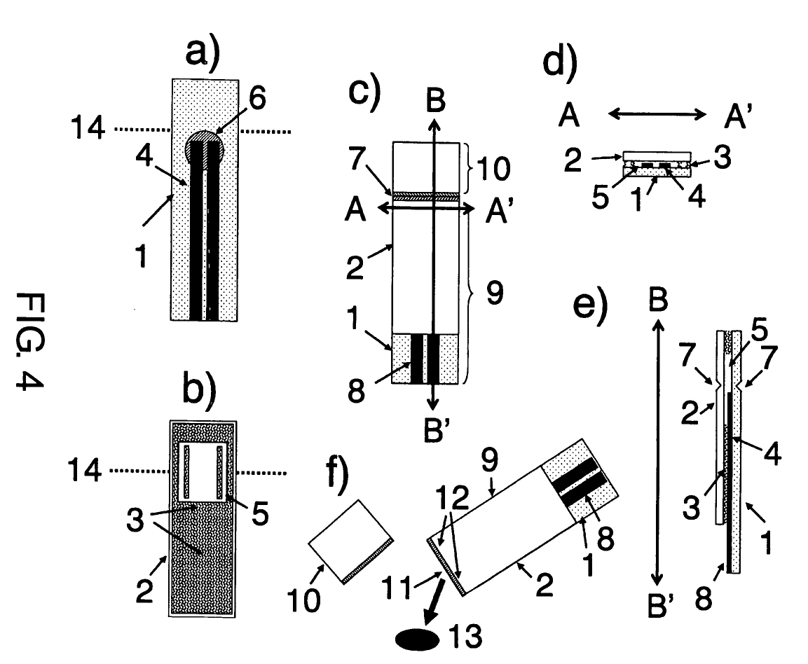

The biosensor shown in FIG. 4 has an exemplary structure, where an empty portion of the spacer is not patterned to form capillary action, as shown in FIG. 4b, and where the upper portion of the biosensor is detached at broken line 14, as shown in FIG. 8d, to create a wide cross-sectional sample-inlet port 11 (FIG. 4f) in the center portion. On both sides of the sample-inlet port, spacer 3 is formed so as not to contact the surrounding spacer, as shown in FIG. 8d. This allows the open parts formed on both sides of the sample-inlet port across the spacer to be air-discharge ports 12.

In the biosensor shown in FIG. 4, sample solution 13 is supplied from the center portion of the cross section, which appears when the sealed cap portion is cut off, and developed in the reaction-detecting section with electrodes 4. At this time, sample solution 13 supplied from sample-inlet port 11 can evenly progress to the reaction-detecting section of sample-feeding path 5, since air-discharge ports 12 are provided on both sides of sample-inlet port 11. Such a structure allows sample solution to be reliably supplied to the reaction-detecting section.

### EXAMPLE 5

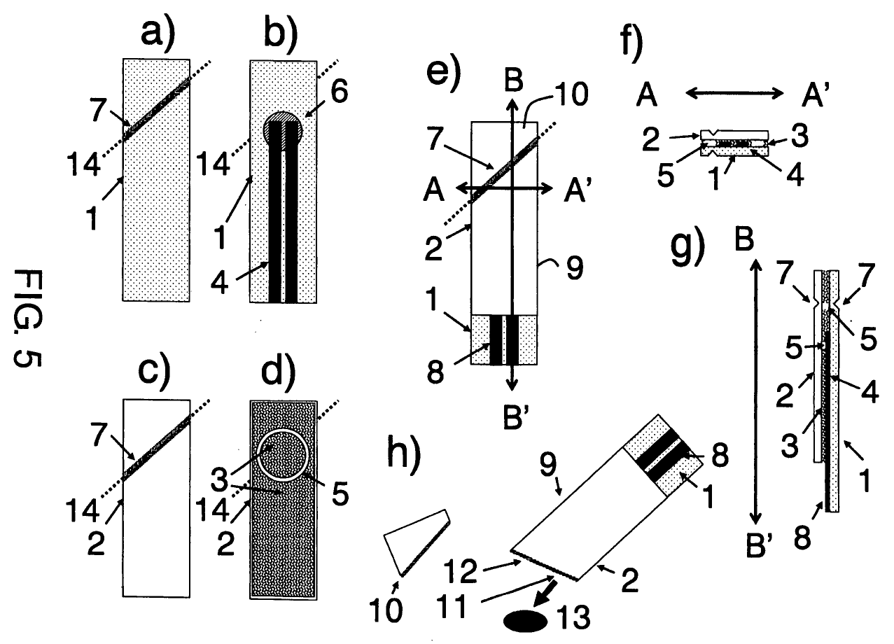

FIG. 5 is an exemplary structure, identical to that shown in FIG. 1 except for the direction of the cutting plane line. In FIG. 5, the V-shaped notch 7 forming the cutting plane line is not perpendicular to, but inclined from the direction of pattern 4 comprising the electrode of the reaction-detecting section, as shown in FIGS. 5a and 5c. Such cases differ from FIG. 1 in that it is a short distance from sample-inlet port 11 to the portion of sample-feeding path 5 where electrode 4 intersects, as shown in FIGS. 5h and 8e. For example, when measuring sample solutions with differing viscosities, such as blood samples, using capillary action to feed sample solutions may result in time fluctuations. The above-described structure effectively improves the reproducibility of measurements in such cases.

### EXAMPLE 6

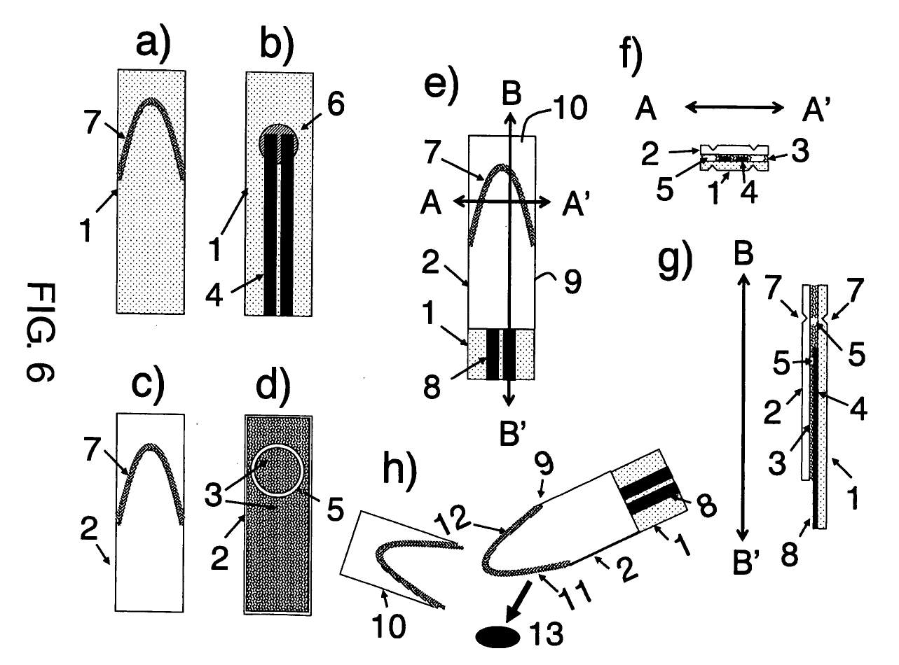

FIG. 6 shows an example of a biosensor where the cutting plane line is curved. FIG. 6 has the same structure as FIG. 1, except for the shape of the cutting plane line. As FIG. 6h shows, since sample-inlet port 11 exists on a curved cross section, this structure is user-friendly when directly contacting the biosensor with a human body, for example when analyzing blood or the like. Furthermore, as shown in FIG. 8f, since the distance from sample-inlet port 11 to the reaction-detecting section comprising electrode 4 is shorter than in FIG. 1 (and FIG. 8a), an effect similar to that described in FIG. 5 can be expected.

### EXAMPLE 7

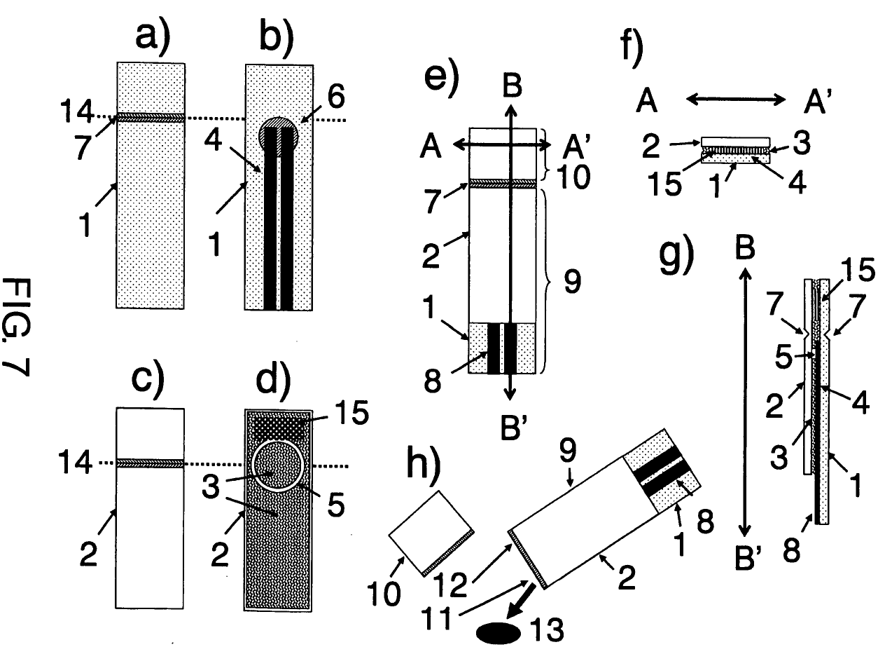

FIG. 7 is an exemplary structure where a desiccant 15 is incorporated in sealed cap portion 10. As shown in FIG. 7d, desiccant 15 is preferably laid out above broken line 14 and crossing the circular flow path that becomes sample-feeding path 5. This layout allows the desiccant to be incorporated in sealed cap portion 10, as shown in FIG. 7h. Furthermore, via the sample-feeding path, the desiccant can keep the air around the reagent layer dry until time of use. When the biosensor is used, desiccant 15 is detached along with sealed cap portion 10, and thus sample solution 13 does not contact desiccant 15.

Desiccant 15 is an example used herein, but other agents can be used in addition to or instead of a desiccant. Therefore, a deoxidant alone or in combination with a desiccant can be used, and furthermore, a humidity indicator or oxygen-detecting agent alone or in combination with the above-described agents can be used.

FIGS. 8a to 8f show development diagrams of the above-described biosensors as shown in FIGS. 1 to 6, except for cover 2. FIGS. 8g to 8l show development diagrams of the above-described biosensors as shown in FIGS. 1 to 7, except for cover 2, where desiccant 15 is provided. In the biosensors shown in FIGS. 8a to 8l, including those incorporating a desiccant, the interior of the sample-feeding path is completely shut off from the outside, and the inside is maintained in an airtight state prior to use. The sample-feeding path partly intersects the electrode. In addition, the sample-feeding path is cut in at least two positions when, sealed cap portion 10, which does not comprise pattern 4 including an electrode, is cut along broken line 14, to newly expose a sample-inlet port and air-discharge port on the cross section of sensor portion 10.

### EXAMPLE 8

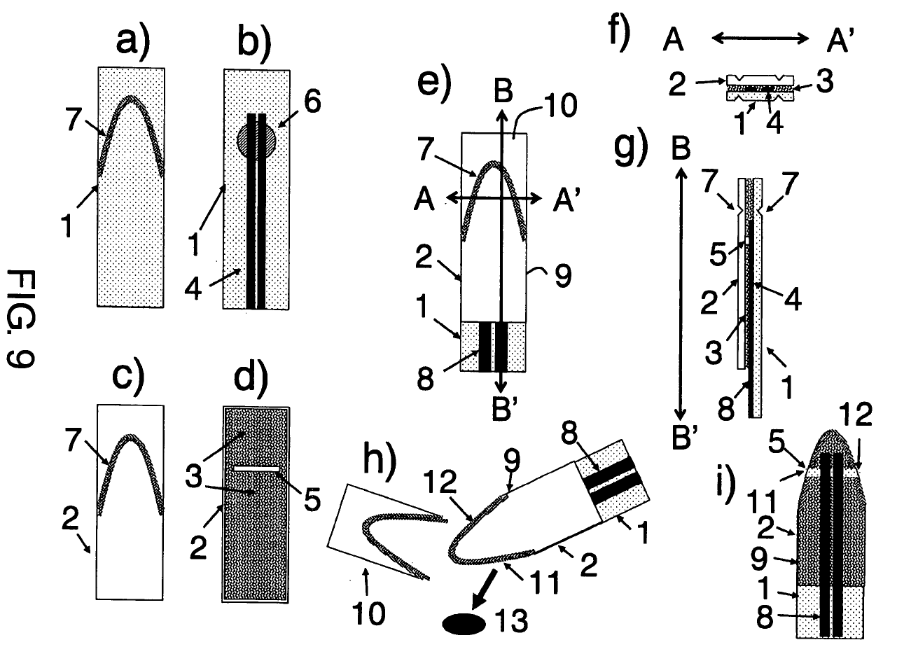

FIG. 9 shows the structure of a biosensor with a linear sample-feeding path 5. In this structure, sample solution 13 is supplied from sample-inlet port 11 and the sample-feeding path 5 is linear. Although the pattern of sample-feeding path 5 is linear in FIG. 9, it can be quadrilateral, and a cutting plane line can be provided to cross the two facing flow paths of the quadrilateral sample-feeding path 5 (not shown).

### EXAMPLE 9

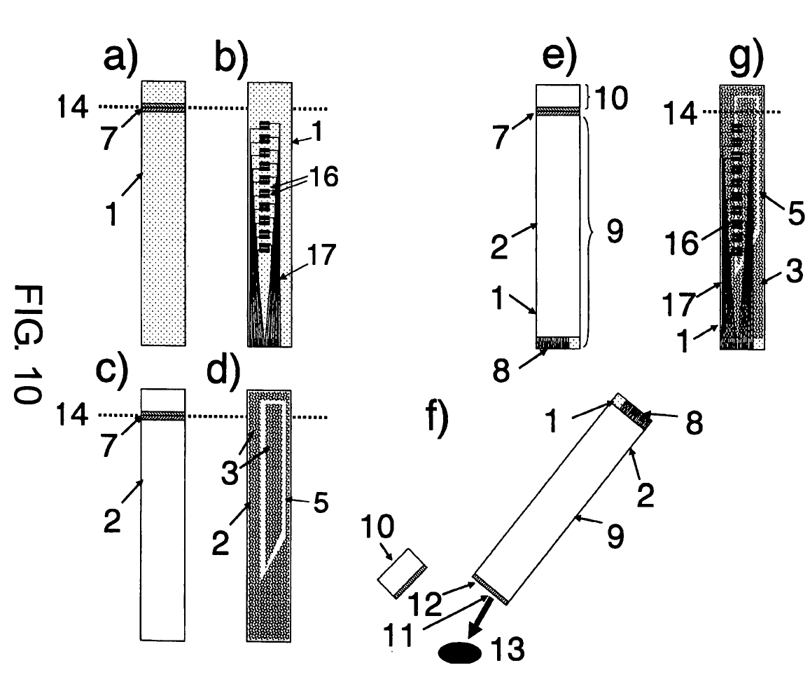

FIG. 10 shows an example of an array-type biosensor. FIG. 10a shows the outside of substrate 1, showing rectangular substrate 1, the V-shaped notch 7 to be a cutting plane line horizontally formed on the upper surface on the outside of the substrate, and broken line 14 indicating where the biosensor will be cut off with notch 7 as a boundary. FIG. 10b shows the inside of substrate 1. On the inside upper surface of substrate 1, pairs of electrodes 16 are arrayed along the length of the substrate, and wires 17 from each electrode are wired up to the bottom end of substrate 1. Reagent layer 6 is formed on at least one electrode of each pair (not shown).

FIG. 10c shows the outer part of cover 2. Horizontal notch 7 is provided along broken line 14 in the top region of cover 2, as for substrate 1. FIG. 10d shows the inside of cover 2. On the inside top surface of cover 2, an adhesive layer is formed as spacer 3. A trapezoid portion 5, not comprising the spacer layer, exists on cover 2. FIG. 10e shows a structural diagram where the inside of substrate 1 and cover 2 are overlapped with their top ends aligned. Sensor portion 9 and sealed cap portion 10 are separated by notch 7 as a boundary. By adhering substrate 1 and cover 2 to each other, the portion on cover 2 which does not comprise spacer is included inside the biosensor, resulting in sample-feeding path 5. By making cover 2 shorter than substrate 1, overlapping the two with their top ends aligned exposes the bottom end of electrode pattern 4, resulting in terminal 8, as shown in FIG. 10e.

FIG. 10f shows an exemplary use of the biosensor, and FIG. 10g shows a developed view thereof, except for cover 2.

A variety of DNA sequences can be simultaneously detected in the same sample solution by immobilizing different reagents as probes on each pair of electrodes on arrayed biosensors. These reagents can be, specifically, DNAs comprising different nucleotide sequences. For example, in the case of single nucleotide polymorphism (SNP) sensors (see, for example, A. Ahmadian et al., Biotechniques, 32, 748, 2002), a mixture of primers, DNA polymerases, deoxyribonucleotide triphosphates, and the like can be used as reagents, and electrodes measure change in pH near the electrode, which takes place when test DNAs in a sample are complementary to the primers.

Similarly, by immobilizing a variety of antibodies on each pair of electrodes, the biosensor, as an immune sensor, can simultaneously measure a variety of measuring targets in the same sample solution. For example, anti-albumin is used as a molecular identifier for measuring human serum albumin. Immune sensors measure the potential between electrodes, which changes when antigen-antibody complexes form.

Instead of an above-described structure, the arrayed biosensors may be structured to have at least two sample-inlet ports, where a reaction-detecting section comprising at least one pair of electrodes exists ahead of the sample-feeding path connected with each sample-inlet port, and the sample-inlet ports appear after cutting the sealed cap portion, as for the above biosensor; or structured to have at least two sample-feeding paths branched from at least one sample-inlet port and a reaction-detecting section comprising at least one pair of electrodes exists ahead of the sample feeding path.

### EXAMPLE 10

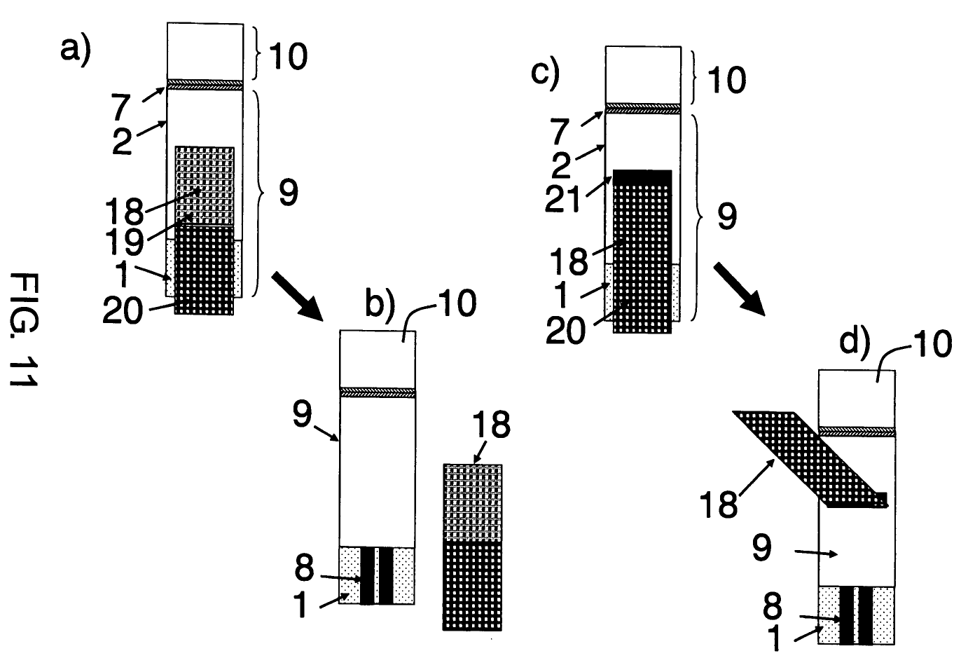

FIG. 11 shows the structure of a biosensor of the present invention, where terminal 8 is exposed to the surface and protective film 18 is provided to protect terminal 8. FIG. 11a shows an example where part of cover 2 and terminal 8 of the biosensor are packaged with protective film 18. The protective film 18 in FIG. 11a consists of a detachable adhesive layer 19, and a holding portion 20 without an adhesive layer, where part of cover 2 is covered with detachable adhesive layer 19, and terminal 8 is covered with holding portion 20 where an adhesive layer is not formed. FIG. 11b shows an exemplary use of FIG. 11a, where protective film 18 is peeled from sensor portion 9 at time of use.

FIG. 11c shows an exemplary biosensor structure, where terminal 8 of sensor portion 9 is simply packaged by the protective film, consisting of the top end (protective-film fixing portion 21) fixed to the upper surface of cover 2 by a strong adhesive, and the other part with no detachable adhesive layer. FIG. 11d is an exemplary use of the biosensor shown in FIG. 11c, where the protective film is peeled up to the protective-film fixing portion 21.

### EXAMPLE 11

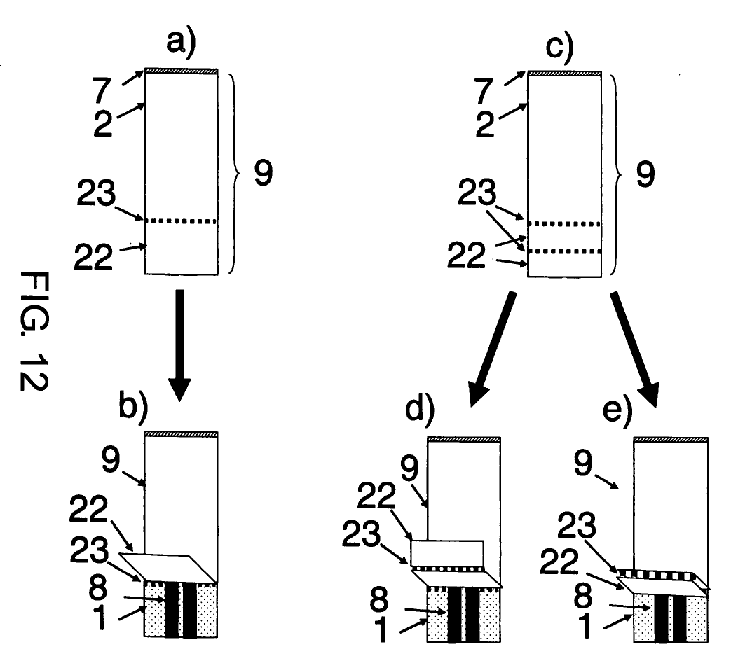

FIG. 12 shows the structure of a biosensor where terminal 8 is protected with cover portion 2, and not with a protective film. In FIG. 12a, terminal protective cover 22, which has no spacer, covers terminal 8, and perforations 23 are provided at the boundary with cover 2, fixed by an adhesive layer part. FIG. 12b is an exemplary use of the biosensor shown in FIG. 12a, where terminal 8 appears when the terminal protective cover 22 is turned over.

FIG. 12c is an example of a biosensor where perforations 23 are also provided between the terminal protective cover portion 22; and FIGS. 12d and 12e show exemplary uses of the biosensor of FIG. 12c. In FIG. 12d, the terminal protective cover 22 can be turned over more easily by providing new perforations 23. Furthermore, in FIG. 12e, by providing the perforations 23, terminal protective cover 22 can be folded up with perforations 23 as a boundary. In such cases, by providing a detachable adhesive layer in regions inside terminal protective cover 22, the folded cover can be prevented from easily returning to its original condition.

### EXAMPLE 12

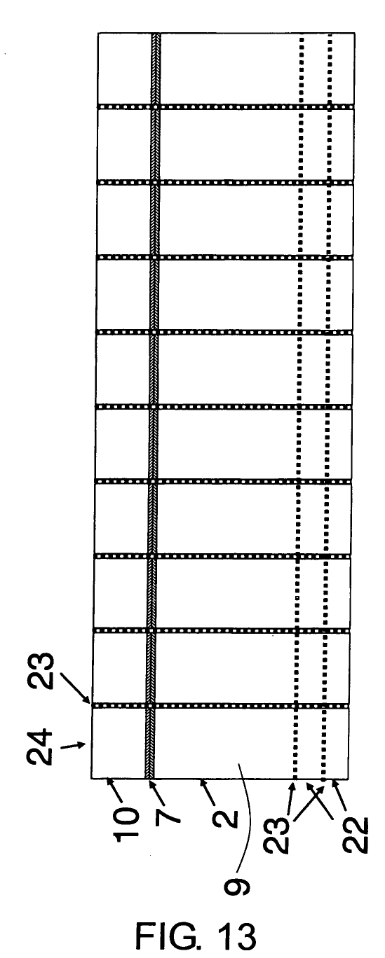

FIG. 13 shows an example of a biosensor aggregation sheet, where a number of biosensors 24 that do not require packaging are regularly arranged at prescribed intervals. Perforations 23 are arranged as boundary lines for each of the biosensors 24. By using linked-type biosensors, arranged as described above, simultaneous or continuous measurements can be conducted by supplying sample solution at each sample-inlet port. The number of arranged linked-type biosensor sensor portions of not particularly limited, and is preferably 20 to 30. The sensor portions may be arranged transversely, as shown in FIG. 13, or may be arranged longitudinally (not shown). Since each of the biosensors 24 can be folded using perforations 23, storage space can be saved, and bending between the connected electrodes and separation of each electrode is easier.

### EXAMPLE 13

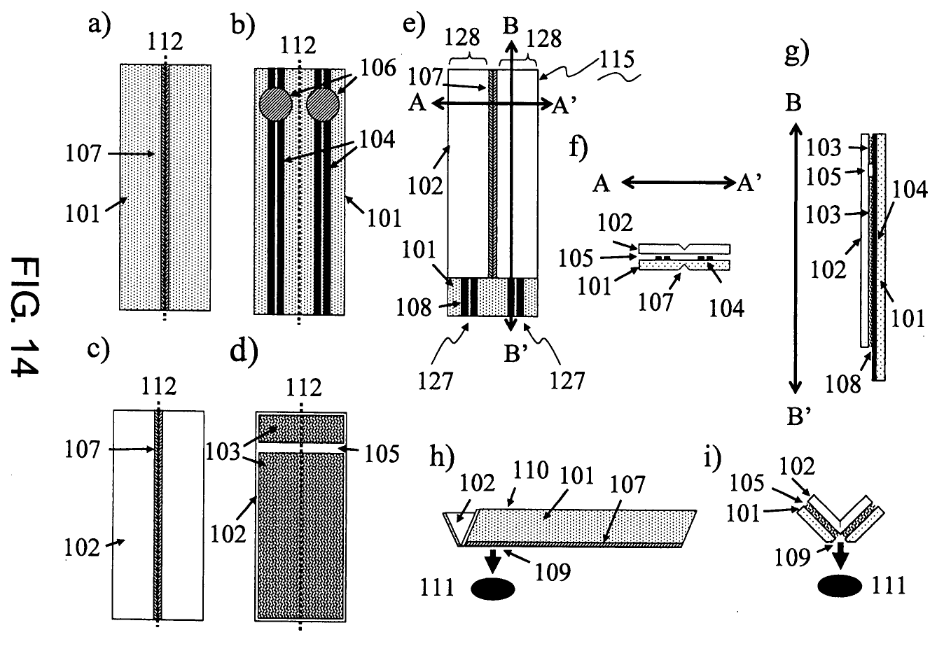

FIG. 14 shows a typical example of the biosensors for simultaneously measuring multiple items of the present invention. In this example, a cross section of the sample-feeding path forms the sample-inlet port of each biosensor, after bending along the V-shaped notch provided at the boundary of two biosensor unit-comprising substrates in parallel (where, for example, one biosensor unit is included in each biosensor unit-comprising substrate).

FIG. 14a shows the outside of rectangular substrate 101 of a typical biosensor for simultaneously measuring multiple items. On the center portion of substrate 101, a vertical cutting plane line running from top to bottom is provided as V-shaped notch 107. At time of use, notch 107 is used to bend the biosensor for simultaneously measuring multiple items in to a V-shape along the broken line 112.

FIG. 14b shows the inside of substrate 101. Inside substrate 101, pattern 104, including two pairs of electrodes, is arranged in parallel from top to bottom, with the substrate central broken line 112 as a boundary. Reagent layer 106 is formed on parts of the electrode pattern of each pair. To clarify the pattern sections that become reagent layer 106, a resist layer may be provided between an adhesive layer corresponding to spacer 103 in FIG. 14d, and substrate 101 including the electrode pattern 104 in FIG. 14b. The resist layer may be provided in a similar pattern to that of the adhesive layer (not shown in FIG. 14b). In such cases the resist layer becomes spacer 103, as for the adhesive layer, however, sometimes the resist layer does not form a pattern similar to the adhesive layer, and it may also be provided as an insulating layer for preventing electrode pattern 104 other than reagent layer 106 from intersecting with sample-feeding path 105. The spacer layer (adhesive layer) 103 may be pre-formed on cover 102 as shown in the figure, or may be formed on the resist layer on substrate 101.

FIG. 14c shows the outer part of cover 102. On the center portion of cover 102, as for substrate 101, the V-shaped notch 107 runs vertically from top to bottom. FIG. 14d shows the inside of cover 102. On the inside surface of cover 102, an adhesive layer is formed as spacer layer 103. Portion 105, where no spacer exists, is laid out in the upper portion of cover 102 to form reagent-feeding path 105 by adhering the portion to the substrate.

FIG. 14e is a structural diagram where the inner surfaces of substrate 101 and cover 102 are overlapped with their tops aligned, showing the biosensor for simultaneously measuring multiple items 115. By making cover 102 shorter than substrate 101, the bottom of the electrode pattern 104 is exposed when the two are overlapped with their tops aligned. This portion can be used as terminal 108, shown in FIG. 14e. Two biosensor unit-comprising substrates 128, each including one biosensor unit 127, exist with notch 107 as a boundary.

FIG. 14f shows an A-A′ cross-sectional view of the sample-feeding path on the upper side of the biosensor for simultaneously measuring multiple items shown in FIG. 14e. While two pairs of two electrodes 104 are each arranged on substrate 101, and an adhesive layer exists between the substrate and cover, the portion shown as the cross-sectional view in FIG. 14f is an empty portion of the spacer that forms sample-feeding path 105. On the outside surfaces of substrate 101 and cover 102, between the two pairs of electrodes, V-shaped notches 107 are arranged to overlap. FIG. 14g shows a B-B′ cross-sectional view of the pattern of the electrodes of the biosensor for simultaneously measuring multiple items shown in FIG. 14e. Electrodes 104 are formed on substrate 101. Between substrate 101 and cover 102 are one spacer 103 and one sample-feeding path 105.

FIG. 14h shows an exemplary use of the biosensor for simultaneously measuring multiple items of the present invention. FIG. 14h shows a biosensor for simultaneously measuring multiple items that is longitudinally bent along V-shaped notch 107 on cover portion 102. Substrate 101 of the biosensor for simultaneously measuring multiple items is divided into two parts, while cover portion 102 is not divided, but rather bent along V-shaped notch 107. Consequently, as shown in the figure, the two biosensor unit-comprising substrates form a V-shape together. At this time, sample-feeding path 105 is divided along the V-shaped notch, which is the boundary of the two biosensor unit-comprising substrates, and the sample-inlet ports 109 of each biosensor unit form adjacently in the same place.

By contacting two adjacent sample-inlet ports 109 in this state with a sample solution 111, the sample solution 111 is independently supplied to the adjacent sample-feeding paths 105 by capillary action. At this time, if sample solution 111 is slightly rounded by surface tension, as shown in the figure, sample solution 111 is effectively supplied to sample-feeding paths 105 since the two biosensor unit-comprising substrates combine to form a V-shape, as shown in FIG. 14h. To smoothly supply sample solution 111 to sample-feeding path 105, an air-discharge port 110 is located on the opposite side of sample-inlet port 109. FIG. 14i shows a front view of the two biosensor unit-comprising substrates forming a V-shape together.

This structure, as shown in FIG. 14, characteristically enables two adjacent biosensor units to measure one sample solution in completely independent systems, without interference from reagents from each reagent layer. In the biosensor for simultaneously measuring multiple items exemplified in FIG. 14, a crack opens on the substrate side, or alternatively opens on the side of cover 102. Furthermore, the biosensor for simultaneously measuring multiple items not only forms a V-shape, but may also be completely folded along the V-shaped notch on either substrate 101 or cover 102, or may have a crack opening at less than 180 degrees, provided by using a hard substrate.

In addition to the above-mentioned common characteristics of the biosensors for simultaneously measuring multiple items of the present invention, characteristics of the biosensors for simultaneously measuring multiple items proposed herein will be described hereinafter.

### EXAMPLE 14

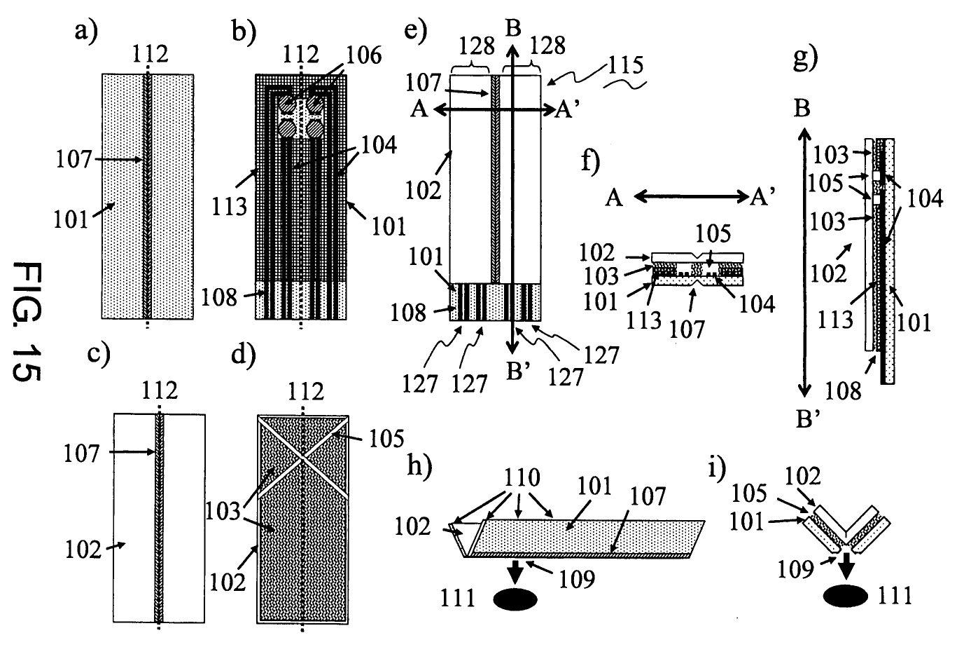

FIG. 15 is a biosensor for simultaneously measuring multiple items 115 where two lots of two biosensor units 127 (e.g. a total of four biosensor units) are included in biosensor unit-comprising substrate 128, in the structure of the biosensor for simultaneously measuring multiple items of FIG. 14, where each independent biosensor unit is along a V-shaped notch (FIG. 15(e)).

FIG. 15a shows the outside of rectangular substrate 101 of a biosensor for simultaneously measuring multiple items. On the center portion of substrate 101, a vertical cutting plane line 112 running from top to bottom is provided as V-shaped notch 107. At time of use, notch 107 is used to bend the biosensor for simultaneously measuring multiple items in to a V-shape along the broken line 112.

FIG. 15b shows the inside of substrate 101. Inside substrate 101, patterns 104 including four pairs of electrodes are symmetrically arranged on substrate 101, with the central broken line 112 of the substrate as a boundary. Also, four reagent layers 106 are formed on a part of each electrode pair pattern. Insulating resist 113 is applied to the inside structure of substrate 101 of FIG. 15b, except for electrode parts around the reagent layer (reaction tank) 106 and terminal 108. Characteristically, by using resist 113, the section of the electrode area in the reaction tank is clearly differentiated from the adhesive layer.

FIG. 15c shows the outer part of cover 102. On the center portion of cover 102, as for substrate 101, vertical cutting plane line 112 runs from top to bottom as V-shaped notch 107. FIG. 15d shows the inside of cover 102. On the inside upper surface of cover 102, an adhesive layer is formed as spacer layer 103. A portion without spacer 105 is provided in the upper portion of cover 102, which forms reagent-feeding path 105 when adhered with the substrate. In such cases, spacer layer (adhesive layer) 103 may be pre-formed on cover 102 as shown in the figure, or may be formed on the resist layer on substrate 101.

FIG. 15e shows a structural diagram of a biosensor for simultaneously measuring multiple items 115, where the inside of substrate 1 and cover 102 are overlapped with their tops aligned. By making cover 102 shorter than substrate 101, the bottom of the electrode pattern 104 is exposed when the two are overlapped with their tops aligned. This portion can be used as terminal 108, shown in FIG. 15e. The four biosensor units 127 are divided in two, forming two pairs of biosensor unit-comprising substrates 128, each including two biosensor units and with notch 107 as a boundary.

FIG. 15f shows an A-A′ cross-sectional view of the sample-feeding path on the top half of a biosensor for simultaneously measuring multiple items shown in FIG. 15e. Four pairs, each of two electrodes 104, are arranged on substrate 101. Arranged between substrate 101 and cover 102 are spacer layer (adhesive layer) 103; sample-feeding path 105 branching in two directions with V-shaped notch 107 as a boundary; and resist layer 113 for covering the point of intersection with sample-feeding paths 105 except for reagent layer (reaction layer) 106. The V-shaped notches 107 on the outside of substrate 101 and cover 102 are arranged to overlap. FIG. 15g shows a B-B′ cross-sectional view of the electrode pattern of the biosensor for simultaneously measuring multiple items 115 shown in FIG. 15e. On substrate 101 the two electrodes 104 are vertical. Provided between substrate 101 and cover 102 are resist layer 113 and spacer layer (adhesive layer) 103, as spacer 103 and sample-feeding path 105, which branches into two.

FIG. 15h shows an exemplary use of a biosensor for simultaneously measuring multiple items of the present invention. FIG. 15h shows a biosensor for simultaneously measuring multiple items bent longitudinally along the V-shaped notch 107 on cover portion 102. As a result, substrate 101, which has four biosensor units, is divided into two, resulting in two biosensor unit-comprising substrates with two biosensor units each. The cover portion is not divided, but rather bent along the V-shaped notch.

Consequently, two biosensor unit-comprising substrates can together form a V-shape, as shown in the figure. At this time, sample-feeding path 105 is divided along the V-shaped notch bordering each of the two biosensor unit-comprising substrates, and the sample-inlet ports 109 of all of the four biosensor units are adjacent and formed in one place.

By contacting four sample-inlet ports 109 in this state with sample solution 111, the sample solution is independently supplied to the sample-feeding paths 105 by capillary action. To smoothly supply sample solution 111 to a sample-feeding path 105, a total of four air-discharge ports 110 are provided on the opposite side of sample-inlet port 109. FIG. 15i shows a front view of the two biosensor unit-comprising substrates forming a V-shape together.

Characteristically, the structure in FIG. 15, enables four adjacent biosensor units to measure one sample solution in completely independent systems, without interference by reagents from each reagent layer tank.

### EXAMPLE 15

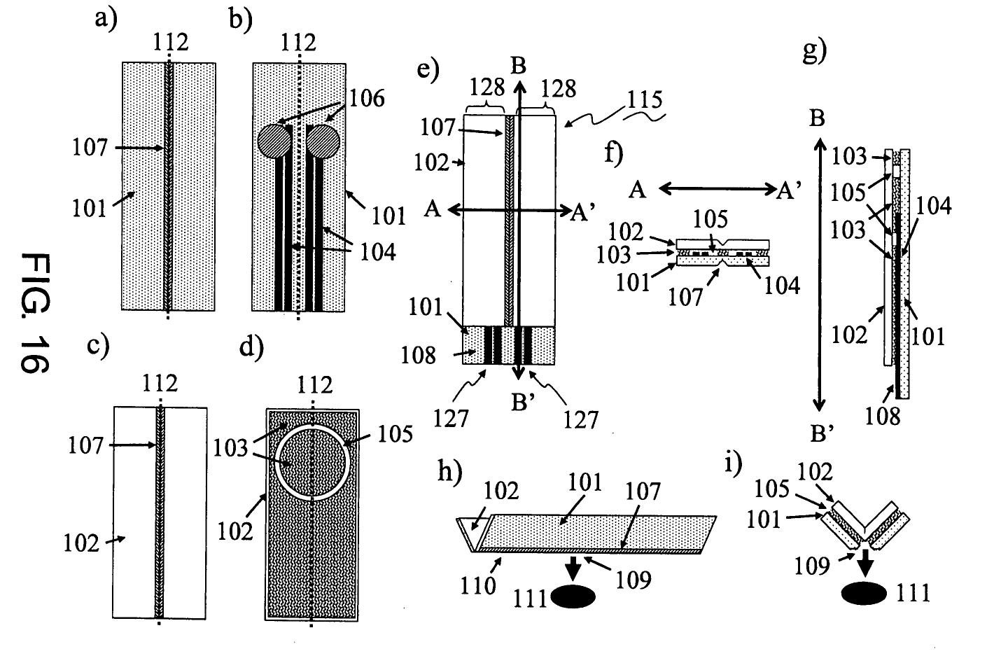

The biosensor for simultaneously measuring multiple items in FIG. 16 is structurally similar to that in FIG. 14, but is characterized in that both the air-discharge port 110 and sample-inlet port 109 are formed for the first time by bending the biosensor during use.

FIG. 16a shows the outside of rectangular substrate 101 of a biosensor for simultaneously measuring multiple items. On the center portion of substrate 101, a vertical cutting plane line 112, running from top to bottom, is provided as V-shaped notch 107. At time of use, this notch 107 is used to bend the biosensor for simultaneously measuring multiple items in to a V-shape along the broken line 112.

FIG. 16b shows the inside of substrate 101. Inside substrate 101, two pairs of patterns 104, which include electrodes, are symmetrically arranged on substrate 101 at a distance from the top, with the central broken line 112 of the substrate as a boundary. Two reagent layers 106 are formed in an area on each pair of electrode patterns. Although not shown in FIG. 16b, a resist layer may be provided between an adhesive layer to compose spacer 103, shown in FIG. 16d, and substrate 101 including electrode pattern 4 of FIG. 16b, in a pattern similar to that of the adhesive layer. Furthermore, the spacer layer (adhesive layer) 103 may be pre-formed on cover 102, as shown in the figure, or may be formed on the resist layer on substrate 101.

FIG. 16c shows the outer part of cover 102. On the center portion of cover 102, as for substrate 101, a vertical cutting plane line 112 running from top to bottom is provided as V-shaped notch 107. FIG. 16d shows the inside of cover 102. On the inside upper surface of cover 102, an adhesive layer is formed as spacer layer 103. Portion 105, where no spacer exists, is located in the upper portion of cover 102, to form reagent-feeding path 105 by adhering the portion to the substrate. In such cases, the spacer layer (adhesive layer) 103 may be pre-formed on cover 102 as shown in the figure, or may be formed on the resist layer on substrate 101. Characteristically, FIG. 16 differs from FIG. 14 and FIG. 15 in that the sample-feeding path 105 is formed inside the adhesive layer, as shown in FIG. 16d.

FIG. 16e shows a structural diagram of a biosensor for simultaneously measuring multiple items 115, where the inner surfaces of substrate 101 and cover 102 are overlapped with their tops aligned. By making cover 102 shorter than substrate 101, the bottom of electrode pattern 104 is exposed when the two are overlapped with their tops aligned. This portion can be used as terminal 108, as shown in FIG. 16e. Two biosensor units 127 are divided into two parts with notch 107 as a boundary, resulting in two biosensor unit-comprising substrates 128 with one biosensor unit each. Characteristically, sample-feeding path 105 is completely included in the structure of a biosensor for simultaneously measuring multiple items in this form, so it does not directly contact the outside air, and thus its inside can be kept secure.

FIG. 16f shows an A-A′ cross-sectional view of the sample-feeding path upper portion of the biosensor for simultaneously measuring multiple items 115 shown in FIG. 16e. Two pairs of electrodes 104 are arranged on substrate 101. Arranged between substrate 101 and cover 102 are spacer layer (adhesive layer) 103, sample-feeding path 105, and reagent layer (reaction layer) 106. V-shaped notches 107, located on the outside of substrate 101 and cover 102, are arranged to overlap. FIG. 16g shows a B-B′ cross-sectional view of the electrode pattern of the biosensor for simultaneously measuring multiple items shown in FIG. 16e. The adhesive layer 103 and two sample-feeding paths 105 for two positions, as spacer 103, are located between substrate 101 and cover 102, and electrode 104 on the surface of substrate 101 only intersects with the lower of the two sample-feeding paths 105.

FIG. 16h shows an exemplary use of a biosensor for simultaneously measuring multiple items of the present invention. FIG. 16h shows the biosensor for simultaneously measuring multiple items bent longitudinally along V-shaped notch 107 on cover portion 102. As a result, substrate 101, which has two biosensor units, is divided into two biosensor unit-comprising substrates, each including one biosensor unit. The cover portion is not divided, but rather bent along the V-shaped notch. Consequently, the two biosensor unit-comprising substrates can form a V-shape together, as shown in the figure.

At this time, sample-feeding path 105 is divided along the V-shaped notch at the boundary of the two biosensor unit-comprising substrates, to adjacently form sample-inlet port 109 and air-discharge port 110 for each of the two biosensor units in the same position. By contacting two sample-inlet ports 109 in this state with a sample solution 111, the sample solution is independently supplied to the semicircular sample-feeding path 105 by capillary action. To smoothly supply sample solution 111 to sample-feeding path 105, air-discharge ports 110 are provided on the cross sections of the same biosensor unit-comprising substrates that comprise sample-inlet ports 109. FIG. 16i shows a front view of the two biosensor-unit comprising substrates where the substrate is divided into two parts to form the V-shape.

The structure of the biosensor for simultaneously measuring multiple items exemplified in FIG. 16 can be completely sealed, requiring no packaging.

### EXAMPLE 16

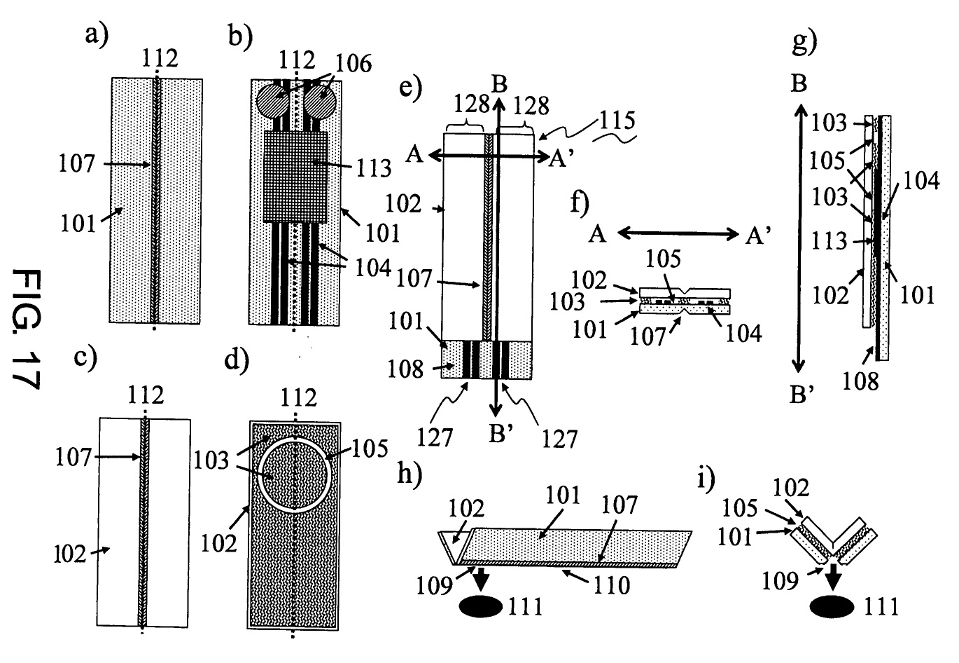

FIG. 17 shows the same outer structure of a biosensor for simultaneously measuring multiple items as that of FIG. 16, with a slightly different inner structure. In FIG. 17, sample-inlet port 109 formed when using the biosensor, at the air-discharge port 110 position of FIG. 16.

FIG. 17a shows the outside of rectangular substrate 101 of a biosensor for simultaneously measuring multiple items. In the center of substrate 101 is a vertical cutting plane line, running from top to bottom as V-shaped notch 107. At time of use, notch 107 is used to bend the biosensor for simultaneously measuring multiple items in to a V-shape along the broken line 112.

FIG. 17b shows the inside of substrate 101. On the inner surface of substrate 101, patterns 104, including two pairs of electrodes, run from top to bottom of the substrate, and two reagent layers 106 are in a section of each electrode pattern, with central broken line 112 of the substrate as a boundary. A resist layer is also provided on part of the two pairs of electrode patterns. As a result, two points of electrode pattern intersection exist per pair of sample-feeding paths, and the lower intersection point of substrate 101 is insulated by resist 113. Thus reagent layer 106 is only provided at the upper intersection point of substrate 101.

FIG. 17c shows the outer part of cover 102. In the center portion of cover 102, as for substrate 101, a vertical cutting plane line 112 runs from top to bottom as V-shaped notch 107. FIG. 17d shows the inside of the same cover 2 as in FIG. 16d. On the inside upper surface of cover 102, an adhesive layer is formed as spacer layer 103. Portion 105, where no spacer exists, is located in the upper portion of cover 102, and results in reagent-feeding path 105 when adhered with the substrate. In such cases, the spacer layer (adhesive layer) 103 may be pre-formed on cover 102 as shown in the figure, or may be formed on the resist layer on substrate 101. Characteristically, FIG. 17 differs from FIG. 14 and FIG. 15 in that sample-feeding path 105 is formed inside the adhesive layer, as shown in FIG. 17d.

FIG. 17e shows a structural diagram of the biosensor for simultaneously measuring multiple items 115, where the inner surfaces of substrate 101 and cover 102 are overlapped with their tops aligned. Making cover 102 shorter than substrate 101 exposes the bottom of electrode pattern 104 when the two are overlapped with their tops aligned. This portion can be used as terminal 108, shown in FIG. 17e. Two biosensor units 127 are divided into two parts with notch 107 as a boundary, resulting in two biosensor unit-comprising substrates 128 that each include one biosensor unit. Characteristically, sample-feeding path 105 is completely enclosed in the structure of this biosensor for simultaneously measuring multiple items, so it does not contact the outside air directly, and the inside air is kept secure.

FIG. 17f shows an A-A′ cross-sectional view of the sample-feeding path on the top side of the biosensor for simultaneously measuring multiple items shown in FIG. 17e. Two pairs of electrodes 104 are arranged on substrate 101. Arranged between substrate 101 and cover 102 are spacer layer (adhesive layer) 103, sample-feeding path 105, and reagent layer (reaction layer) 106. The V-shaped notches 107 located outside substrate 101 and cover 102 are arranged to overlap.

FIG. 17g shows a B-B′ cross-sectional view of the electrode pattern in the biosensor for simultaneously measuring multiple items shown in FIG. 17e. Arranged between substrate 101 and cover 102 are the adhesive layer as spacer 103 and two sample-feeding paths 105. The resist layer 113 partly covers electrode pattern 104 so as to insulate the lower of the two positions where the electrode pattern 104 and sample-feeding path 105 intersect.

FIG. 17h shows an exemplary use of a biosensor for simultaneously measuring multiple items of the present invention. FIG. 17h shows a biosensor for simultaneously measuring multiple items longitudinally bent along V-shaped notch 107 on cover portion 102. Substrate 101, with two biosensor units, is divided into two biosensor unit-comprising substrates, each including one biosensor unit. On the other hand, the cover portion is not divided but rather bent along the V-shaped notch. Consequently, the two biosensor-unit comprising substrates can together form a V-shape, as shown in the figure.

At this time, sample-feeding path 105 is divided along the V-shaped notch at the boundary between the two biosensor unit-comprising substrates, resulting in sample-inlet port 109 and air-discharge port 110 of the two biosensor units being adjacent and in the same place on the cross section.

In the structure in FIG. 17, sample-inlet port 109 and air-discharge port 110 are respectively provided close to the top and center of the biosensors for simultaneously measuring multiple items. By contacting two sample-inlet ports 109 in this state with sample solution 111, the sample solution is independently supplied to semicircular sample-feeding path 105 by capillary action. To smoothly supply sample solution 111 to sample-feeding path 105, air-discharge ports 110 are provided on the same cross section of the biosensor unit-comprising substrates as that comprising sample-inlet port 109. FIG. 17i shows a front view of the two biosensor unit-comprising substrates dividing substrate 101 in two to form a V-shape.

The biosensor for simultaneously measuring multiple items exemplified in FIG. 17 has a completely sealed structure, where no packaging is required, as for FIG. 16. Furthermore, the sample-inlet port 109 is provided close to the top of the biosensor for simultaneously measuring multiple items. Accordingly, compared with using the biosensor for simultaneously measuring multiple items of FIG. 16, it is easier to connect this biosensor for simultaneously measuring multiple items to a measuring unit, to supply sample solution 111 to the biosensor.

### EXAMPLE 17

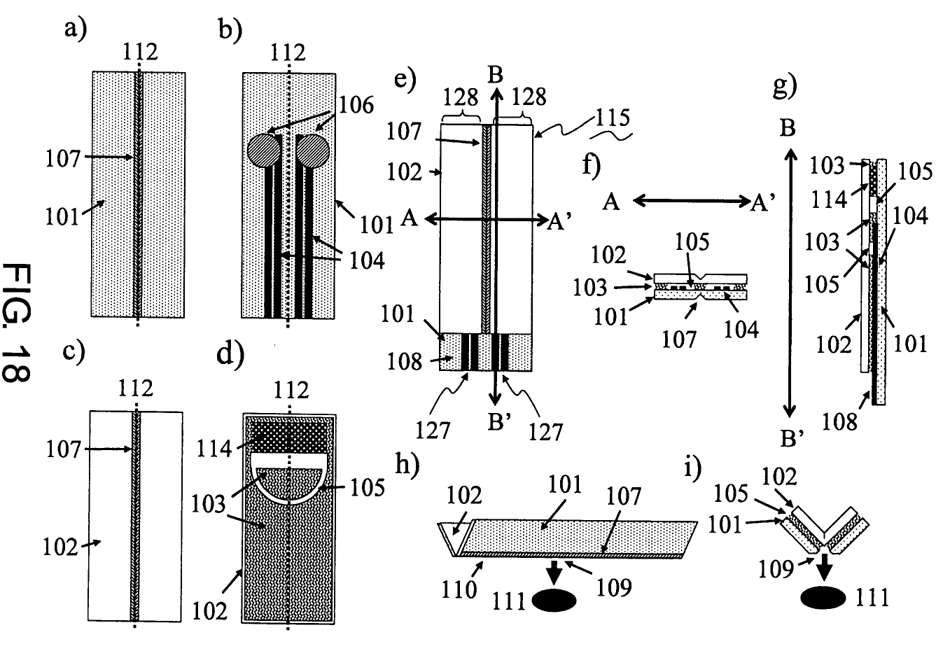

FIG. 18 is structurally similar to the biosensor for simultaneously measuring multiple items of FIG. 16, but is characterized by the provision of a regulating agent, such as a desiccant, for adjusting the atmosphere in the sample-feeding path.

FIG. 18a shows the outside of rectangular substrate 101 of a biosensor for simultaneously measuring multiple items. In the center portion of substrate 101, a vertical cutting plane line 112 runs from top to bottom as V-shaped notch 107. When in use, this notch 107 is used to bend the biosensor for simultaneously measuring multiple items in to a V-shape along broken line 112.

FIG. 18b shows the inside of substrate 1. Inside substrate 101, patterns 104 including two pairs of electrodes are symmetrically arranged on substrate 101 at a distance from the top, with the central broken line 112 of the substrate as a boundary. Two reagent layers 106 are formed in an area of each pair of electrode patterns. Although not shown in FIG. 18b, a resist layer may be provided between the adhesive layer composing spacer 103, shown in FIG. 18d, and substrate 101 including the electrode pattern 104 of FIG. 18b, in a similar pattern to that of the adhesive layer. Furthermore, the spacer layer (adhesive layer) 103 may be formed on cover 102 in advance, as shown in the figure, or may be formed on the resist layer on substrate 101.

FIG. 18c shows the outer part of cover 102. In the center portion of cover 102, as for substrate 101, a vertical cutting plane line 112 runs from top to bottom as a V-shaped notch 107. FIG. 18d shows the inside of cover 102. The adhesive layer is located on the surface of cover 102 as spacer layer 103, and the internal atmosphere-regulating agent, such as desiccant 114, is provided in the upper portion of cover 102. On the surface of cover 102, portion 105, where no spacer exists, is located so as to connect with the regulating agent, forming reagent-feeding path 105 by adhering with the substrate. In such cases, spacer layer (adhesive layer) 103 may be formed on the surface of cover 102 in advance, as shown in the figure, or may be formed on the resist layer on substrate 101. In a similar way to the biosensor for simultaneously measuring multiple items exemplified in FIG. 16, the biosensor for simultaneously measuring multiple items of FIG. 18 is characterized in that sample-feeding path 105 is contained inside the adhesive layer, as shown in FIG. 18d.

FIG. 18e shows a structural diagram of a biosensor for simultaneously measuring multiple items 115, showing the inner surfaces of substrate 101 and cover 102 overlapped with their tops aligned. By making cover 102 shorter than substrate 101, the bottom of electrode pattern 104 is exposed when the two overlap with their tops aligned. This portion can be used as terminal 108, shown in FIG. 18e. Two biosensor units 127 are divided into two parts with notch 107 as a boundary, forming two biosensor unit-comprising substrates 128, each including one biosensor unit. Characteristically, the sample-feeding path 105 of this form is completely included in the structure of the biosensor for simultaneously measuring multiple items, so as not to contact the outside air directly. Thus its interior is kept secure, as for the biosensor for simultaneously measuring multiple items exemplified in FIG. 16.

FIG. 18f shows an A-A′ cross-sectional view of the sample-feeding path on the upper side of the biosensor for simultaneously measuring multiple items shown in FIG. 18e. The two pairs of electrodes 104 are arranged on substrate 101, and spacer layer (adhesive layer) 103, sample-feeding path 105, and reagent layer (reaction layer) 106 are arranged between substrate 101 and cover 102. The V-shaped notches 107 on the outside of substrate 101 and cover 102 are arranged so as to overlap. FIG. 18g shows a B-B′ cross-sectional view of the electrode pattern in the biosensor for simultaneously measuring multiple items shown in FIG. 18e. The spacer layer (adhesive layer) 103, as spacer 103, sample-feeding path 105, and internal atmosphere-regulating agent 114, are structurally arranged between substrate 101 and cover 102, which is characteristic of the biosensor for simultaneously measuring multiple items of FIG. 18.

FIG. 18h shows an exemplary use of a biosensor for simultaneously measuring multiple items of the present invention. FIG. 18h shows the biosensor for simultaneously measuring multiple items bent longitudinally along V-shaped notch 107, located on cover portion 102. As a result, substrate 101, which has two biosensor units, is divided into two biosensor unit-comprising substrates, each including one biosensor unit. On the other hand, the cover portion is not divided, but rather bent along the V-shaped notch. Consequently, the two biosensor unit-comprising substrates can form a V-shape together, as shown in the figure. At this time, sample-feeding path 105 is divided along the V-shaped notch at the boundary of the two biosensor unit-comprising substrates, resulting in the formation of sample-inlet ports 109 of the two biosensor units, and air-discharge port 110, which is next to the regulating agent layer, adjacently in the same place.

By contacting the two sample-inlet ports 109 in this state with sample solution 111, the sample solution is independently supplied to semicircular sample-feeding path 105 by capillary action, and the sample solution stops near sample-feeding path 5 adjacent to the regulating agent layer. To smoothly supply sample solution 111 to sample-feeding path 105, air-discharge port 110 is provided on the same cross section of the biosensor unit-comprising substrate as sample-inlet port 109.

FIG. 18i shows a front view of the two biosensor unit-comprising substrates dividing the substrate in two to form a V-shape.

The biosensor for simultaneously measuring multiple items exemplified in FIG. 18 can have a completely sealed type structure, where no packaging is required and the regulating agent is kept inside.

### EXAMPLE 18

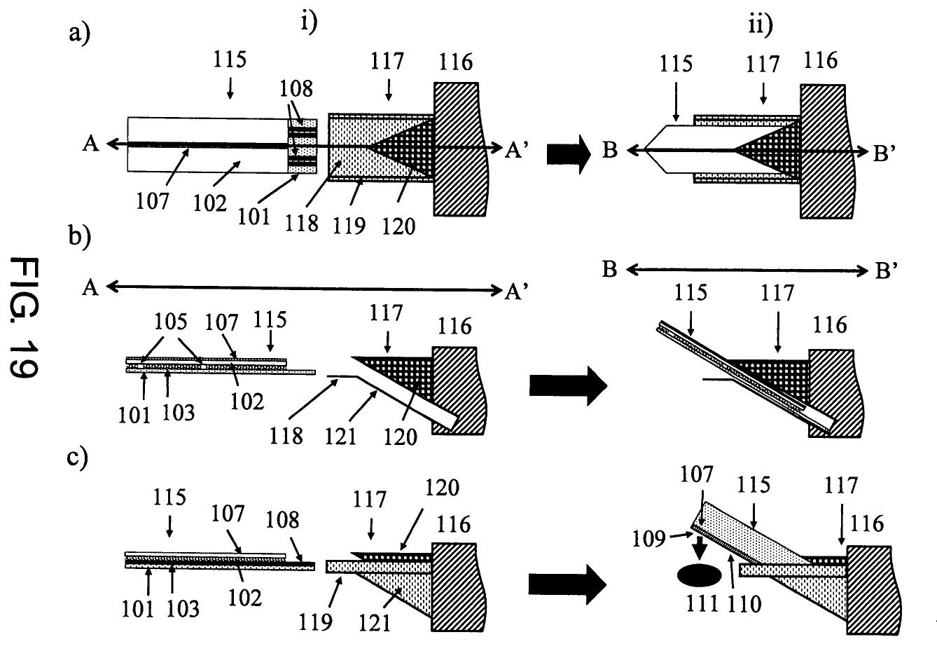

FIG. 19 shows an exemplary use of the biosensor for simultaneously measuring multiple items exemplified in FIG. 17, together with a specialized measuring unit (connector).

FIGS. 19a-i shows a top view of a biosensor for simultaneously measuring multiple items 115, and measuring unit 116. Terminal 108 is located at the bottom of the biosensor for simultaneously measuring multiple items 115. Supply part 117 of measuring unit 116 is composed of horizontal movement part 118, for sliding the biosensor for simultaneously measuring multiple items 115, horizontal movement guidance part 119, and the upper portion of folding portion 120 to bend the biosensor for simultaneously measuring multiple items 115 along V-shaped notch 107 when moving horizontally to insert the biosensor for simultaneously measuring multiple items into the supply part of the measuring unit.

FIG. 19a-ii shows a biosensor for simultaneously measuring multiple items when connected to the measuring unit. When a biosensor for simultaneously measuring multiple items 115 is connected to measuring unit 116, the biosensor for simultaneously measuring multiple items is transformed into a V-shape in the form shown in FIG. 17h. FIGS. 19b-i and 19b-ii show A-A′ and B-B′ cross-sectional views, respectively, of a biosensor for simultaneously measuring multiple items 115, and measuring unit 116. FIG. 19c shows a side view of a biosensor for simultaneously measuring multiple items 115 and measuring unit 116. FIG. 19c-ii shows a condition where sample solution 111 is supplied by connecting the biosensor for simultaneously measuring multiple items 115 to measuring unit 116.

### EXAMPLE 19

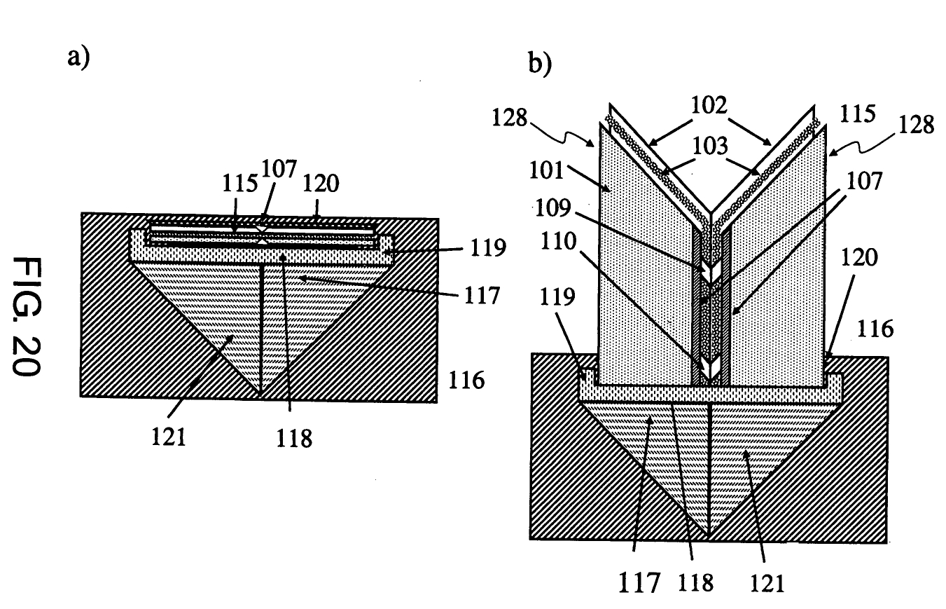

FIG. 20 shows a front view of the biosensor for simultaneously measuring multiple items 115 and measuring unit 116 shown in FIG. 19. FIG. 20a shows a front view at a time prior to introducing the biosensor for simultaneously measuring multiple items 115 to measuring unit 116. FIG. 20b shows a front view of the biosensor for simultaneously measuring multiple items 115 introduced to the measuring unit 116. Herein, the V-shaped notch 107 located in the center portion of the cover of the biosensor for simultaneously measuring multiple items 115, in contact with the upper portion of the folding portion 120 of the measuring unit introduction part (FIG. 20a), horizontally presses the biosensor for simultaneously measuring multiple items 115 into the horizontal movement part 118 of the measuring unit, with the result that the biosensor for simultaneously measuring multiple items 115 is formed as shown in FIG. 20b. FIG. 20b shows a case where two connected biosensor unit-comprising substrates 128 are bent in to a V-shape where sample-inlet port 109 and air-discharge port 110 are adjacently connected, and have been transformed into a shape for taking in sample solution.

### EXAMPLE 20

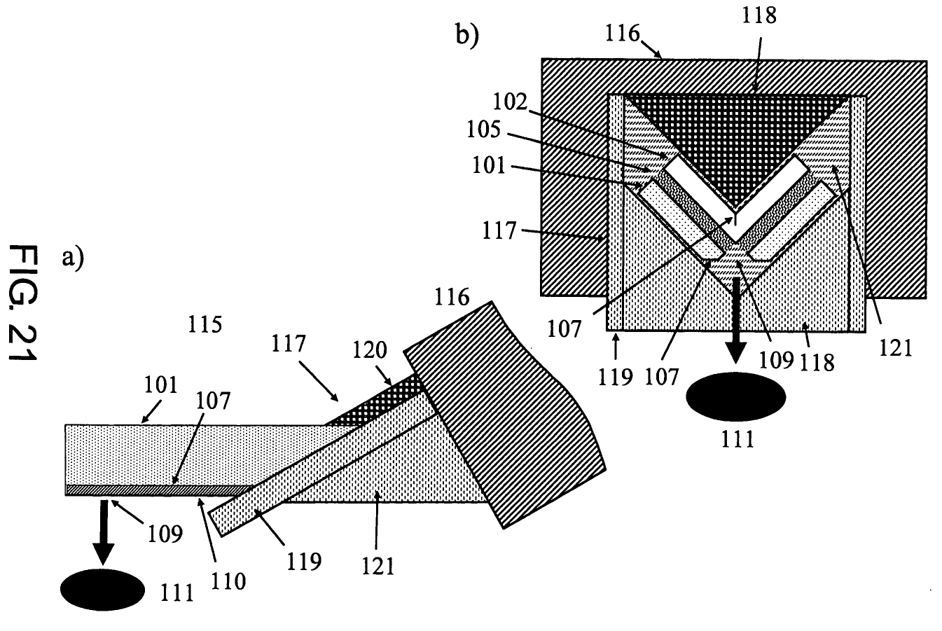

FIG. 21 shows a case where a sample solution is supplied while the biosensor for simultaneously measuring multiple items 115 is connected to measuring unit 116, shown in FIG. 19. FIG. 21a shows a side view of the biosensor for simultaneously measuring multiple items 115 and measuring unit 116. This shows a condition where sample solution 111 is supplied from sample-inlet port 109 of the biosensor for simultaneously measuring multiple items 115, by tilting measuring unit 116 at an angle of about 30 degrees, as shown. FIG. 21b shows a front view of the biosensor for simultaneously measuring multiple items at this time, forming a V-shape. As shown in FIG. 21b, a portion of the opening part of the V-shaped biosensor for simultaneously measuring multiple items forms two adjacent sample-inlet ports 109, in to which sample solution 111 can be supplied. As shown in the figure, a droplet (rounded) sample solution 111 is easily taken in when the biosensor for simultaneously measuring multiple items 115 is transformed to a V-shape.

### EXAMPLE 21

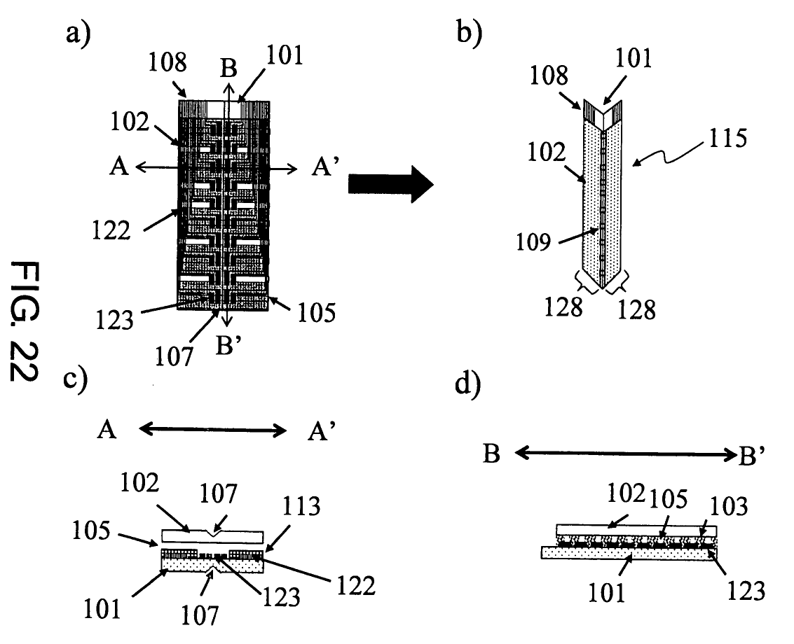

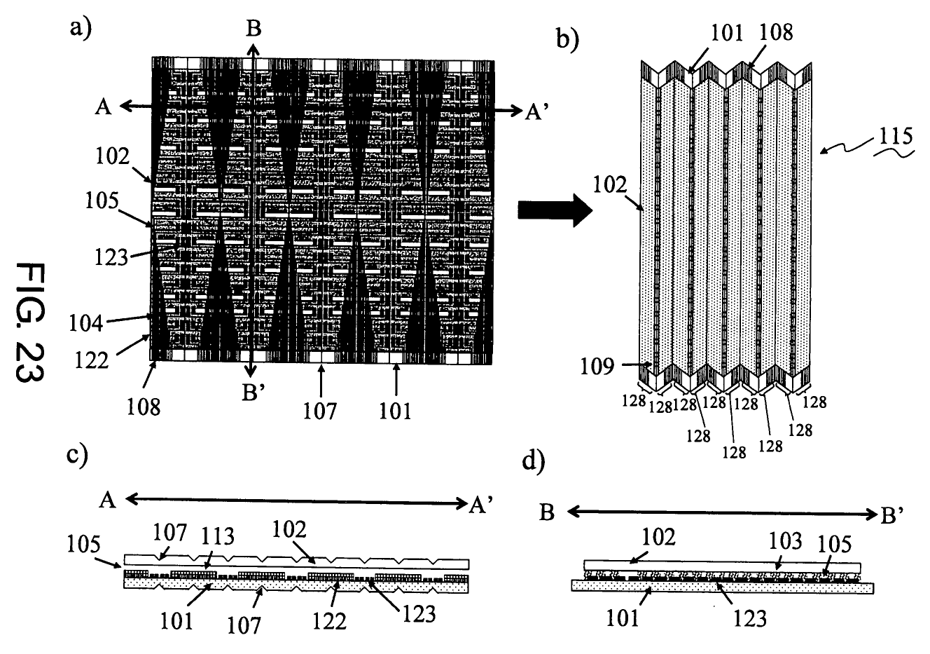

FIG. 22 shows an arrayed biosensor for simultaneously measuring multiple items.

FIG. 22a is a perspective diagram. Electrode patterns 104 are symmetrically arranged in two rows and ten columns, with the V-shaped notches 107 of substrate 101 and cover 102 as a center, and sample-feeding path 105 intersecting each electrode. FIG. 22b is an exemplary use of a biosensor for simultaneously measuring multiple items bent lengthways along V-shaped notch 107. In the biosensor for simultaneously measuring multiple items shown in FIG. 22, 20 biosensor units are divided in to two by the V-shaped notch 107, to form two biosensor unit-comprising substrates, each including ten biosensor units. Since one sample-inlet port is formed for each biosensor unit, ten sample-inlet ports 109 each, and 20 sample-inlet ports 109 in total, are formed on the cross sections of the biosensor unit-comprising substrates. Also, to smoothly supply sample solution 111 to sample-feeding path 105, air-discharge port 110 is located on the opposite side of sample-inlet port 109.

FIG. 22c shows an A-A′ cross-sectional view, and FIG. 22d shows a B-B′ cross-sectional view. The A-A′ cross-sectional view shown in FIG. 22c shows the arrangement of resist 113. The resist layer 113 in this arrayed biosensor for simultaneously measuring multiple items is used to insulate wiring other than the electrodes, and to make the insulating layer pattern clearer than where there is only the spacer layer (adhesive layer) 103. Therefore, the size of the pattern of this resist in FIG. 22a is the same size as that of cover portion 102, large enough to cover all except the part of electrode 123 forming a reaction layer.

In the arrayed biosensor for simultaneously measuring multiple items of FIG. 22, by regularly arranging a number of biosensor units, large numbers of sample solutions can be measured at the same time, and further, a larger number of items can be measured for one sample solution by arranging two biosensor unit-comprising substrates to face one another.

### EXAMPLE 22

FIG. 23 shows a biosensor for simultaneously measuring multiple items, consisting of a number of connected arrayed simultaneous multi-item measuring biosensors 115. In FIG. 23, there are ten biosensor unit-comprising substrates, and 20 biosensor units on each biosensor unit-comprising substrate.

FIG. 23a is a perspective diagram. FIG. 23b is an exemplary use of each of the biosensors for simultaneously measuring multiple items, which have been bent lengthways along V-shaped notch 107, to form a V-shape.

For example, since 20 biosensor units are included in one biosensor unit-comprising substrate in this arrayed biosensor for simultaneously measuring multiple items, a total of 200 sample-inlet ports 109 are formed.

FIG. 23c shows an A-A′ cross-sectional view, and FIG. 23d shows a B-B′ cross-sectional view.

In the arrayed biosensor for simultaneously measuring multiple items of FIG. 23, by regularly arranging a number of biosensor units greater than that shown in FIG. 22, not only can a large number of sample solutions be measured at the same time, but also a larger number of items (reagent layers) can be measured for one sample solution by two biosensor unit-comprising substrates arranged to face each other. When in actual use, biosensors with sample solution 111 pre-arranged on a flat substrate so as to have a certain contact angle can be used for measurement. Also, by facing the sample-inlet port 109 upwards, sample solution can be directly supplied using a sample-dispensing apparatus, such as a spotter.

### EXAMPLE 23

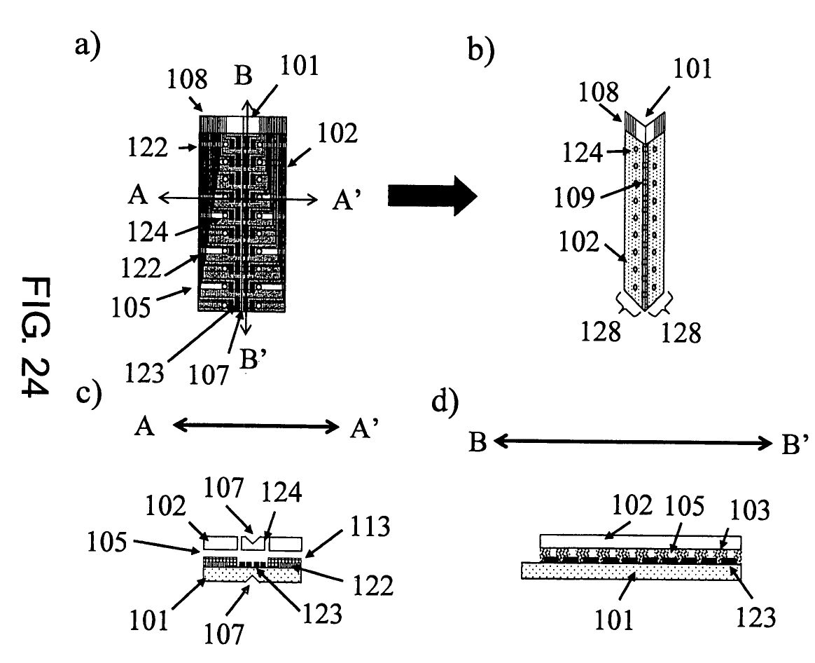

FIG. 24 shows an arrayed biosensor for simultaneously measuring multiple items, where the air-discharge port 124 of each biosensor unit is located between electrode pattern 104 and wiring 122 in the arrayed biosensor for simultaneously measuring multiple items of FIG. 22.

In the case of this arrayed biosensor for simultaneously measuring multiple items, wiring 122 orthogonal to a sample-feeding path does not necessarily have to be insulated by resist layer 113, which is different from the arrayed simultaneous multi-item measuring biosensors shown in FIG. 22 and FIG. 23. Furthermore, compared with the arrayed simultaneous multi-item measuring biosensors shown in FIG. 22 and FIG. 23, this biosensor is characterized in that less sample solution is required for measurement, since air-discharge port 124 is located next to electrode 123 such that the length of sample-feeding path 105 is shorter. FIG. 24c shows an A-A′ cross-sectional view, and FIG. 24d shows a B-B′ cross-sectional view.

### EXAMPLE 24

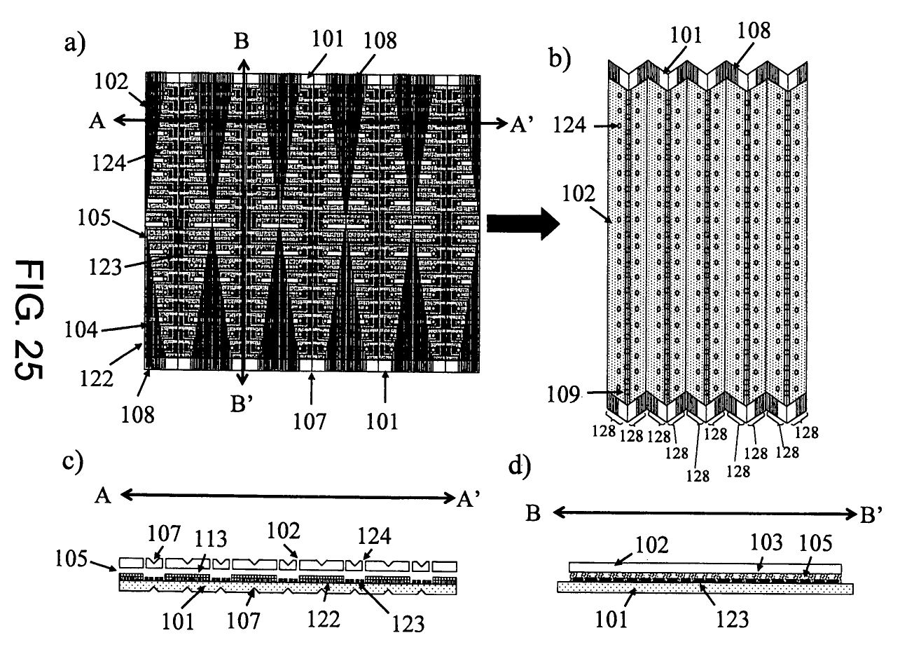

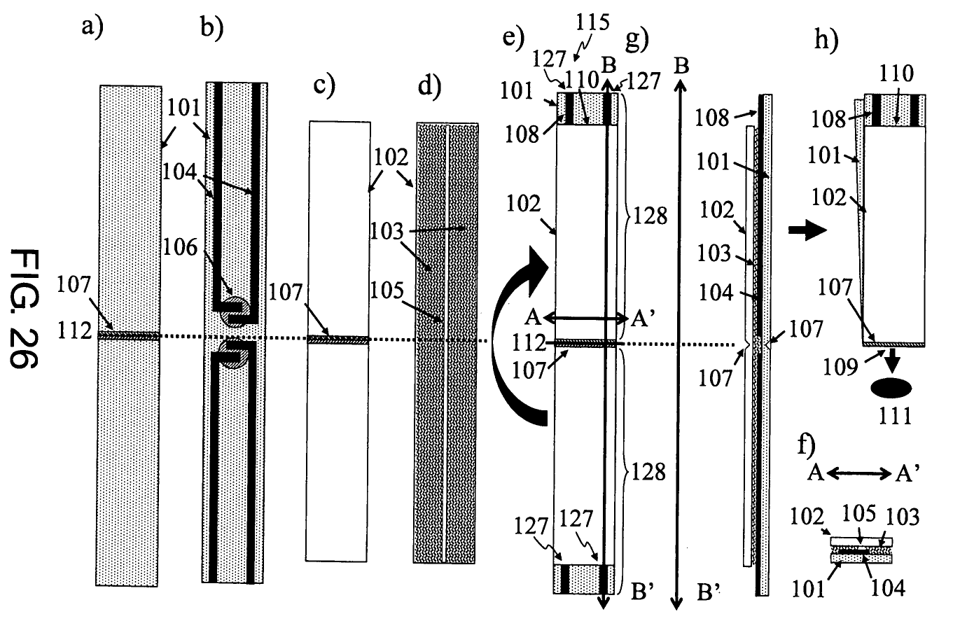

FIG. 25 shows a biosensor for simultaneously measuring multiple items further connected to a number of the biosensors for simultaneously measuring multiple items of FIG. 24. In FIG. 25 there are ten pairs of biosensor unit-comprising substrates, with 20 biosensor units on each biosensor unit-comprising substrate.

FIG. 25a is a perspective diagram. FIG. 25b is an exemplary use of biosensors for simultaneously measuring multiple items, where each is bent lengthways along the V-shaped notch 107, to form a V-shape. For example, since 20 biosensor units are included in one biosensor unit-comprising substrate in this arrayed biosensor for simultaneously measuring multiple items, a total of 200 sample-inlet ports 109 are formed.

FIG. 25c shows an A-A′ cross-sectional view, and FIG. 25d shows a B-B′ cross-sectional view.

In the arrayed biosensor for simultaneously measuring multiple items of FIG. 25, by regularly arranging a larger number of biosensor units than that shown in FIG. 24, not only can a large number of sample solutions be measured at the same time, but also a larger number of items (reagent layers) can be measured for one sample solution by two pairs of biosensor unit-comprising substrates arranged to face each other.

When in actual use, as for Example 22, biosensors with sample solution 111 pre-arranged on a flat substrate so as to have a certain contact angle can be used for measurement. Also, by facing the sample-inlet port 109 upwards, sample solution can be directly supplied using a sample-dispensing apparatus, such as a spotter. In these cases, for the reason mentioned in Example 23, less sample solution is needed for measurement, compared with Example 22.

### EXAMPLE 25

FIG. 26 shows a biosensor for simultaneously measuring multiple items, where two biosensor units are arranged on one substrate to face each other longitudinally. When used, the biosensor can be used for measurement after folding along a V-shaped notch, which is provided on two biosensor unit-comprising substrates, each including one biosensor unit.

FIG. 26a shows the outside of rectangular substrate 101 of a biosensor for simultaneously measuring multiple items. Horizontally formed V-shaped notch 107 is in the center portion of substrate 101.

FIG. 26b shows the inside of substrate 101. Inside substrate 101, patterns 104, including two pairs of electrodes, are arranged to face each other, with the central broken line 112 of the substrate as a boundary. Also, reagent layer 106 is formed in a portion of the electrode pattern of each pair. Although not shown in FIG. 26b, to clarify the pattern section that becomes reagent layer 106, a resist layer may be provided between an adhesive layer composing spacer 103 shown in FIG. 26d, and substrate 101, which includes electrode pattern 104 of FIG. 26b. The resist layer can have a similar pattern to an adhesive layer. In this case, the resist layer becomes spacer 103, as for the adhesive layer. In such cases, for example, the resist layer sometimes does not form a pattern similar to that of the adhesive layer. The resist layer may also be provided as an insulating layer to prevent electrode pattern 104, except for reagent layer (reaction layer) 106, from intersecting with sample-feeding path 105. Also, adhesive layer 103 may be formed on cover 102 in advance, as shown in the figure, or may be formed on the resist layer on substrate 101.

FIG. 26c shows the outer part of cover 102. In the center portion of cover 102, a horizontal cutting plane line is located in the form of V-shaped notch 107, as for substrate 101. FIG. 26d shows the inside of cover 102. On the inside surface of cover 102, an adhesive layer is formed as spacer layer 103. Portion 105, where no spacer exists, is located in the upper portion of cover 102 so as to divide the spacer layer (adhesive layer) 103 longitudinally into two, forming reagent-feeding path 105 by adhering the portion with substrate 101. In such cases, both ends of the sample-feeding path extend from top to bottom of the cover.

FIG. 26e shows a structural diagram of a biosensor for simultaneously measuring multiple items 115, where the inner surfaces of substrate 101 and cover 102 are overlapped while aligned along horizontal central line 112. Making cover 102 shorter than substrate 101 forms terminal 108 at both ends. Two biosensor unit-comprising substrates 128, each including one biosensor unit 127, exist with notch 107 as a boundary.

FIG. 26f shows an A-A′ cross-sectional view of the sample-feeding path on the upper side of the biosensor for simultaneously measuring multiple items, shown in FIG. 26e. Electrode 104 is located on substrate 101, and the spacer layer (adhesive layer) 103 and sample-feeding path 105, as an empty portion of the spacer, are formed between substrate 101 and cover 102. FIG. 26g shows a B-B′ cross-sectional view of the pattern of the electrode of the biosensor for simultaneously measuring multiple items shown in FIG. 26e. V-shaped notches 107 are arranged to overlap on the outside surfaces of substrate 101 and cover 102, between the two pairs of electrodes. The two electrodes 104 respectively extend from the top and bottom of substrate 101 until near the center.

FIG. 26h shows an exemplary use of a biosensor for simultaneously measuring multiple items of the present invention. FIG. 26h shows the biosensor for simultaneously measuring multiple items, longitudinally bent along V-shaped notch 107 on cover portion 102. As a result, substrate 101 is bent in half, but is not divided, and the two biosensor unit-comprising substrates are separated. On the other hand, the cover portion is divided along the V-shaped notch. Consequently, the two biosensor unit-comprising substrates can be folded as shown in the figure.

At this time, sample-feeding path 105 is divided along the V-shaped notch at the boundary of the two biosensor unit-comprising substrates, and sample-inlet ports 109 for each biosensor units are formed adjacently in one place. By contacting two adjacent sample-inlet ports 109 in this state with sample solution 111, the sample solution is independently supplied to sample-feeding paths 105 of the adjacent biosensor units by capillary action. To smoothly supply sample solution 111 to sample-feeding path 105, air-discharge port 110 is located on the opposite side of sample-inlet port 109.

The structure of the biosensor for simultaneously measuring multiple items in FIG. 26 characteristically includes two adjacent biosensor units that can use completely independent systems to measure one sample solution, without interference from reagents in the other's reagent layer tank. Herein, the biosensor for simultaneously measuring multiple items exemplified in FIG. 26 may be used such that two biosensor unit-comprising substrates 101 are folded to face each other, so their terminals 108 are back to back, or, used such that covers 102 of the two biosensor unit-comprising substrates are folded so each terminal 108 faces the other.

### EXAMPLE 26

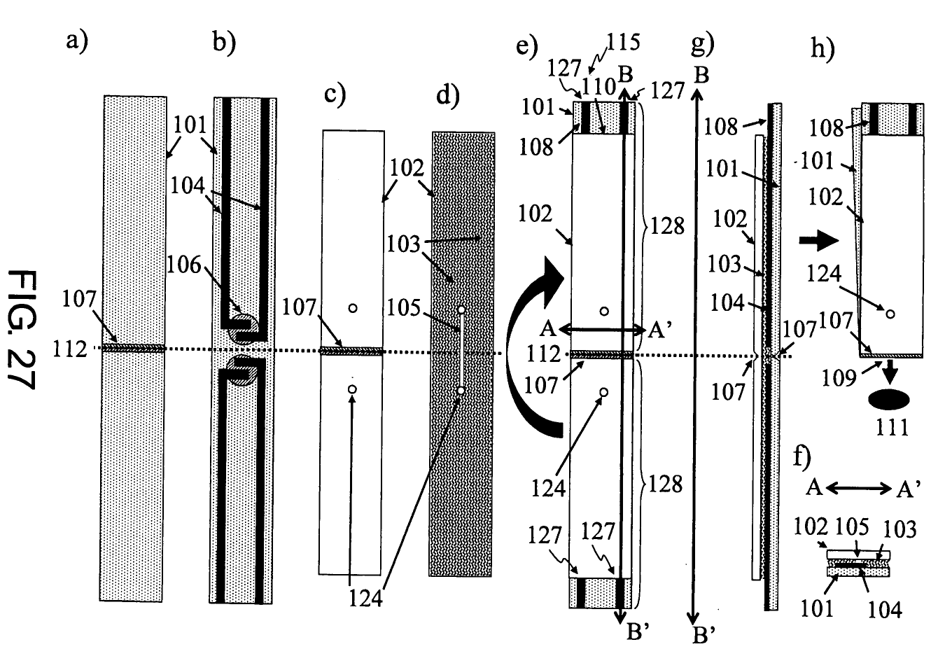

The outside structure of FIG. 27 is almost identical to that of the biosensor for simultaneously measuring multiple items of FIG. 26, but the inner structure is different.

FIG. 27a shows the outside of rectangular substrate 101 of a biosensor for simultaneously measuring multiple items. Horizontally formed V-shaped notch 107 is located in the center portion of substrate 101.

FIG. 27b shows the inside of substrate 101. Inside substrate 101, patterns 104, including two pairs of electrodes, are arranged to face each other, with central broken line 112 of the substrate as a boundary. Also, reagent layer 106 is formed in a portion of each pair of electrode patterns. Although not shown in FIG. 27b, to clarify the pattern section that becomes reagent layer 106, a resist layer may be provided between an adhesive layer composing spacer 103 shown in FIG. 27d, and substrate 101, which includes electrode pattern 104 of FIG. 27b. The resist layer can have a similar pattern to the adhesive layer. In this case, the resist layer becomes spacer 103, as for the adhesive layer. In such cases, for example, the resist layer sometimes does not form a pattern similar to an adhesive layer. The resist layer may also be provided as an insulating layer to prevent electrode pattern 104, except for reagent layer (reaction layer) 106, from intersecting with sample-feeding path 105. Also, the spacer layer (adhesive layer) 103 may be formed on cover 102 in advance, as shown in the figure, or may be formed on the resist layer on substrate 101.

FIG. 27c shows the outer part of cover 102. In the center portion of cover 102, a horizontally formed cutting plane line is located in the form of V-shaped notch 107, as for substrate 101. Furthermore, in contrast to FIG. 26c, air-discharge ports 124 are provided at two positions. FIG. 27d shows the inside of cover 102. On the inside surface of cover 102, an adhesive layer is formed as spacer layer 103. In the upper portion of cover 102, portion 105, where no spacer layer (adhesive layer) 103 exists, is formed between the air-discharge ports 124 of the two pairs of biosensor unit-comprising substrates.

FIG. 27e shows a structural diagram of a biosensor for simultaneously measuring multiple items 115, where the inner surfaces of substrate 101 and cover 102 are overlapped while aligned alone each horizontal central line 112. By making cover 102 shorter than substrate 101, terminal 108 is formed at both ends. Also, one of the two biosensor units 127 are included in each of the two biosensor unit-comprising substrates 128, with notch 107 as a boundary, and each biosensor unit-comprising substrate 128 is has one air-discharge port 124.

FIG. 27f shows an A-A′ cross-sectional view of the sample-feeding path on the upper side of the biosensor for simultaneously measuring multiple items shown in FIG. 27e. Electrode 104 is located on substrate 101, and spacer layer (adhesive layer) 103 and sample-feeding path 105, as an empty portion of the spacer, are formed between substrate 101 and cover 102. FIG. 27g shows a B-B′ cross-sectional view of the electrode pattern of the biosensor for simultaneously measuring multiple items shown in FIG. 27e. On the outside surfaces of substrate 101 and cover 102, between two pairs of electrodes, V-shaped notches 107 are arranged to overlap. On substrate 101, the two electrodes 104 respectively extend from the top and bottom until near the center.

FIG. 27h shows an exemplary use of a biosensor for simultaneously measuring multiple items of the present invention. FIG. 27h shows a biosensor for simultaneously measuring multiple items, longitudinally bent along V-shaped notch 107 on cover portion 102. As a result, substrate 101 is bent in half, but is not divided, and the two biosensor unit-comprising substrates are separated. On the other hand, the cover portion is divided along the V-shaped notch. Consequently, the two biosensor unit-comprising substrates can form a V-shape together, as shown in the figure. At this time, sample-feeding path 105 is divided along the V-shaped notch at the boundary of the two biosensor unit-comprising substrates, and the sample-inlet ports 109 of each biosensor unit are formed adjacently in one place. By contacting two adjacent sample-inlet ports 109 in this state with sample solution 111, the sample solution is independently supplied to the sample-feeding paths 105 of the adjacent biosensor units by capillary action. To smoothly supply sample solution 111 to sample-feeding path 105, air-discharge port 124 is in a form that penetrates cover 102 after passing reagent layer 106, where the electrode exists.

In contrast to the biosensor for simultaneously measuring multiple items exemplified in FIG. 26, the biosensor for simultaneously measuring multiple items exemplified in FIG. 27 employs a structure with a reduced sample-feeding path 105 volume, which ends in air-discharge port 124, provided to penetrate cover 102. Thus, as a result, the biosensor in FIG. 27 is characterized in that the amount of sample solution required for measurement can be reduced. Regarding the other characteristics and applications for use, as for the biosensor for simultaneously measuring multiple items exemplified in FIG. 26, this biosensor may be used in a condition where the two biosensor unit-comprising substrates 101 are folded to face each other so their terminals 108 are back to back, or such that the covers 102 of the two biosensor unit-comprising substrates are folded so their terminals 108 face each other.

### EXAMPLE 27

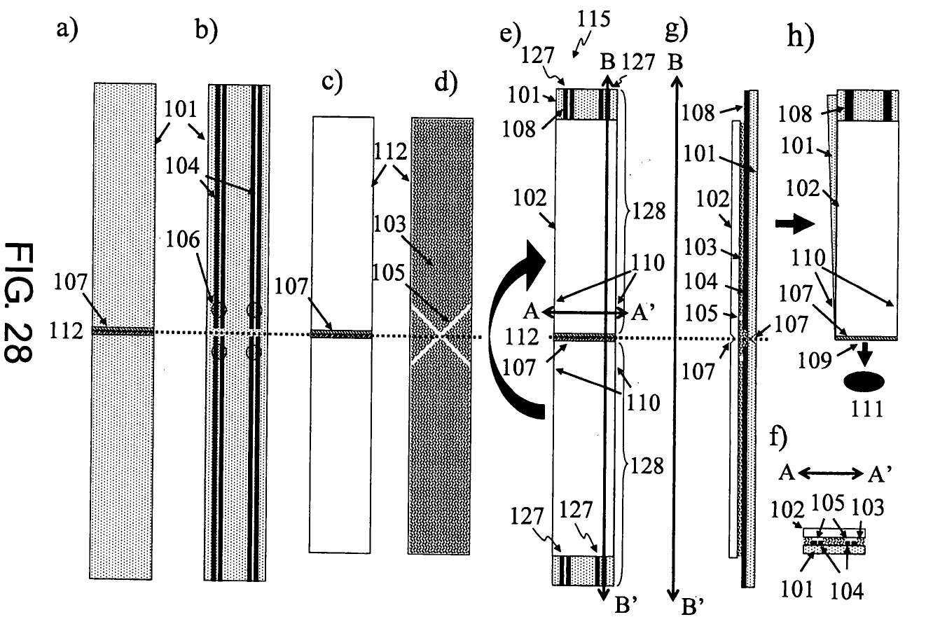

On the outside, FIG. 28 is almost identical to the structure of the biosensor for simultaneously measuring multiple items of FIG. 26, but the inner structure is different.

FIG. 28a shows the outside of rectangular substrate 101 of a biosensor for simultaneously measuring multiple items. The horizontally formed V-shaped notch 107 is located in the center portion of substrate 101.

FIG. 28b shows the inside of substrate 101. Inside substrate 101, four pairs of patterns 104, including electrodes, are arranged to face each other in two sets of two pairs, with the central broken line 112 of the substrate as a boundary. Also, reagent layer 106 is formed in a portion of each pair of electrode patterns. Although not shown in FIG. 28b, to clarify the pattern section that becomes reagent layer (reaction tank) 106, a resist layer may be provided between an adhesive layer composing spacer 103 shown in FIG. 28d, and substrate 101, which includes electrode pattern 104 of FIG. 28b. The resist layer can have a similar pattern to an adhesive layer. In this case, the resist layer becomes spacer 103, as for the adhesive layer. In such cases, for example, the resist layer sometimes does not form a pattern similar to an adhesive layer. The resist layer may also be provided as an insulating layer to prevent electrode pattern 104, except for reagent layer (reaction layer) 106, from intersecting with sample-feeding path 105. Also, the spacer layer (adhesive layer) 103 may be formed on cover 102 in advance, as shown in the figure, or may be formed on the resist layer on substrate 101.

FIG. 28c shows the outer part of cover 102. In the center portion of cover 102, a horizontally formed cutting plane line is located in the form of V-shaped notch 107, as for substrate 101. FIG. 28d shows the inside of cover 102. On the inside surface of cover 102, an adhesive layer is formed as spacer layer 103. In the upper portion of cover 102, portion 105 where no spacer exists is provided in an X shape in spacer layer (adhesive layer) 103, resulting in sample-feeding path 105 when the portion is adhered to substrate 101. In such cases, the two ends of the sample-feeding path appear at four positions on a side face different to the cross section of the biosensor for simultaneously measuring multiple items.

FIG. 28e shows a structural diagram of the biosensor for simultaneously measuring multiple items 115, where the inner surfaces of substrate 101 and cover 102 are overlapped with their horizontal central line 112 aligned. By making cover 102 shorter than substrate 101, a terminal 108 forms at both ends. Also, the four biosensor units 127 exist in groups of two, in two biosensor unit-comprising substrates 128, with notch 107 as a boundary. Furthermore, air-discharge ports 110, derived from each biosensor unit, are provided on different side faces to the cross section of biosensor unit comprising substrate 128.

FIG. 28f shows an A-A′ cross-sectional view of the sample-feeding path on the upper side of the biosensor for simultaneously measuring multiple items shown in FIG. 28e. Electrodes 104 are located on substrate 101, and spacer layer (adhesive layer) 103 and sample-feeding path 105, as an empty portion of the spacer, are formed between substrate 101 and cover 102. FIG. 28g shows a B-B′ cross-sectional view of the pattern of the electrode of the biosensor for simultaneously measuring multiple items shown in FIG. 28e. V-shaped notches 107 are arranged on the outside surfaces of substrate 101 and cover 102, between two pairs of electrodes and so as to overlap. On substrate 101, two electrodes 104 respectively extend from the top and bottom until near the center, and sample-feeding path 105 is formed near the V-shaped notches 107.

FIG. 28h shows an exemplary use of a biosensor for simultaneously measuring multiple items of the present invention. FIG. 28h shows a biosensor for simultaneously measuring multiple items bent longitudinally along the V-shaped notch 107 on the cover portion 102. As a result, substrate 101, which includes four biosensor units, is bent to separate in to two biosensor unit-comprising substrates each including two biosensors, but is not divided. On the other hand, the cover portion is divided along the V-shaped notch. Consequently, the two biosensor unit-comprising substrates can be folded up as shown in the figure.

At this time, in sample-feeding path 105, the four biosensor units are divided along the V-shaped notch into two lots of two, and sample-inlet ports 109 are formed adjacently in one place for each biosensor unit. By contacting four adjacent sample-inlet ports 109 in this state with sample solution 111, the sample solution is independently supplied to each of the sample-feeding paths 105 of the adjacent biosensor units. To smoothly supply sample solution 111 to sample-feeding path 105, air-discharge port 110 is provided on the side face of the biosensor unit-comprising substrate, located at the back of reagent layer 106 where the electrodes exist.

In contrast to the biosensor for simultaneously measuring multiple items exemplified in FIG. 26, the biosensor for simultaneously measuring multiple items exemplified in FIG. 28 folds along the V-shaped notch located at the center to bring the two lots of two biosensor units back to back. As a result, up to four items can be measured for one sample solution. Regarding other characteristics and applications for use, as for the biosensor for simultaneously measuring multiple items exemplified in FIG. 26, this biosensor may be used where the two biosensor unit-comprising substrates 101 are folded to face each other, so the respective terminals 108 are back to back, or where the covers 102 of the two biosensor unit-comprising substrates are folded to face each other, so each terminal 108 faces the other.

### EXAMPLE 28

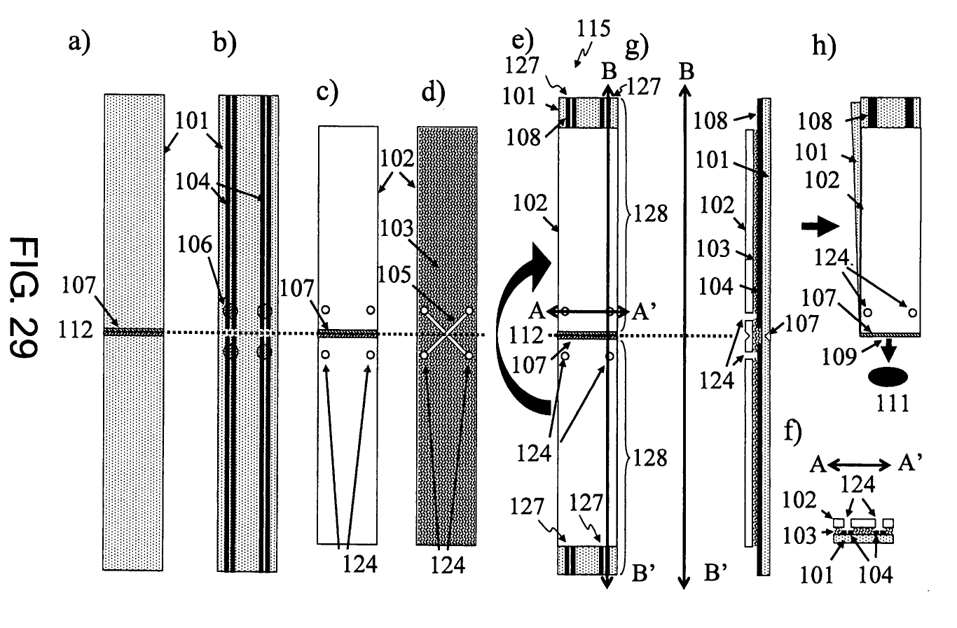

The outer structure of FIG. 29 is almost identical to that of the biosensor for simultaneously measuring multiple items of FIG. 26, but its inner structure is different.

FIG. 29a shows the outside of rectangular substrate 101 of a biosensor for simultaneously measuring multiple items. The horizontally formed V-shaped notch 107 is located in the center portion of substrate 101.

FIG. 29b shows the inside of substrate 101. Inside substrate 101, patterns 104, including four pairs of electrodes, are arranged to face each other in two lots of two, with the central broken line 112 of the substrate as a boundary. Also, reagent layer 106 is formed in a portion on each pair of electrode patterns. Although not shown in FIG. 29b, to clarify the pattern section that becomes reagent layer (reaction tank) 106, a resist layer may be provided between an adhesive layer composing spacer 103 shown in FIG. 29d, and substrate 101, which includes electrode pattern 104 of FIG. 29b. The resist layer can have a similar pattern to an adhesive layer. In this case, the resist layer becomes spacer 103, as for the adhesive layer. In such cases, for example, the resist layer sometimes does not form a pattern similar to an adhesive layer. The resist layer may also be provided as an insulating layer to prevent electrode pattern 104, except for reagent layer (reaction layer) 106, from intersecting with sample-feeding path 105. Also, the spacer layer (adhesive layer) 103 may be formed on cover 102 in advance, as shown in the figure, or may be formed on the resist layer on substrate 101.

FIG. 29c shows the outer part of cover 102. A horizontally formed cutting plane line is located in the form of V-shaped notch 107 in the center portion of cover 102, as for substrate 101. Furthermore, in contrast to FIG. 28c, air-discharge ports 124 are provided at four positions. FIG. 29d shows the inside of cover 102. An adhesive layer is formed as spacer layer 103 on the inside surface of cover 102. Furthermore, on the surface of cover 102, portion 105 where no spacer exists is provided in an X shape in spacer layer (adhesive layer) 103, and through-holes (air-discharge ports) 124 are provided at the four ends of this portion. Reagent-feeding path 105 is formed by adhering this portion with substrate 101.

FIG. 29e shows a structural diagram of the biosensor for simultaneously measuring multiple items 115, where the inner surfaces of substrate 101 and cover 102 are overlapped with their horizontal central lines 112 aligned. By making cover 102 shorter than substrate 101, terminals 108 are formed at both ends. Also, four biosensor units 127 are separated into two with notch 107 as a boundary, included in two biosensor unit-comprising substrates 128, where each biosensor unit has one air-discharge port 124.

FIG. 29f shows an A-A′ cross-sectional view of the sample-feeding path on the upper side of the biosensor for simultaneously measuring multiple items shown in FIG. 29e. Electrode 104 is located on substrate 101. Spacer layer (adhesive layer) 103, sample-feeding path 105 as an empty portion of the spacer, and two air-discharge port 124 are formed between substrate 101 and cover 102. FIG. 29g shows a B-B′ cross-sectional view of the pattern of the electrode of the biosensor shown in FIG. 29e. V-shaped notches 107 are arranged so as to overlap on the outside surfaces of substrate 101 and cover 102, between two pairs of electrodes. On substrate 101, two electrodes 104 extend from the top and bottom until near the center, resulting in sample-feeding path 105 near V-shaped notch 107.

FIG. 29h shows an exemplary use of a biosensor for simultaneously measuring multiple items of the present invention. FIG. 29h shows a biosensor for simultaneously measuring multiple items, longitudinally bent along the V-shaped notch 107 on cover portion 102. As a result, substrate 101, including four biosensor units, is bent so as to separate two biosensor unit-comprising substrates to include two biosensor units each, but is not divided. On the other hand, the cover portion is divided along the V-shaped notch.

Consequently, the two biosensor unit-comprising substrates can be folded as shown in the figure. At this time, the four biosensor units of sample-feeding path 105 are divided along the V-shaped notch into two groups of two, and the sample-inlet ports 109 of the respective biosensor units are formed adjacently in one place. By contacting four adjacent sample-inlet ports 109 in this state with sample solution 111, the sample solution is independently supplied to sample-feeding paths 105 of the adjacent biosensor units by capillary action. To smoothly supply sample solution 111 into sample-feeding path 105, air-discharge port 124 is provided so as to penetrate cover 102 at the back of the reagent layer 106, where the electrodes exist.

In contrast to the biosensor for simultaneously measuring multiple items exemplified in FIG. 26, the biosensor for simultaneously measuring multiple items exemplified in FIG. 29 folds along the V-shaped notch located at the center to bring the two lots of two biosensor units back to back. As a result, up to four items can be measured from one sample solution. Furthermore, as for the examples of the biosensor for simultaneously measuring multiple items in FIGS. 26 and 27, the biosensor for simultaneously measuring multiple items exemplified in FIG. 29 requires less sample solution for measurement than that of FIG. 28. Regarding other characteristics and applications for use, as for the biosensor for simultaneously measuring multiple items exemplified in FIG. 26, this biosensor may be used with two biosensor unit-comprising substrates 101 folded up to face each other, so their terminals 108 are back to back, or, with covers 102 of the two biosensor unit-comprising substrates folded to face each other, so the terminals 108 face each other.

### EXAMPLE 29

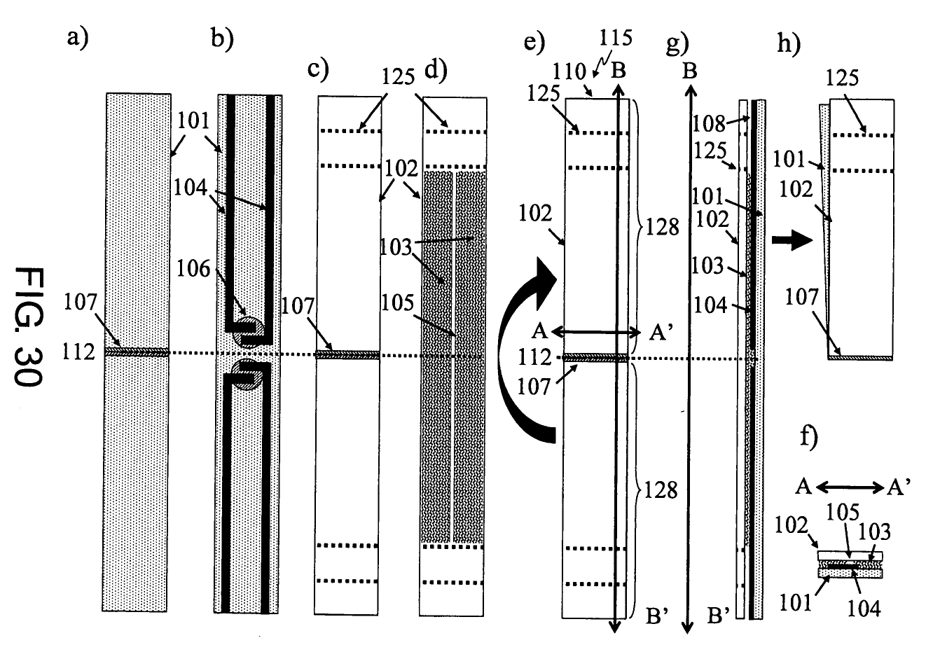

FIG. 30 exemplifies a biosensor for simultaneously measuring multiple items, structured so a cover protects the terminal of the biosensor for simultaneously measuring multiple items of FIG. 26 until use. Herein, the biosensor for simultaneously measuring multiple items of FIG. 26 is taken as an example, but there is no limitation on the form of the present invention, so long as it concerns a biosensor for simultaneously measuring multiple items of the present invention.

FIGS. 30a, b, and f are identical to FIGS. 26a, b, and f. FIGS. 30c, d, e, g, and h have a structure where cover 2, shown in FIGS. 26c, d, e, g, and h, covers the entire substrate 1, and the adhesive layer composing spacer 103 is the same as the pattern shown in 113c. Perforations 125 are provided at two lots of two positions in the cover portion 102, which covers the top and bottom terminals 108.

### EXAMPLE 30

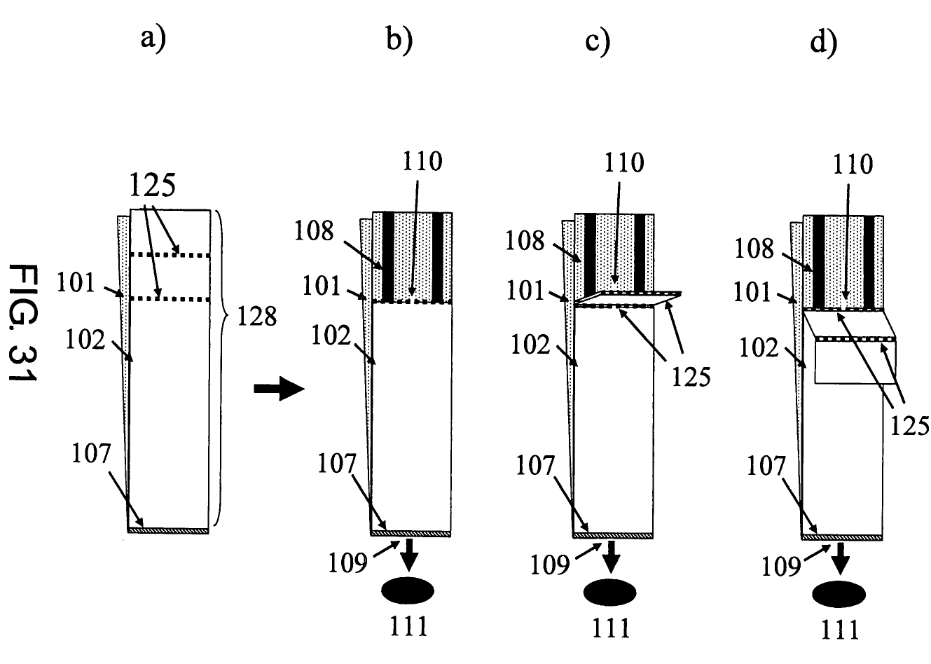

FIG. 31 shows an exemplary use of terminal parts 108 of the biosensor for simultaneously measuring multiple items exemplified in FIG. 30. FIG. 31a shows a biosensor before use. FIG. 31b shows a biosensor with cover 102, which covers the upper portion of terminal 108, removed along perforations 125; FIG. 31c shows a condition where cover 102 is folded along perforations 125; and FIG. 31d shows a biosensor where cover 102 is folded back along perforations 125.

By using cover 102 to cover the biosensor for simultaneously measuring multiple items up to terminal part 108, terminal 108 can be protected until use.

### EXAMPLE 31

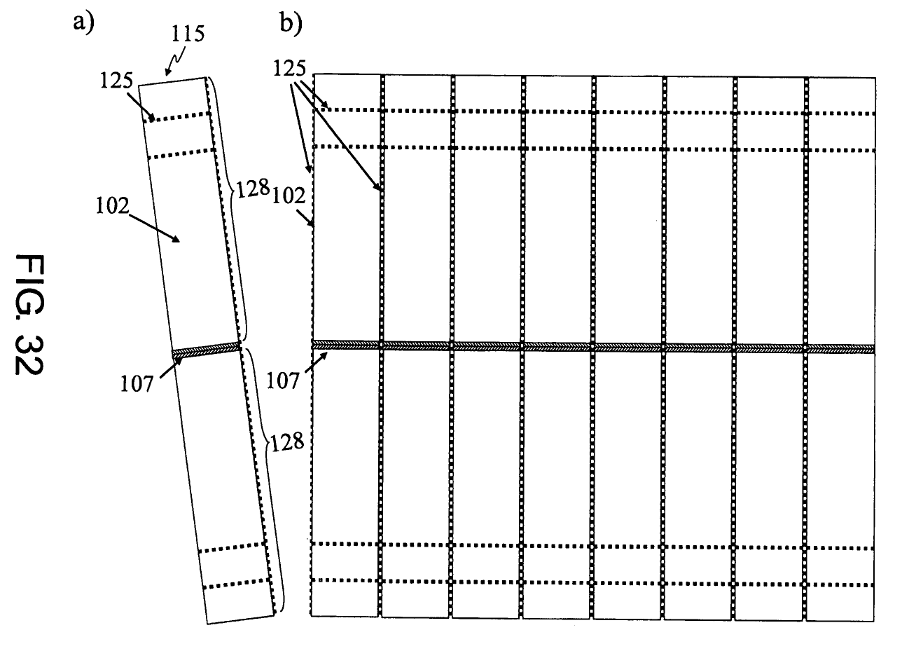

FIG. 32 shows an example connecting the terminal protection-type biosensor for simultaneously measuring multiple items 115 exemplified in FIG. 30. The structure of biosensors for simultaneously measuring multiple items 115 which can be connected is applicable to the biosensors for simultaneously measuring multiple items exemplified in FIGS. 26 to 29. That is, the biosensors for simultaneously measuring multiple items are not particularly limited to a specific form, as long as each biosensor unit-comprising substrate 128 has a V-shaped notch located in substrate 101 and cover 102 as a center. When used, the biosensor for simultaneously measuring multiple items 115 can be separated along longitudinally provided perforations 125, as shown in the figure.

### EXAMPLE 32

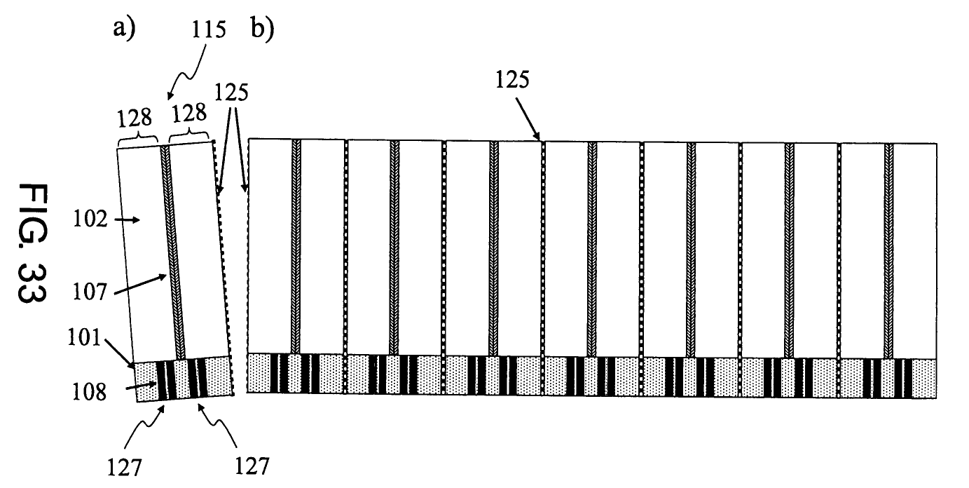

FIG. 33 shows an example of connected terminal protection-type biosensors for simultaneously measuring multiple items 115, as exemplified in FIGS. 14, 16, 17, and 18. In such cases, the biosensors for simultaneously measuring multiple items 115 are not particularly limited to a specific form, as long as each biosensor unit-comprising substrate 128 has a V-shaped notch located in substrate 101 and cover 102 as a center. When used, each of the biosensors for simultaneously measuring multiple items 115 can be separated along longitudinally provided perforations 125, as shown in the figure.

### EXAMPLE 33

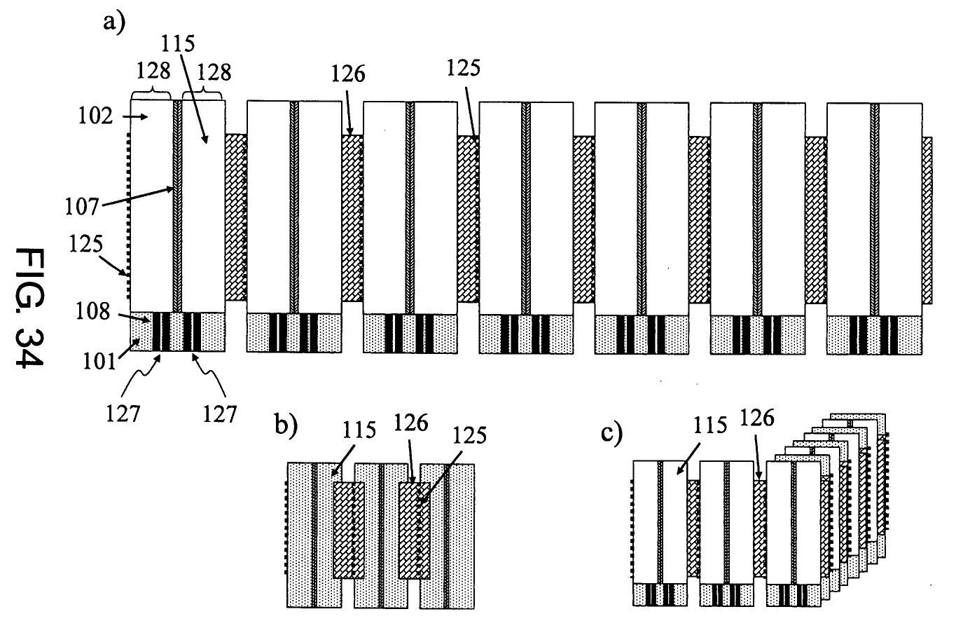

FIG. 34 shows an example of connected biosensors for simultaneously measuring multiple items 115, as exemplified in FIGS. 14, 16, 17, and 18, and connected using a soft sheet. In such cases, as for Example 32, the biosensor for simultaneously measuring multiple items 115 is not particularly limited to a specific form, as long as each biosensor unit-comprising substrate 128 is orientated with a V-shaped notch located in substrate 101 and cover 102 as a center. As shown in the figure, each of the biosensors for simultaneously measuring multiple items 115 are connected by a soft sheet, and when used can be separated using longitudinally provided perforations 125. In this form, in contrast to Example 32, each of the biosensors for simultaneously measuring multiple items 115 can be collected together by folding. As a result, the connected biosensors for simultaneously measuring multiple items 115 can be accommodated in a special container or the like.

### EXAMPLE 34

FIG. 35 shows a biosensor for simultaneously measuring multiple items 115 with an air-discharge port opening 131 on each biosensor unit-comprising substrate 128, where the air-discharge port opening 131 is bent by a provided auxiliary device 129 on opening a sample-inlet port in the structure of the biosensor for simultaneously measuring multiple items of FIG. 14 (FIG. 35(e)).

FIG. 35a shows the outside of rectangular substrate 101 of a biosensor for simultaneously measuring multiple items. In the center portion of substrate 101, a vertically formed cutting plane line 112 runs from top to bottom, and upper outward-folding portions (the air-discharge port openings) 131 of substrate 101 are formed so as to form a small rectangle. Also, cutting plane line 112 is provided as a V-shaped notch 107. These notches 107 are to bend the biosensor for simultaneously measuring multiple items in to a V-shape along the center broken line 112 when in use, and further, to bend the upper outward-folding portion 131 along broken line 112, in the direction of the center broken line 112. Furthermore, in the upper outward-folding portion 131, an auxiliary device 129 is provided so that the air-discharge port openings 131 open in conjunction with opening a sample-inlet port. Two auxiliary devices 129 are provided to connect both ends of upper outward-folding portion 131. Auxiliary device 129 is provided with a fixed portion for fixing to the upper outward-folding portion 131.

FIG. 35b shows the inside of substrate 101. Inside substrate 101, patterns 104 including two pairs of electrodes are arranged in parallel from top to bottom, with the center broken line 112 of the substrate as a boundary. Similarly, at both inner tops of substrate 101, the broken line 112 showing the air-discharge port opening 131 is parallel to the outsides of patterns 104, which include two pairs of electrodes. Also, reagent layer 106 is formed in a portion of the electrode pattern of each pair. Although not shown in FIG. 35b, to clarify the pattern section that becomes reagent layer 106, a resist layer may be provided between an adhesive layer composing spacer 103 shown in FIG. 35d, and substrate 101, which includes electrode pattern 104 of FIG. 35b. The resist layer can have a similar pattern to an adhesive layer. In this case, the resist layer becomes spacer 103, as for the adhesive layer. In such cases, for example, the resist layer sometimes does not form a pattern similar to an adhesive layer. The resist layer may also be provided as an insulating layer to prevent electrode pattern 104, except for reagent layer 106, from intersecting with sample-feeding path 105. Also, the spacer layer (adhesive layer) 103 may be formed on cover 102 in advance, as shown in the figure, or may be formed on the resist layer on substrate 101.

FIG. 35c shows the outer portion of cover 102. In the center portion of cover 102, as for substrate 101, the vertically formed V-shaped notches 107 run from top to bottom, and the upper outward-folding portions 131 of substrate 101 form a small rectangle. Cutting plane line 112 is provided as a V-shaped notch 107. FIG. 35d shows the inside of cover 102. An adhesive layer is formed as spacer layer 103 on the inside surface of cover 102. A portion 105, where no spacer exists, is provided in the upper portion of cover 102, to form the reagent-feeding path 105 by adhering the portion to the substrate.

FIG. 35e is a structural diagram of a biosensor for simultaneously measuring multiple items 115, showing the inner surfaces of substrate 101 and cover 102 superimposed on each other with their tops aligned. By making cover 102 shorter than substrate 101, the bottom portion of electrode pattern 104 is exposed when the two are superimposed with their tops aligned. This becomes terminal 108, shown in FIG. 35e. Also, two biosensor unit-comprising substrates 128, each including one biosensor unit 127, exist with notch 107 as a boundary, and air-discharge port opening 131 is in the upper outside portion of each biosensor unit-comprising substrate 128.

FIG. 35f shows an A-A′ cross-sectional view of the sample-feeding path portion on the upper side of the biosensor for simultaneously measuring multiple items shown in FIG. 35e. Two pairs of two electrodes 104 are each arranged on substrate 101, an adhesive layer is provided between the substrate and cover, and the cross section portion of FIG. 35f becomes the empty spacer portion forming sample-feeding path 105. This structure hermetically seals sample-feeding path 105 in the empty portion of the spacer sandwiched between the substrate and cover. Overlapping V-shaped notches 107 are provided between the two pairs of electrodes, as well as on the outside of the substrate 101 and cover 102 of the two air-discharge port openings 131. FIG. 35g shows a B-B′ cross-sectional view of the pattern of the electrodes of the biosensor for simultaneously measuring multiple items shown in FIG. 35e. Electrodes 104 are formed on substrate 101, and one spacer 103 and one sample-feeding path 105 each are provided between substrate 101 and cover 102. Furthermore, two auxiliary devices 129 are arranged on the outside upper surface of substrate 101, sandwiching sample-feeding path 105.

FIG. 35h shows an exemplary use of a biosensor for simultaneously measuring multiple items of the present invention. FIG. 35h shows a case where the biosensor for simultaneously measuring multiple items is longitudinally bent along the V-shaped notch 107 located in cover portion 102. As a result, substrate 101 of the biosensor for simultaneously measuring multiple items is divided in two. Cover portion 102, on the other hand, is not divided, although it is bent along V-shaped notch 107. Consequently, two biosensor-unit comprising substrates can be formed in to a V-shape, facing each other as shown in the figure. At this time, sample-feeding path 105 is divided along the V-shaped notch at the boundary of the two biosensor unit-comprising substrates, forming sample-inlet ports 109 for each of the biosensor units adjacently in one place. At the same time, forming the V-shape extends the two auxiliary devices 129, and the upper outward-folding portions 131 on the two biosensor unit-comprising substrates bend to form two air-discharge ports 110. By going through the above-described process, sample-feeding path 105 is changed from a hermetically sealed state to an open state.

By contacting two adjacent sample-inlet ports 109 in this state with sample solution 111, the sample solution 111 is independently supplied to the adjacent sample-feeding paths 105 by capillary action. If sample solution 111 is slightly rounded by surface tension at this time, as shown in the figure, it can be effectively supplied to the sample-feeding path 105, since the two biosensor unit-comprising substrates form a V-shape together, as shown in FIG. 35h. To smoothly supply sample solution 111 to sample-feeding path 105, air-discharge port 110 is provided on the opposite side of sample-inlet port 109. FIG. 35i shows a front view of the two biosensor unit-comprising substrates forming a V-shape. This figure shows auxiliary device 129 extended by the V-shape formation of the biosensor unit-comprising substrate, so that each air-discharge port opening 131 is bent from the biosensor unit-comprising substrate.

In the case of FIG. 35, as for the biosensor for simultaneously measuring multiple items shown in FIG. 14, the structure characteristically includes two adjacent biosensor units that can measure one sample solution in completely independent systems, without interference from the reagents in the other's reagent layer. Herein, the biosensor for simultaneously measuring multiple items exemplified in FIG. 35, where a crack is generated on the substrate side, may be divided on the side of cover 102. Furthermore, the biosensor for simultaneously measuring multiple items is not limited to transformation to a V-shape, and may also be completely folded along the V-shaped notch of either substrate 101 or cover 102, or may be used by making a crack at less than 180 degrees using a hard substrate. Also, the biosensor for simultaneously measuring multiple items exemplified in FIG. 35 has two auxiliary devices 129 for opening air-discharge ports, but may have one auxiliary device, or three, or more. The use of this auxiliary device 129 simultaneously forms sample-inlet port 109 and air-discharge port 110, just by transforming the biosensor for simultaneously measuring multiple items into a V-shape. FIG. 35 exemplifies a biosensor for simultaneously measuring multiple items that uses auxiliary device 129, but the biosensor does not have to be specifically provided with an auxiliary device. In such cases, the air-discharge port may be opened by manually bending each air-discharge port opening 131.

### EXAMPLE 35

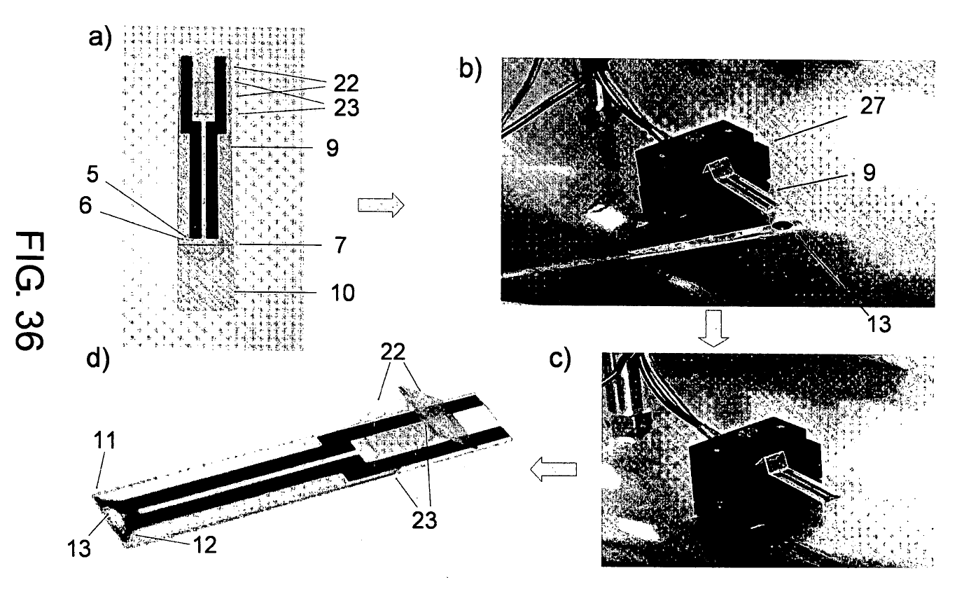

FIG. 36 shows an embodiment of a sealed-type biosensor for measuring a single item of the present invention applied to the measurement of glucose. Also, this biosensor is one example where a terminal protective cover shown in FIG. 12c is provided for the biosensor shown in FIG. 1.

FIG. 36a shows a biosensor before use for measurement, showing an example where the reagent layer 6 is developed in sample-feeding path 5. In the biosensor shown in FIG. 36b, where sample-feeding path 11 and air-discharge port 12 are opened by cutting off biosensor unit 9 and sealing cap portion 10 with notch 7 of FIG. 36a as a boundary, the terminal protective cover 22 is folded up as shown in FIG. 12a. The biosensor is then connected to connector 27, and whole blood is supplied to the biosensor as sample 13. FIG. 36c shows an example of the biosensor supplied with a sample; and FIG. 36d shows an example of the biosensor after measurement.

This biosensor of the present invention employs glucose oxidase and potassium ferricyanide as a reagent layer. The measurement principle of this glucose sensor, shown in FIG. 36a, is described below:

A sample is supplied to this biosensor by capillary action from a sample-inlet port to the inside. As indicated by Formula 1 below, in the supplied glucose solution, catalytic action of GOD in the reagent layer converts ferricyanide ions into ferrocyanide ions, and oxidizes glucose:

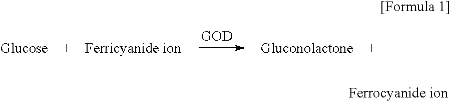

The generated ferrocyanide ions are oxidized by a carbon electrode according to the electrode reaction of the following Formula 2, and then detected electrochemically:

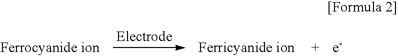

In detection methods using the glucose sensors of the present invention, the generated ferrocyanide ions are oxidized by an anode electrode, an anode current flows, and the ferrocyanide ions become ferricyanide ions again. The glucose quantity can thus be determined by observing changes in the current value due to the concentration of ferrocyanide ions generated by enzyme reaction.

Next, the production methods and measurement methods of the biosensor are described.

Polyethylene terephthalate (PET) (length 40 mm, width 6 mm, depth 188 μm) was employed as a biosensor substrate and cover. On the biosensor substrate, two carbon electrodes of 1.3 mm in width were formed at an interval of 0.5 mm using a screen printer. Screen printing was also used to form resist and adhesive as a spacer layer. Notches for cutting off biosensor units and sealing cap portions were formed 10 mm from the upper portion of the biosensor substrate, so their depth was half, or more than half the depth of the substrate and cover. Perforations were provided at two positions 5 mm and 10 mm from the lower portion of the biosensor substrate, in a bent portion of the terminal protective cover.

The amount of sample was about 0.28 μl, but the amount of sample actually required, when measured in whole blood (specific gravity: 1.05), was 0.34±0.023 mg (n=10, coefficient of variation CV=6.7%). This difference between sample amounts is assumed to be because the spacer layer was actually deeper than expected, or the sample solution adhered near the sample-inlet port, or the like.

The reagent layer of enzyme and mediator, made with 5.5 units glucose oxidase (GOD) and 0.1 mg potassium ferricyanide (mediator) dissolved in distilled water, was formed on both electrodes by application to the electrode surface and vacuum drying.

The results of measuring blood sugar (glucose in the blood) using this glucose sensor will now be described: For blood sugar measurement using this glucose sensor, whole blood samples with a hematocrit value of 40% were prepared, with glucose concentrations set at 0, 100, 300, and 500 mg/dl, and these were used as specimen solutions. An electrochemical measuring unit (ALS/CHI-1202, BAS Inc.) was used for measurement, and potential step chronoamperometry was employed as a measurement method. Twenty seconds after supplying about 0.3 μl blood into the sample-inlet port by capillary action, an electric potential of 900 mV was applied between the two electrodes in the biosensor, and the current value ten seconds after application was used as the measured value.

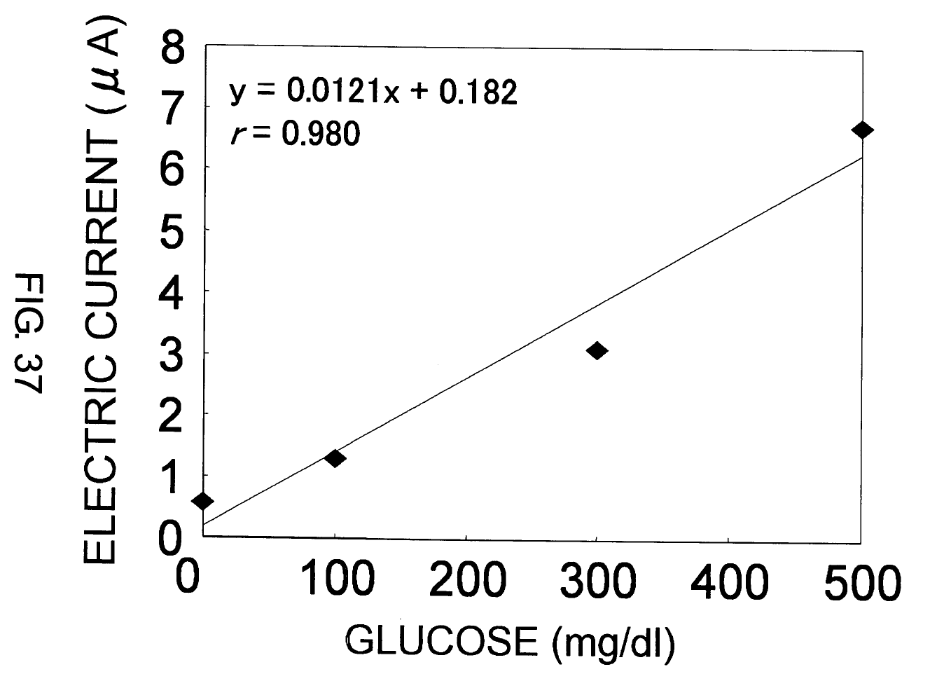

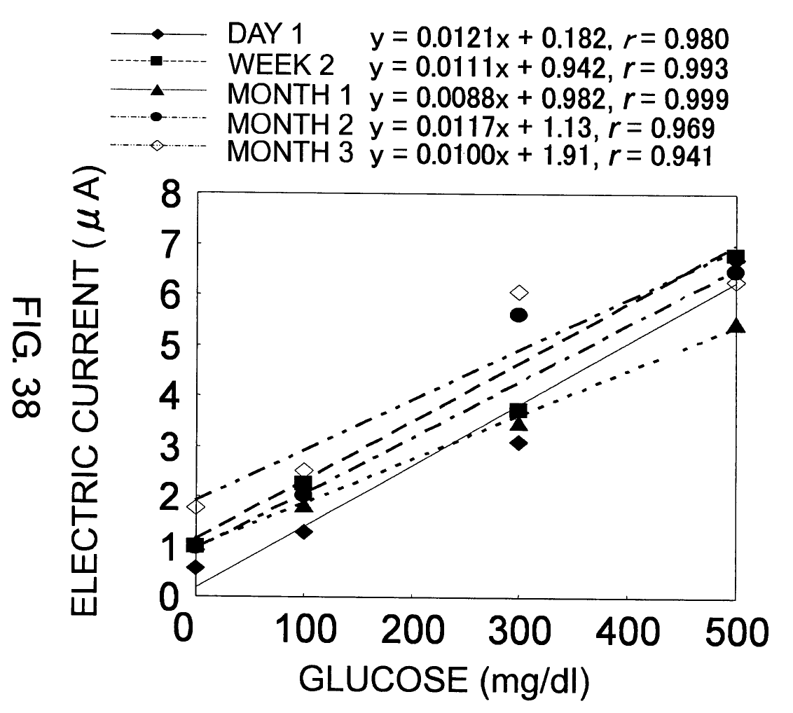

FIG. 37 shows the variation in the current values of the biosensors of the present invention, caused by blood glucose concentration. As FIG. 37 shows, current values were observed to vary from 0.5 to 9 μA over a blood glucose range of 0, 100, 300, and 500 mg/dl (n=3). Subsequently, under the same conditions, storage stability tests were conducted on day 0, week 2, month 1, month 2, and month 3 for biosensors in the condition of FIG. 36a. For the tests, the biosensors were stored in a (room temperature) laboratory table drawer in a laboratory. The results are shown in FIG. 38. This figure shows that the relationship between blood glucose concentration and output current value was maintained as correlation coefficient (r=0.976±0.0230) and gradient (0.0107±0.00134), and that no substantial change was observed even when the biosensor was stored in the room for three months.

### EXAMPLE 36

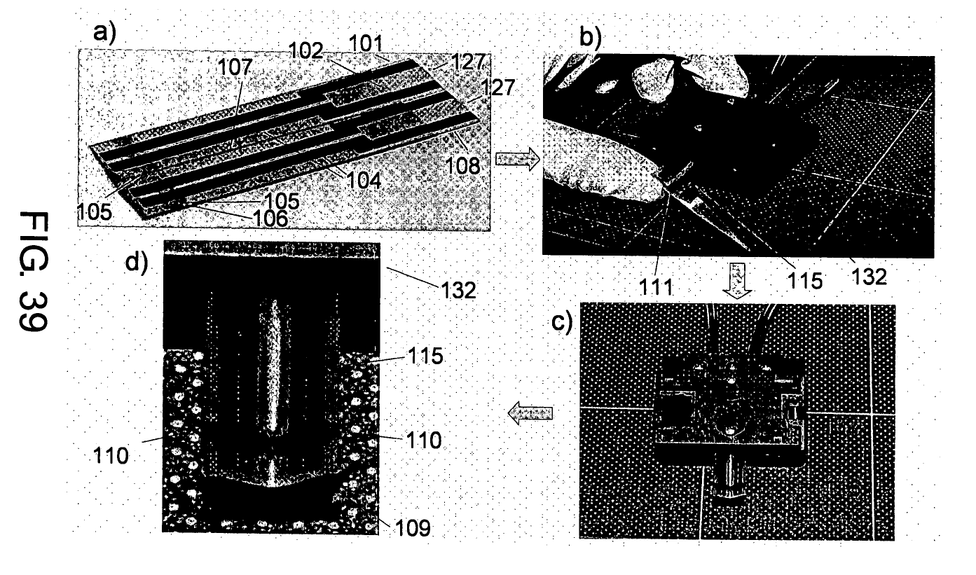

FIG. 39 shows an embodiment of a biosensor for simultaneously measuring two items of the present invention, for application to the simultaneous measurement of glucose, or to the simultaneous measurement of both glucose and lactic acid. Further, this biosensor is an example of an application of the biosensor shown in FIG. 14.

FIG. 39a is the biosensor before use for measurement, showing an example where reagent layer 106 is developed in the sample-feeding path 105 in each biosensor unit; FIG. 39b is an example where the biosensor for simultaneously measuring two items 115 is set to the specialized connector 132, to supply whole blood as sample 111; FIG. 39c shows an example of the biosensor after supplying a sample; and FIG. 39d shows an example of the biosensor after measurement.

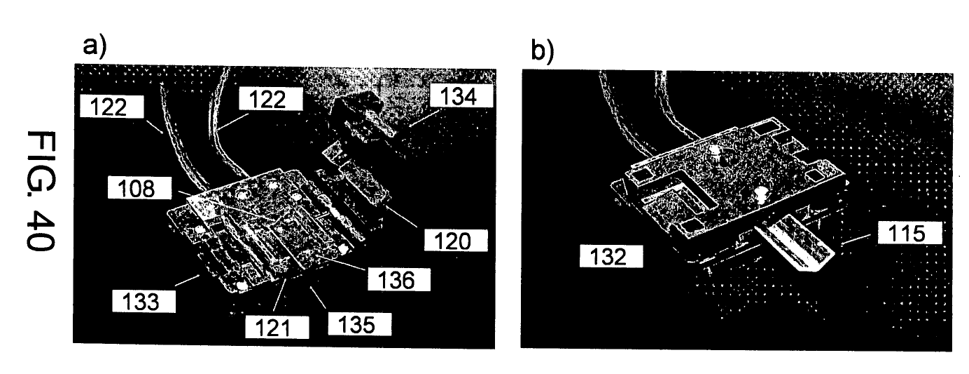

FIG. 40 shows an example of connector 132 for the biosensor for simultaneously measuring two items in the embodiments of the present invention. FIG. 40a shows an example where connector 132 is open. The connector is composed of base portion 133, cap 134, folder 135 for setting up the biosensor, presser 136, terminal 108 for receiving an electrical signal from the biosensor, and wiring 122. Terminal 108 and presser 136 are arranged on the surface of folder 135 on base 133. Therefore, to connect the biosensor using this connector, cover portion 102 of the biosensor has to be located on the lower side, outside the V-shaped structure, so that terminal 108 of the biosensor is connected with terminal 108 on the base. Also, folder 135 of the connector, which is a folding upper portion 120 and folding lower portion 121, is designed so that the angle is 90 degrees when the biosensor is formed in to a V-shape to connect to the connector. A biosensor can be connected to a connector after pre-forming a flat biosensor in to a V-shape, or after transforming the biosensor in to a V-shape by setting a flat biosensor in the folder.

FIG. 40b shows an example where the biosensor for simultaneously measuring two items 115 is connected to connector 132, and sample-inlet port 109 of each biosensor unit 127 opens downward in a lower portion near the bottom of the V-shaped biosensor.

In one example of application of this biosensor, glucose oxidase and potassium ferricyanide were employed as reagent layers, as for Example 35. By separately supplying samples from the sample-inlet port of each biosensor unit 127 to the inside by capillary action, these biosensors electrochemically measured the quantity of glucose in whole blood.

Next, the production methods and measurement methods of the biosensors are described:

Production methods used PET (length 35 mm, width 12 mm, depth 188 μm) as a biosensor substrate, and PET (length 30 mm, width 12 mm, depth 188 μm) as a cover. Two pairs of biosensor units 127 were arranged on the biosensor substrate, with notch 107 as a boundary. The notch was formed so that its depth was half that of the substrate and cover or more. Using a screen printer, two carbon electrodes 1.3 mm in width were formed on the biosensor substrate of each biosensor unit 127, at an interval of 0.5 mm. Screen printing was also used to form resist and adhesive as a spacer layer.

In theory, the total amount of sample of the two biosensors was about 0.90 μl, but the sample amount actually required when measuring whole blood (specific gravity: 1.05) was 1.13±0.064 mg (n=10, coefficient of variation CV=5.7%). The difference between these sample volumes is assumed to be because the spacer layer was in fact deeper than expected, or the sample solution adhered near the sample-inlet port, or the like.

A reagent layer of enzyme and mediator, made with nine units glucose oxidase (GOD) and 0.1 mg potassium ferricyanide (mediator) dissolved in distilled water, was formed on both electrodes by application to electrode surfaces in each biosensor, and then vacuum drying.

The results of measuring blood sugar (glucose in blood) using this glucose sensor are described. For blood sugar measurement using this glucose sensor, whole blood samples with a hematocrit value of 40% were prepared to have glucose concentrations set at 0, 100, 300, and 500 mg/dl, and these were used as specimen solutions. The responses of the two left and right biosensors were compared. The electrochemical measuring unit (ALS/CHI-1202, BAS Inc.) used in Example 35, which can measure two items simultaneously, was used for measurement. Potential step chronoamperometry was employed as the measurement method. Twenty seconds after supplying about 1.1 μl blood to the sample-inlet port by capillary action, an electric potential of 900 mV was applied between the two electrodes in the biosensor, and the current value ten seconds after application was used as the measured value.

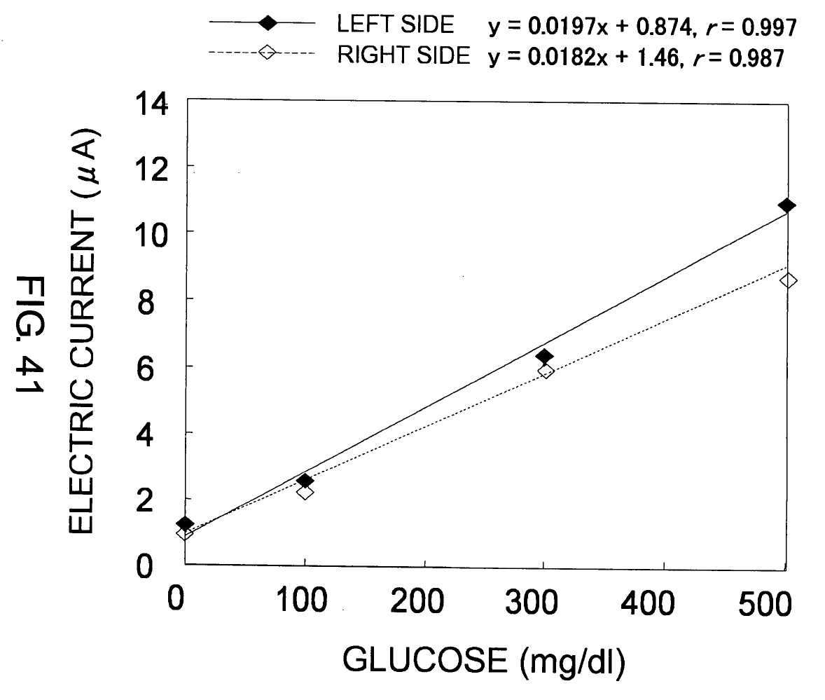

FIG. 41 shows the results for the left and right biosensors of the present invention of variation in current value caused by blood glucose concentration. As FIG. 41 shows, within the range of blood glucose 0, 100, 300, and 500 mg/dl (n=3), a current value variation of about 1 to 11 μA was observed in each of the left and right sensors. As this result indicates, no large difference was observed between the response values of the left and right sensors.

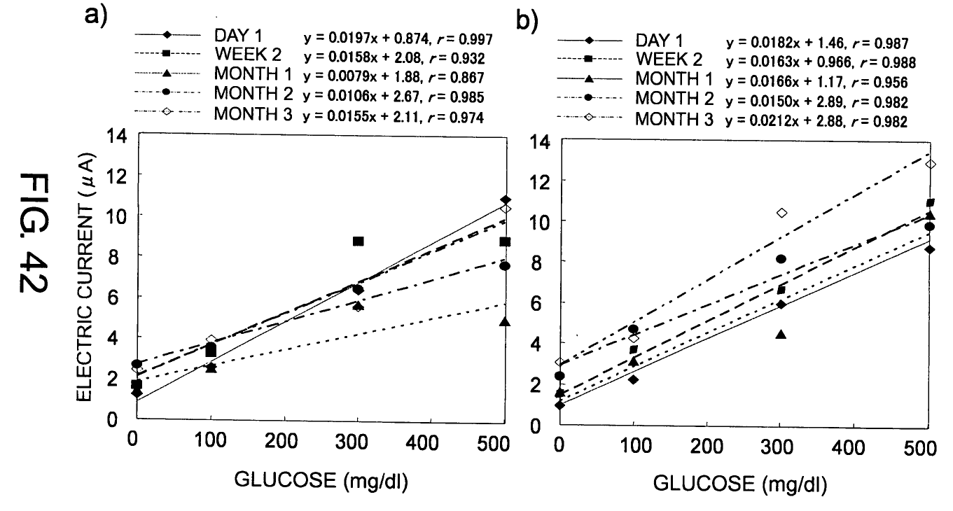

Subsequently, under the same conditions, storage stability tests for the biosensors of FIG. 39a were conducted on day 0, week 2, month 1, month 2, and month 3. The biosensors were stored in a (room temperature) laboratory table drawer in the laboratory, to test using the same conditions as in Example 35. The results are shown in FIG. 42. This figure shows that glucose concentration in blood and output current value maintained the following relationships, even when the biosensor was stored in a room for three months: correlation coefficient (r=0.951±0.053) and gradient (0.0139±0.0047) for the left side sensor, correlation coefficient (r=0.979±0.013) and gradient (0.0175±0.0074) for the right side sensor, and correlation coefficient (r=0.965±0.020) and gradient (0.0157±0.0025) for both biosensors. The responses of the left and right sensors were each observed. However, if similar experiments were conducted in an ordinary living environment using non-sealed type biosensors, the unsealed biosensors, unlike the present biosensors, would be affected by fungal or bacterial propagation on the reagent layer or the like, as well as the influence of temperature and humidity. Therefore, the biosensors for simultaneously measuring multiple items are also preferably sealed type biosensors which require no wrapping.

Next, this biosensor was used to simultaneously measure both glucose and lactic acid. The reagent layer of enzyme and mediator in the two left and right biosensors was different. The reagent layer of the biosensors of one side was formed on both electrodes by dissolving 1.65 units of glucose oxidase (GOD) and 0.1 mg potassium ferricyanide (mediator) in distilled water, applying this to the electrode surface of each biosensor, and then vacuum drying. The reagent layer of the biosensors on the other side was formed on both electrodes by dissolving 3.7 units of lactic acid oxidase (LOD) and 0.1 mg potassium ferricyanide (mediator) in distilled water, applying this to the electrode surface of each biosensor, and then vacuum drying.

As sample solutions, 0.1 M, pH7.4 phosphate buffer comprising 100 mg/dl lactic acid, phosphate buffer comprising 100 mg/dl lactic acid and 300 mg/dl glucose, and phosphate buffer comprising 300 mg/dl glucose were used.

The results of simultaneously measuring glucose and lactic acid using these biosensors for simultaneously measuring multiple items is described. For the measurement of glucose and lactic acid using a biosensor for simultaneously measuring two items, four kinds of mixed solutions were used as specimen solutions, with glucose and lactic acid prepared at prescribed concentrations (glucose+lactic acid: 0+0 mg/dl, 100+50 mg/dl, 300+100 mg/dl, and 500+140 mg/dl). Also, 0.1M, pH7.4 phosphate buffer was used to prepare these mixed solutions. The measuring unit used was the electrochemical measuring unit (ALS/CHI-1202, BAS Inc.) used in Example 35, which can be used to simultaneously measure two items. Potential step chronoamperometry was employed as the measurement method. Twenty seconds after supplying about 1.1 μl of sample solution to the sample-inlet port by capillary action, 900 mV of electric potential was applied between the two electrodes in the biosensor, and the current value ten seconds after application was used as the measured value.

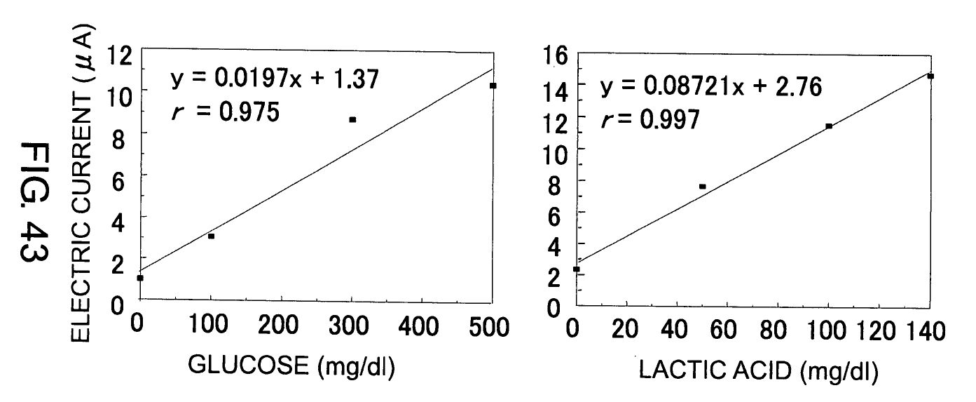

FIG. 43 shows the results of simultaneously measuring glucose and lactic acid using these biosensors. When measuring the mixed glucose and lactic acid solutions, the present biosensors were thus able to obtain a linear relationship between the concentration of each measuring target and the output current value, without being affected by the reagent layer of each adjacent biosensor.

### EXAMPLE 37

Thus, to solve the problems of the open-type biosensor for simultaneously measuring multiple items in Example 36, the following Examples describe the results of study on a sealed-type biosensor for simultaneously measuring multiple items of the present invention for which no wrapping is required.

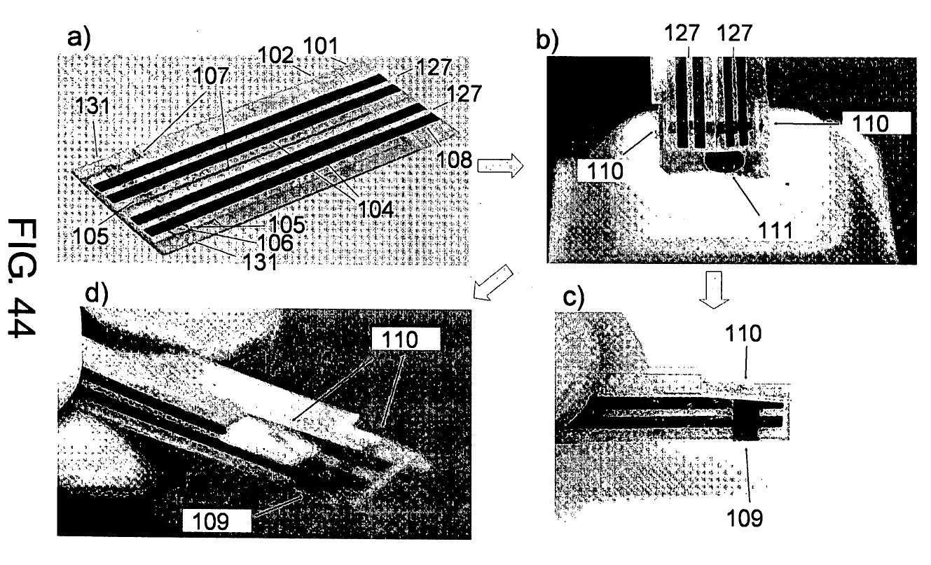

FIG. 44 shows the application of a sealed-type biosensor for simultaneously measurement two items in the embodiments of the present invention to simultaneous glucose measurements. Also, this biosensor is an example of applying the biosensor in FIG. 35 without auxiliary device 129.

FIG. 44a shows the biosensor before use for measurement, showing an example where reagent layer 106 is developed in the sample-feeding path 105 in each biosensor unit; where the sample-feeding path is in a hermetically sealed state, shut off from the outside by an upper outward-folding portion 131. FIG. 44b is an example where whole blood is supplied as a sample after transforming the biosensor for simultaneously measuring two items into a V-shape so as to open a sample-inlet port; FIG. 44c shows an example of the biosensor after supplying a sample solution, viewed diagonally from the front; and FIG. 44d similarly shows an example of the biosensor after supplying a sample solution, viewed side-on. The biosensor may thus be bent while inserting the biosensor into a shape-fixing portion (folder) of a connector, or may be inserted into the connector after being bent.

Next, the production methods and measurement methods of the biosensors are described:

Production methods used PET (length 35 mm, width 15 mm, depth 188 μm) as a biosensor substrate, and PET (length 30 mm, width 15 mm, depth 188 μm) as a cover. Two pairs of biosensor units 127 were arranged on the biosensor substrate, with notch 107 as a boundary. The opening 131 of air-discharge port is also provided with the notch 107 on upper of the outer surface of each biosensor unit. The notch was formed so that its depth was half that of the substrate and cover or more. Using a screen printer, two carbon electrodes 1.3 mm in width were formed on the biosensor substrate of each biosensor unit 127, at an interval of 0.8 mm. Screen printing was also used to form resist and adhesive as a spacer layer.

In theory, the total amount of sample of the two biosensors was about 0.90 μl, but the sample amount actually required when measuring whole blood (specific gravity: 1.05) was 1.12±0.077 mg (n=10, coefficient of variation CV=6.9%). The difference between these sample volumes is assumed to be because the spacer layer was in fact deeper than expected, or the sample solution adhered near the sample-inlet port, or the like.

A reagent layer of enzyme and mediator, made with nine units glucose oxidase (GOD) and 0.1 mg potassium ferricyanide (mediator) dissolved in distilled water, was formed on both electrodes by application to electrode surfaces in each biosensor, and then vacuum drying.

The results of measuring blood sugar (glucose in blood) using this glucose sensor are described. For blood sugar measurement using this glucose sensor, whole blood samples with a hematocrit value of 40% were prepared to have glucose concentrations set at 0, 100, 300, and 500 mg/dl, and these were used as specimen solutions. The responses of the two left and right biosensors were compared. The electrochemical measuring unit (ALS/CHI-1202, BAS Inc.) used in Example 35, which can measure two items simultaneously, was used for measurement. Potential step chronoamperometry was employed as the measurement method. Twenty seconds after supplying about 1.1 μl blood to the sample-inlet port by capillary action, an electric potential of 900 mV was applied between the two electrodes in the biosensor, and the current value ten seconds after application was used as the measured value.

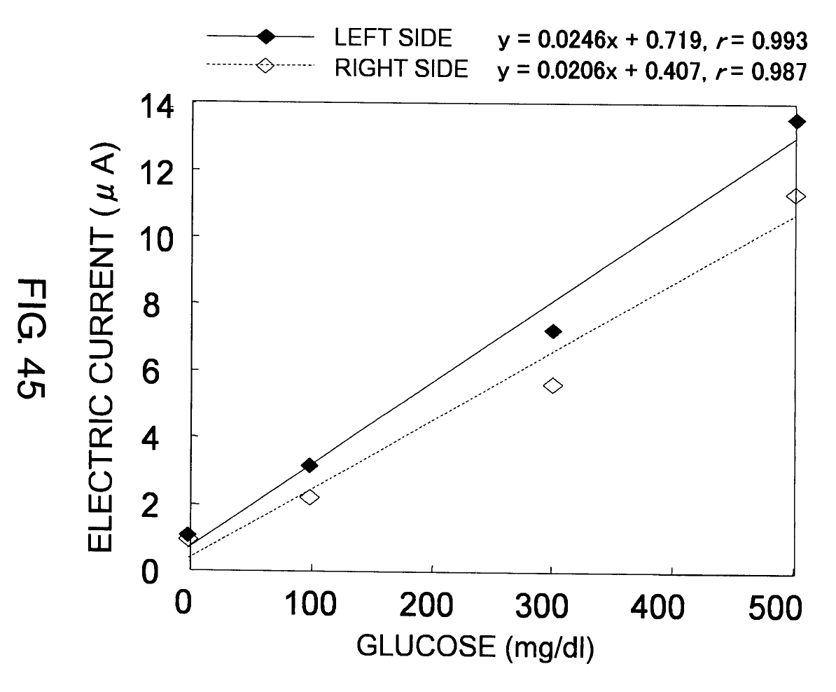

FIG. 45 shows the results for the left and right biosensors of the present invention of variation in current value caused by blood glucose concentration. As FIG. 45 shows, within the range of blood glucose 0, 100, 300, and 500 mg/dl (n=3), a current value variation of about 0.5 to 14 μA was observed in each of the left and right sensors. As this result indicates, no large difference was observed between the response values of the left and right sensors.

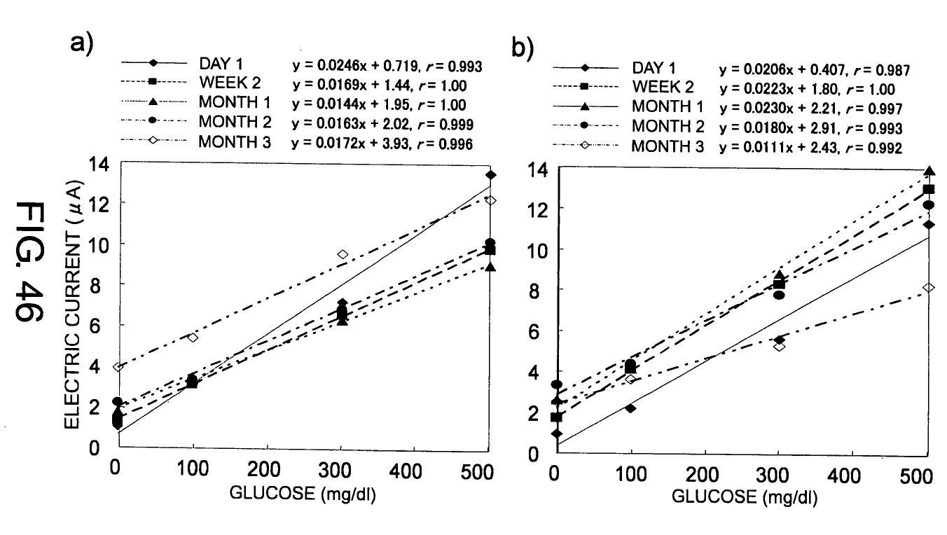

Subsequently, under the same conditions, storage stability tests were conducted for these biosensors on day 0, week 2, month 1, month 2, and month 3. The biosensors were stored in a (room temperature) laboratory table drawer in a laboratory, for tests under the same conditions as in Example 35. The results are shown in FIG. 46. Although the responses differ slightly from day to day, this figure shows that glucose concentration in blood and output current value maintain the following relationships for the three months when the biosensor was stored in a room: correlation coefficient (r=0.996±0.0040) and gradient (0.0179±0.0039) for the left sensor, correlation coefficient (r=0.994±0.0050) and gradient (0.0190±0.0048) for the right sensor, and correlation coefficient (r=0.995±0.0013) gradient (0.0184±0.0008) for both biosensors. The responses of the left and right sensors were independently observed. These biosensors thus obtained excellent results regarding the correlation between glucose concentration in blood and output current value. These biosensors, which are sealed-type biosensors, were found able to conduct measurements for at least three months, without the need for wrapping.

### EXAMPLE 38

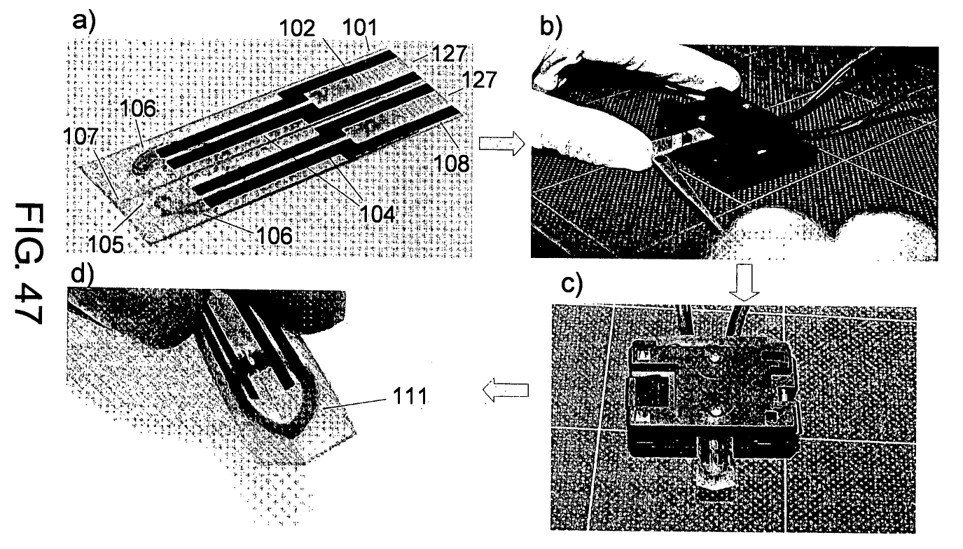

FIG. 47 shows the application of a sealed-type biosensor for simultaneously measuring two items in the embodiments of the present invention to the simultaneous measurement of glucose, or to the simultaneous measurement of both glucose and lactic acid. This biosensor is one example of an application of the biosensor shown in FIG. 16.

FIG. 47a shows the biosensor before use for measurement, illustrating an example where reagent layer 106 is developed in sample-feeding path 105 in each biosensor unit; and where the sample-feeding path is in a hermetically sealed state, shut off from the outside. FIG. 47b shows an example where whole blood is supplied as a sample, by setting the biosensor for simultaneously measuring two items in the specialized connector 132. FIG. 47c shows an example of the biosensor after supplying a sample, and FIG. 47d shows an example of the biosensor after measurement.

Next, the production methods and measurement methods of the biosensors are described:

Production methods used PET (length 35 mm, width 12 mm, depth 188 μm) as a biosensor substrate, and PET (length 30 mm, width 12 mm, depth 188 μm) as a cover. Two pairs of biosensor units 127 were arranged on the biosensor substrate, with notch 107 as a boundary. The notch was formed so that its depth was half that of the substrate and cover or more. Using a screen printer, two carbon electrodes 1.3 mm in width were formed on the biosensor substrate of each biosensor unit 127, at an interval of 0.5 mm. Screen printing was also used to form resist and adhesive as a spacer layer.

In theory, the total amount of sample of the two biosensors was about 2.0 μl, but the sample amount actually required when measuring whole blood (specific gravity: 1.05) was 2.71±0.097 mg (n=10, coefficient of variation CV=3.6%), indicating high reproducibility. The difference between these sample volumes is assumed to be because the spacer layer was in fact deeper than expected, or the sample solution adhered near the sample-inlet port, or the like.

A reagent layer of enzyme and mediator, made with 20 units glucose oxidase (GOD) and 0.1 mg potassium ferricyanide (mediator) dissolved in distilled water, was formed on both electrodes by application to electrode surfaces in each biosensor, and then vacuum drying.

The results of measuring blood sugar (glucose in blood) using this glucose sensor are described. For blood sugar measurement using this glucose sensor, whole blood samples with a hematocrit value of 40% were prepared to have glucose concentrations set at 0, 100, 300, and 500 mg/dl, and these were used as specimen solutions. The responses of the two left and right biosensors were compared. The electrochemical measuring unit (ALS/CHI-1202, BAS Inc.) used in Example 35, which can measure two items simultaneously, was used for measurement. Potential step chronoamperometry was employed as the measurement method. Twenty seconds after supplying about 3 μl blood to the sample-inlet port by capillary action, an electric potential of 900 mV was applied between the two electrodes in the biosensor, and the current value ten seconds after application was used as the measured value.

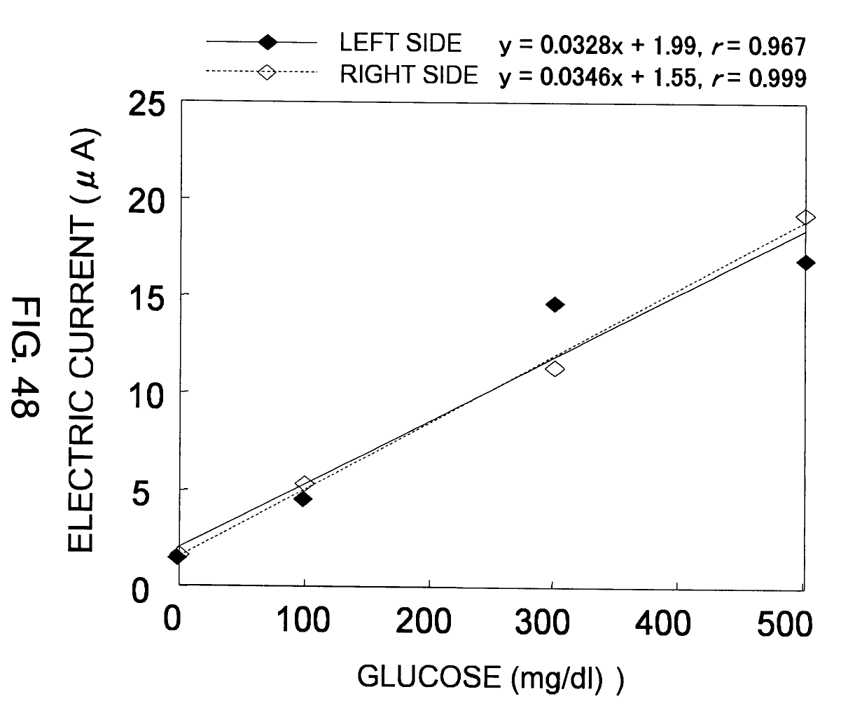

FIG. 48 shows the results for the left and right biosensors of the present invention of variation in current value caused by blood glucose concentration. As FIG. 48 shows, within the range of blood glucose 0, 100, 300, and 500 mg/dl (n=3), a current value variation of about 1.5 to 19 μA was observed in each of the left and right sensors. The above result showed that the response values of the left and right sensors are matched very well.

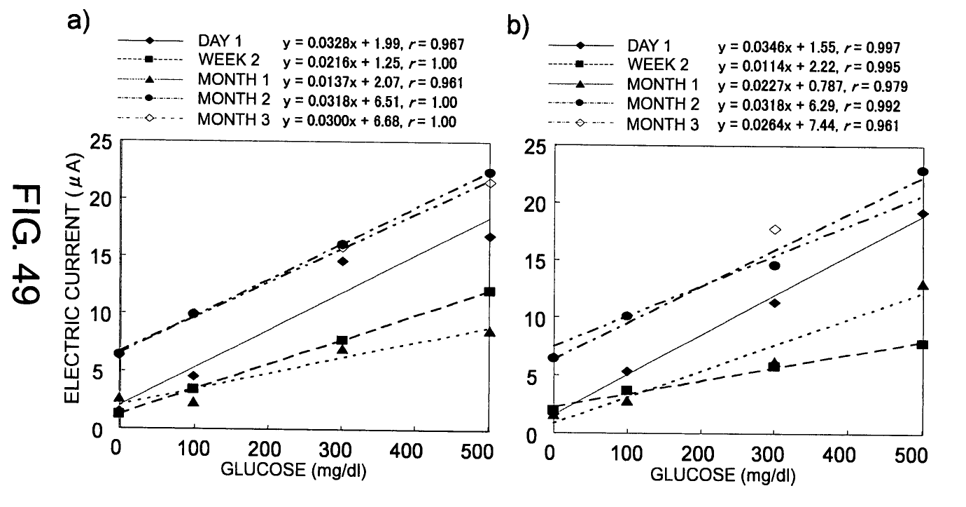

Subsequently, under the same conditions, storage stability tests were conducted for these biosensors on day 0, week 2, month 1, month 2, and month 3. The biosensors were stored in a (room temperature) laboratory table drawer in a laboratory, for tests under the same conditions as in Example 35. The results are shown in FIG. 49. Although the responses differ from day to day, this figure shows that glucose concentration in blood and output current value maintain the following relationships for the three months when the biosensor was stored in a room: correlation coefficient (r=0.986±0.020) and gradient (0.0260±0.0082) for the left sensor, correlation coefficient (r=0.985±0.0080) and gradient (0.0254±0.010) for the right sensor, and correlation coefficient (r=0.985±0.00) gradient (0.0257±0.0004) for both biosensors. The responses of the left and right sensors were independently observed.

These biosensors thus obtained relatively excellent results regarding the correlation between glucose concentration in blood and output current value. These biosensors, which are sealed-type biosensors, were found able to conduct measurements for at least three months, without the need for wrapping.

Next, this biosensor was used to simultaneously measure both glucose and lactic acid. The reagent layer of enzyme and mediator in the two left and right biosensors was different. The reagent layer of the biosensors of one side was formed on both electrodes by dissolving nine units of glucose oxidase (GOD) and 0.1 mg potassium ferricyanide (mediator) in distilled water, applying this to the electrode surface of each biosensor, and then vacuum drying. The reagent layer of the biosensors on the other side was formed on both electrodes by dissolving 20 units of lactic acid oxidase (LOD) and 0.1 mg potassium ferricyanide (mediator) in distilled water, applying this to the electrode surface of each biosensor, and then vacuum drying.

As sample solutions, 0.1 M, pH7.4 phosphate buffer comprising 100 mg/dl lactic acid, phosphate buffer comprising 100 mg/dl lactic acid and 300 mg/dl glucose, and phosphate buffer comprising 300 mg/dl glucose were used.

The results of simultaneously measuring glucose and lactic acid using these sealed-type biosensors for simultaneously measuring multiple items is described. For the measurement of glucose and lactic acid using a biosensor for simultaneously measuring two items, four kinds of mixed solutions were used as specimen solutions, with glucose and lactic acid prepared at prescribed concentrations (glucose+lactic acid: 0+0 mg/dl, 100+50 mg/dl, 300+100 mg/dl, and 500+140 mg/dl). Also, 0.1M, pH7.4 phosphate buffer was used to prepare these mixed solutions. The measuring unit used was the electrochemical measuring unit (ALS/CHI-1202, BAS Inc.) used in Example 35, which can be used to simultaneously measure two items. Potential step chronoamperometry was employed as the measurement method. Twenty seconds after supplying about 3 μl of sample solution to the sample-inlet port by capillary action, 900 mV of electric potential was applied between the two electrodes in the biosensor, and the current value ten seconds after application was used as the measured value.

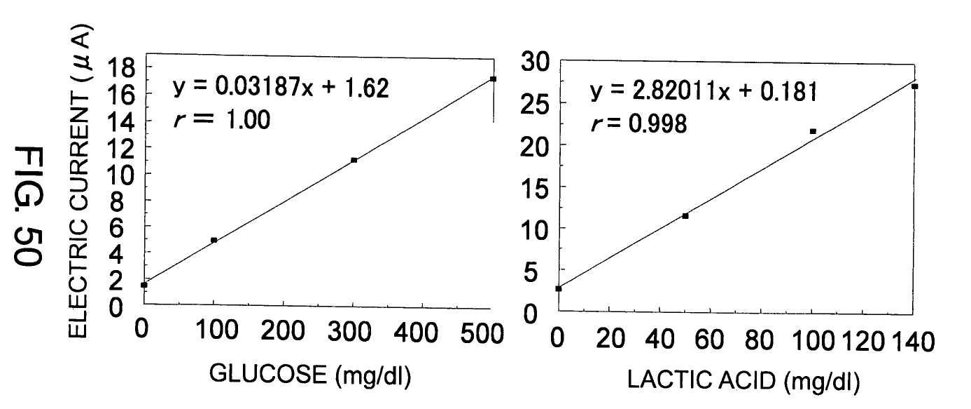

FIG. 50 shows the results of simultaneously measuring glucose and lactic acid using these biosensors. When measuring the mixed glucose and lactic acid solutions, the present biosensors were thus able to obtain a linear relationship between the concentration of each measuring target and the output current value, without being affected by the reagent layer of each adjacent biosensor.

1. A biosensor comprising:
an electrically insulating substrate;
an electrically insulating cover connected to the substrate via a spacer layer;
a reaction-detecting section comprising at least one set of electrodes, and an external terminal to be connected to the reaction-detecting section, both of which are formed on the substrate at a region between the substrate and cover; and
a sealed sample-feeding path defined by the spacer layer between the substrate and cover, wherein the sample-feeding path comprises a portion that intersects the electrodes,
a cutting plane line is provided at an outermost surface of the substrate or cover, and is bordered by a sensor portion comprising the electrodes and a sealed cap portion which does not comprise the electrodes,
the cutting plane line exists at a position where, when the sealed cap portion is cut along the cutting plane line, the cut surface does not cross the electrodes, and the cut surface crosses the sample-feeding path so that a sample-inlet port and air-discharge port from the sample-feeding path are exposed through the cut surface.

2. The biosensor of claim 1, wherein the cutting plane line is formed by notches or cuts, and the notches or cuts are laid out to face the same positions on the substrate and cover.

3. The biosensor of claim 1, wherein the substrate and cover each comprise a multilayer structure of at least two or more layers, and the cutting plane line is formed to leave at least an innermost layer of the multilayer structure.

4. The biosensor of claim 1, wherein a reagent layer is provided at a region where the sample-feeding path crosses the electrode.

5. The biosensor of claim 1, wherein a part of the region sandwiched between the substrate and cover comprises a desiccant and/or deoxidant.

6. The biosensor of claim 5, wherein the desiccant and/or deoxidant is comprised in a sealed cap portion.

7. The biosensor of claim 1, wherein a part of the region sandwiched between the substrate and cover comprises a humidity indicator and/or oxygen-detecting agent.

8. The biosensor of claim 7, wherein a part or all of the substrate and/or cover is of a material transparent to visible rays, and thus the humidity indicator and/or oxygen-detecting agent is visible.

9. The biosensor of claim 1, wherein the substrate and/or cover are made of a material that does not transmit ultraviolet.

10. The biosensor of claim 1, wherein a top surface of the substrate and/or cover is coated with an ultraviolet absorber or a material that does not transmit ultraviolet.

11. The biosensor of claim 1, wherein the substrate or cover comprise a compound with a photocatalytic effect, or where a top surface of the substrate and/or cover is coated with a layer comprising a compound with a photocatalytic effect.

12. The biosensor of claim 1, wherein the spacer layer comprises a fluorescent or luminescent agent close to an exposed sample-inlet port and air-discharge port.

13. The biosensor of claim 1, wherein the electrodes form an array.

14. The biosensor of claim 13, wherein at least one sample-inlet port is exposed when the sealed cap portion is cut along the cutting plane line, and the reaction-detecting section comprising at least one set of electrodes is located ahead of the sample-feeding path connected to the sample-inlet port.

15. The biosensor of claim 14, wherein the at least one sample-inlet port is connected to at least two sample-feeding paths branched from the sample-inlet port, and the reaction-detecting section comprising at least one set of electrodes is located ahead of the sample-feeding path.

16. The biosensor of claim 8, wherein the substrate and/or cover comprising a material transparent to visible rays is coated with a protective film.

17. The biosensor of claim 1, wherein the external terminal is coated with a protective film.

18. The biosensor of claim 1, wherein the external terminal is covered with the cover, and the cover has a fold-line foldable in such a way as to expose the external terminal.

19. A biosensor package retaining a plurality of the biosensor of claim 1.

20. A biosensor aggregation sheet comprising a plurality of the biosensors of claim 1, regularly laid out at predetermined intervals, wherein a cut-away perforation is provided at a substrate of an adjoining biosensor.

21. A method for using the biosensor of claim 1, wherein the method comprises the step of cutting off a sealed cap to form a sample-inlet port and an air-discharge port.

22. A biosensor device comprising:
the biosensor of claim 1;
a measuring section for measuring an electrical value at a reaction-detecting section of the biosensor;
a display section for displaying a value measured in the measuring section; and
a memory section for saving the measured value.

23. The biosensor device of claim 22, wherein the measuring method in the measuring section is any one of potential step chronoamperometry, coulometry, and cyclic voltammetry.

24. The biosensor device of claim 22, wherein the biosensor comprises a wireless means for transmitting measurement data to the measuring section, and the wireless means is a non-contact IC card or Bluetooth.

25. A biosensor for simultaneously measuring multiple items, comprising:
a substrate;
a cover connected to the substrate via a spacer layer; and
a number of biosensor unit-comprising substrates, containing at least one biosensor unit which comprises a reaction-detecting section that includes one electrode and one reagent layer on the substrate, and a sample-feeding path that includes the reagent layer,
wherein each of the biosensor units comprises one reagent layer on one sample-feeding path,
a cutting plane line for dividing each of the biosensor unit-comprising substrates is provided at a top surface of the substrate or cover,
the cutting plane line and sample-feeding path are placed such that, when the substrate or cover is cut along the cutting plane line, a sample-inlet port that supplies a sample solution to the sample-feeding path opens at a cut surface of each biosensor unit-comprising substrate, as a cut port of the sample-feeding path.

26. The biosensor of claim 25, wherein the sample-feeding path is provided such that the sample-inlet port opens at the cut surface, and an air-discharge port is provided at the surface of the substrate or cover, or at a side surface of the biosensor unit-comprising substrate which differs from the cut surface.

27. The biosensor of claim 25, wherein the sample-feeding path is sealed;
a cutting plane line (the first cutting plane line), which divides each of the biosensor unit-comprising substrates, and a second cutting plane line, which is different from the first cutting plane line and is used to expose the air-discharge port by cutting parts of the substrate and cover, are provided on a top surface of the substrate or cover; and
the first and second cutting plane lines and the sample-feeding path are arranged such that the sample-inlet port opens as a cut opening on the first cut surface when the substrate or cover is cut along the first cut surface, and such that the air-discharge port opens as a cut opening on the second cut surface when the substrate or cover is cut along the second cut surface.

28. The biosensor of claim 27, equipped with an auxiliary device on a surface of the substrate or cover, such that the substrate or cover are bent along the second cutting plane line in response to bending of the substrate or cover along the first cutting plane line.

29. The biosensor of claim 25, wherein the sample-feeding path is provided such that both the sample-inlet port and air-discharge port open to a cut surface of each of the biosensor unit-comprising substrates, and the sample-feeding path is set up in a sealed state, prior to cutting.

30. The biosensor of claim 25, wherein the sample-feeding path is laid out such that a sample-inlet port forms for every biosensor unit.

31. The biosensor of claim 25, wherein at least one of the substrate or cover comprises a multilayer structure comprising at least two layers, and the cutting plane line is formed at any one of the layers of the multilayer structure, excluding the innermost layer.

32. The biosensor of claim 25, wherein the electrodes form an array.

33. A method for using the biosensor of claim 25, wherein said method comprises the steps of:
(1) bending the substrate or cover along a cutting plane line which divides the biosensor unit-comprising substrates, and cutting the substrate or cover to open the cut opening (sample-inlet port) of the sample-feeding path on the cut surface of each biosensor unit-comprising substrate;
(2) fixing the shape of the bent biosensor unit-comprising substrate to keep the sample-inlet port open;
(3) contacting the open sample-inlet port with a solution comprising a measuring target; and
(4) supplying the solution comprising the measuring target to the sample-feeding path.

34. The method of claim 33, wherein the bending in step (1) is carried out such that the cut surface is exposed and one substrate is cut while the other substrate is left connected, and wherein step (3) is carried out with the biosensor bent.

35. The method of claim 33, wherein step (3) comprises contacting the sample-inlet ports of two or more biosensor unit-comprising substrates with the solution at one time.

36. The method of claim 33, wherein the biosensor unit-comprising substrate comprises two or more biosensor units, and step (2) comprises contacting one sample-inlet port of the biosensor unit-comprising substrates with a solution at the same time.

37. A method for measuring a measuring target using the biosensor of claim 25, wherein the method comprises the steps of:
(1) bending the substrate or cover along a cutting plane line which divides the biosensor unit-comprising substrates, and cutting the substrate or cover to open a cut opening (sample-inlet port) of the sample-feeding path on the cut surface of each biosensor unit-comprising substrate;
(2) fixing the shape of the bent biosensor unit-comprising substrate to keep the sample-inlet port open;
(3) contacting the open sample-inlet port with a solution comprising a measuring target;
(4) supplying the solution comprising the measuring target to the sample-feeding path; and
(5) measuring the measuring targets with each of the biosensors.

38. A biosensor device comprising:
a biosensor of claim 25;
a connector section which captures electric signals at biosensor electrodes;
a measuring section which measures an electrical value via the connector section;
a display section which displays the value measured in the measuring section; and
a memory section which saves the measured value.

39. The biosensor device of claim 38, wherein the connector section comprises a structure for:
altering the shape of the biosensor unit-comprising substrate for opening the sample-inlet port;
fixing the biosensor unit-comprising substrate with the shape; and then capturing electrical signals at the biosensor electrodes.

40. The biosensor device of claim 36, wherein the measuring method in the measuring section is potential step chronoamperometry, coulometry, or cyclic voltammetry.

41. A connector for use in biosensors, for fixing the biosensor of claim 25 to capture electrical signals, wherein the connector comprises:
a sensor shape-fixing section that fixes the bent shape of the biosensor unit-comprising substrate to open the sample-inlet port; and
an electrical connection section or wiring for capturing electrical signals on the biosensor, and electrical signals at the biosensor electrodes.
